(19) United States
(12) Patent Application Publication
(10) Pub. No.: US 2024/0377922 A1
(43) Pub. Date: Nov. 14, 2024

(54) ELECTRONIC COMMUNICATION AND CONNECTING A CAMERA TO A DEVICE

(71) Applicant: Apple Inc., Cupertino, CA (US)

(72) Inventors: Pavan RAJAM, Cupertino, CA (US); William M. BUMGARNER, San Jose, CA (US); Jee Won CHOI, San Francisco, CA (US); Jarrett A. FORD, Alameda, CA (US)

(21) Appl. No.: 18/444,447

(22) Filed: Feb. 16, 2024

Related U.S. Application Data
(60) Provisional application No. 63/470,869, filed on Jun. 3, 2023.
(60) Provisional application No. 63/465,210, filed on May 9, 2023.

(51) Int. Cl. G06F 3/0482; G06F 3/01; G06F 3/04847

(52) U.S. Cl. CPC G06F 3/0482; G06F 3/017; G06F 3/04847

(57) ABSTRACT

The present disclosure generally relates to managing real-time communication sessions and connecting cameras to devices.

### CROSS-REFERENCE TO RELATED APPLICATIONS

This application claims priority to U.S. Provisional Application No. 63/470,869, filed Jun. 3, 2023, and entitled “ELECTRONIC COMMUNICATION AND CONNECTING A CAMERA TO A DEVICE,” and U.S. Provisional Application No. 63/465,210, filed May 9, 2023, and entitled “ELECTRONIC COMMUNICATION AND CONNECTING A CAMERA TO A DEVICE,” the entire disclosures of which are hereby incorporated by reference for all purposes.

### FIELD

The present disclosure relates generally to computer user interfaces, and more specifically to techniques for electronic communication and connecting a camera to a device.

### BACKGROUND

Electronic devices can display various types of content and can be used to perform communication.

### BRIEF SUMMARY

Some techniques for electronic communication and connecting a camera to a device using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for electronic communication and connecting a camera to a device. Such methods and interfaces optionally complement or replace other methods for electronic communication and connecting a camera to a device. Such methods and interfaces reduce the cognitive burden on a user and produce a more efficient human-machine interface. For battery-operated computing devices, such methods and interfaces conserve power and increase the time between battery charges.

In accordance with some embodiments, method is described. The method comprises: at a first computer system that is in communication with a display generation component, one or more camera sensors, and one or more input devices: while a real-time communication session is active on the first computer system, obtaining an indication that a set of handoff criteria is met, wherein the set of handoff criteria requires that a physical location of the first computer system relative to a second computer system satisfies a proximity condition; in response to obtaining the indication that the set of handoff criteria is met, displaying, via the display generation component, a handoff user interface element; detecting, via the one or more input devices, a selection of the handoff user interface element; and in response to detecting the selection of the handoff user interface element, initiating a handoff process that includes capturing video for the real-time communication session using the one or more camera sensors while a user interface of the real-time communication session is displayed by the second computer system.

In accordance with some embodiments, a non-transitory computer-readable storage medium is described. The non-transitory computer-readable storage medium stores one or more programs configured to be executed by one or more processors of a computer system that is in communication with a display generation component, one or more camera sensors, and one or more input devices. The one or more programs include instructions for: while a real-time communication session is active on the first computer system, obtaining an indication that a set of handoff criteria is met, wherein the set of handoff criteria requires that a physical location of the first computer system relative to a second computer system satisfies a proximity condition; in response to obtaining the indication that the set of handoff criteria is met, displaying, via the display generation component, a handoff user interface element; detecting, via the one or more input devices, a selection of the handoff user interface element; and in response to detecting the selection of the handoff user interface element, initiating a handoff process that includes capturing video for the real-time communication session using the one or more camera sensors while a user interface of the real-time communication session is displayed by the second computer system.

In accordance with some embodiments, a transitory computer-readable storage medium is described. The transitory computer-readable storage medium stores one or more programs configured to be executed by one or more processors of a computer system that is in communication with a display generation component, one or more camera sensors, and one or more input devices. The one or more programs include instructions for: while a real-time communication session is active on the first computer system, obtaining an indication that a set of handoff criteria is met, wherein the set of handoff criteria requires that a physical location of the first computer system relative to a second computer system satisfies a proximity condition; in response to obtaining the indication that the set of handoff criteria is met, displaying, via the display generation component, a handoff user interface element; detecting, via the one or more input devices, a selection of the handoff user interface element; and in response to detecting the selection of the handoff user interface element, initiating a handoff process that includes capturing video for the real-time communication session using the one or more camera sensors while a user interface of the real-time communication session is displayed by the second computer system.

In accordance with some embodiments, a computer system configured to communicate with a display generation component, one or more camera sensors, and one or more input devices is described. The computer system comprises: one or more processors; and memory storing one or more programs configured to be executed by the one or more processors, the one or more programs including instructions for: while a real-time communication session is active on the first computer system, obtaining an indication that a set of handoff criteria is met, wherein the set of handoff criteria requires that a physical location of the first computer system relative to a second computer system satisfies a proximity condition; in response to obtaining the indication that the set of handoff criteria is met, displaying, via the display generation component, a handoff user interface element; detecting, via the one or more input devices, a selection of the handoff user interface element; and in response to detecting the selection of the handoff user interface element, initiating a handoff process that includes capturing video for the real-time communication session using the one or more camera sensors while a user interface of the real-time communication session is displayed by the second computer system.

In accordance with some embodiments, a computer system configured to communicate with a display generation component, one or more camera sensors, and one or more input devices is described. The computer system comprises: means for, while a real-time communication session is active on the first computer system, obtaining an indication that a set of handoff criteria is met, wherein the set of handoff criteria requires that a physical location of the first computer system relative to a second computer system satisfies a proximity condition; means for, in response to obtaining the indication that the set of handoff criteria is met, displaying, via the display generation component, a handoff user interface element; means for detecting, via the one or more input devices, a selection of the handoff user interface element; and means for, in response to detecting the selection of the handoff user interface element, initiating a handoff process that includes capturing video for the real-time communication session using the one or more camera sensors while a user interface of the real-time communication session is displayed by the second computer system.

In accordance with some embodiments, a computer program product is described. The computer program product comprises one or more programs configured to be executed by one or more processors of a computer system that is in communication with a display generation component, one or more camera sensors, and one or more input devices. The one or more programs include instructions for: while a real-time communication session is active on the first computer system, obtaining an indication that a set of handoff criteria is met, wherein the set of handoff criteria requires that a physical location of the first computer system relative to a second computer system satisfies a proximity condition; in response to obtaining the indication that the set of handoff criteria is met, displaying, via the display generation component, a handoff user interface element; detecting, via the one or more input devices, a selection of the handoff user interface element; and in response to detecting the selection of the handoff user interface element, initiating a handoff process that includes capturing video for the real-time communication session using the one or more camera sensors while a user interface of the real-time communication session is displayed by the second computer system.

In accordance with some embodiments, a method is described. The method comprises: at a first computer system that is in communication with a display generation component and one or more input devices: detecting, via the one or more input devices, a request to display an application that uses data captured by a camera sensor; and in response to detecting the request to display the application that uses data captured by a camera sensor: in accordance with a determination that the first computer system is connected to a second computer system that is in communication with one or more camera sensors, displaying, via the display generation component, the application; and in accordance with a determination that the first computer system is not connected to a computer system that is in communication with one or more camera sensors, displaying, via the display generation component, a first connection user interface element that, when selected, initiates a process for connecting the first computer system with the second computer system.

In accordance with some embodiments, a non-transitory computer-readable storage medium is described. The non-transitory computer-readable storage medium stores one or more programs configured to be executed by one or more processors of a computer system that is in communication with a display generation component and one or more input devices. The one or more programs include instructions for: detecting, via the one or more input devices, a request to display an application that uses data captured by a camera sensor; and in response to detecting the request to display the application that uses data captured by a camera sensor: in accordance with a determination that the first computer system is connected to a second computer system that is in communication with one or more camera sensors, displaying, via the display generation component, the application; and in accordance with a determination that the first computer system is not connected to a computer system that is in communication with one or more camera sensors, displaying, via the display generation component, a first connection user interface element that, when selected, initiates a process for connecting the first computer system with the second computer system.

In accordance with some embodiments, a transitory computer-readable storage medium is described. The transitory computer-readable storage medium stores one or more programs configured to be executed by one or more processors of a computer system that is in communication with a display generation component and one or more input devices. The one or more programs include instructions for: detecting, via the one or more input devices, a request to display an application that uses data captured by a camera sensor; and in response to detecting the request to display the application that uses data captured by a camera sensor: in accordance with a determination that the first computer system is connected to a second computer system that is in communication with one or more camera sensors, displaying, via the display generation component, the application; and in accordance with a determination that the first computer system is not connected to a computer system that is in communication with one or more camera sensors, displaying, via the display generation component, a first connection user interface element that, when selected, initiates a process for connecting the first computer system with the second computer system.

In accordance with some embodiments, a computer system configured to communicate with a display generation component and one or more input devices is described. The computer system comprises: one or more processors; and memory storing one or more programs configured to be executed by the one or more processors, the one or more programs including instructions for: detecting, via the one or more input devices, a request to display an application that uses data captured by a camera sensor; and in response to detecting the request to display the application that uses data captured by a camera sensor: in accordance with a determination that the first computer system is connected to a second computer system that is in communication with one or more camera sensors, displaying, via the display generation component, the application; and in accordance with a determination that the first computer system is not connected to a computer system that is in communication with one or more camera sensors, displaying, via the display generation component, a first connection user interface element that, when selected, initiates a process for connecting the first computer system with the second computer system.

In accordance with some embodiments, a computer system configured to communicate with a display generation component and one or more input devices is described. The computer system comprises: means for detecting, via the one or more input devices, a request to display an application that uses data captured by a camera sensor; and means for, in response to detecting the request to display the application that uses data captured by a camera sensor: in accordance with a determination that the first computer system is connected to a second computer system that is in communication with one or more camera sensors, displaying, via the display generation component, the application; and in accordance with a determination that the first computer system is not connected to a computer system that is in communication with one or more camera sensors, displaying, via the display generation component, a first connection user interface element that, when selected, initiates a process for connecting the first computer system with the second computer system.

In accordance with some embodiments, a computer program product is described. The computer program product comprises one or more programs configured to be executed by one or more processors of a computer system that is in communication with a display generation component and one or more input devices. The one or more programs include instructions for: detecting, via the one or more input devices, a request to display an application that uses data captured by a camera sensor; and in response to detecting the request to display the application that uses data captured by a camera sensor: in accordance with a determination that the first computer system is connected to a second computer system that is in communication with one or more camera sensors, displaying, via the display generation component, the application; and in accordance with a determination that the first computer system is not connected to a computer system that is in communication with one or more camera sensors, displaying, via the display generation component, a first connection user interface element that, when selected, initiates a process for connecting the first computer system with the second computer system.

In accordance with some embodiments, a method is described. The method comprises: at a computer system that is in communication with a display generation component and one or more input devices: while a real-time communication session is active on the computer system, receiving, via the one or more input devices, a request to display a set of one or more control user interface elements that correspond to respective functions associated with the real-time communication session; in response to receiving the request to display the set of one or more control user interface elements, displaying, via the display generation component, the set of one or more control user interface elements, including designating a first control user interface element of the set of one or more control user interface elements; while designating the first control user interface element, detecting, via the one or more input devices, a selection of the first control user interface element; and in response to detecting the selection of the first control user interface element, initiating a process for ending the real-time communication session.

In accordance with some embodiments, a non-transitory computer-readable storage medium is described. The non-transitory computer-readable storage medium stores one or more programs configured to be executed by one or more processors of a computer system that is in communication with a display generation component and one or more input devices. The one or more programs include instructions for: while a real-time communication session is active on the computer system, receiving, via the one or more input devices, a request to display a set of one or more control user interface elements that correspond to respective functions associated with the real-time communication session; in response to receiving the request to display the set of one or more control user interface elements, displaying, via the display generation component, the set of one or more control user interface elements, including designating a first control user interface element of the set of one or more control user interface elements; while designating the first control user interface element, detecting, via the one or more input devices, a selection of the first control user interface element; and in response to detecting the selection of the first control user interface element, initiating a process for ending the real-time communication session.

In accordance with some embodiments, a transitory computer-readable storage medium is described. The transitory computer-readable storage medium stores one or more programs configured to be executed by one or more processors of a computer system that is in communication with a display generation component and one or more input devices. The one or more programs include instructions for: while a real-time communication session is active on the computer system, receiving, via the one or more input devices, a request to display a set of one or more control user interface elements that correspond to respective functions associated with the real-time communication session; in response to receiving the request to display the set of one or more control user interface elements, displaying, via the display generation component, the set of one or more control user interface elements, including designating a first control user interface element of the set of one or more control user interface elements; while designating the first control user interface element, detecting, via the one or more input devices, a selection of the first control user interface element; and in response to detecting the selection of the first control user interface element, initiating a process for ending the real-time communication session.

In accordance with some embodiments, a computer system configured to communicate with a display generation component and one or more input devices is described. The computer system comprises: one or more processors; and memory storing one or more programs configured to be executed by the one or more processors, the one or more programs including instructions for: while a real-time communication session is active on the computer system, receiving, via the one or more input devices, a request to display a set of one or more control user interface elements that correspond to respective functions associated with the real-time communication session; in response to receiving the request to display the set of one or more control user interface elements, displaying, via the display generation component, the set of one or more control user interface elements, including designating a first control user interface element of the set of one or more control user interface elements; while designating the first control user interface element, detecting, via the one or more input devices, a selection of the first control user interface element; and in response to detecting the selection of the first control user interface element, initiating a process for ending the real-time communication session.

In accordance with some embodiments, a computer system configured to communicate with a display generation component and one or more input devices is described. The computer system comprises: means for, while a real-time communication session is active on the computer system, receiving, via the one or more input devices, a request to display a set of one or more control user interface elements that correspond to respective functions associated with the real-time communication session; means for, in response to receiving the request to display the set of one or more control user interface elements, displaying, via the display generation component, the set of one or more control user interface elements, including designating a first control user interface element of the set of one or more control user interface elements; means for, while designating the first control user interface element, detecting, via the one or more input devices, a selection of the first control user interface element; and means for, in response to detecting the selection of the first control user interface element, initiating a process for ending the real-time communication session.

In accordance with some embodiments, a computer program product is described. The computer program product comprises one or more programs configured to be executed by one or more processors of a computer system that is in communication with a display generation component and one or more input devices. The one or more programs include instructions for: while a real-time communication session is active on the computer system, receiving, via the one or more input devices, a request to display a set of one or more control user interface elements that correspond to respective functions associated with the real-time communication session; in response to receiving the request to display the set of one or more control user interface elements, displaying, via the display generation component, the set of one or more control user interface elements, including designating a first control user interface element of the set of one or more control user interface elements; while designating the first control user interface element, detecting, via the one or more input devices, a selection of the first control user interface element; and in response to detecting the selection of the first control user interface element, initiating a process for ending the real-time communication session.

In accordance with some embodiments, a method is described. The method comprises: at a computer system that is in communication with a display generation component and one or more input devices: while displaying, via the display generation component, a first user interface, receiving, via the one or more input devices, a request to navigate to a second user interface that is different from the first user interface; and in response to receiving the request to navigate to the second user interface: in accordance with a determination that the first user interface is included in a real-time communication session that is active on the computer system, displaying, via the display generation component, a first user interface element that, when selected, causes the computer system to maintain display of the first user interface; and in accordance with a determination that the first user interface is not included in a real-time communication session that is active on the first computer system, displaying, via the display generation component, the second user interface.

In accordance with some embodiments, a non-transitory computer-readable storage medium is described. The non-transitory computer-readable storage medium stores one or more programs configured to be executed by one or more processors of a computer system that is in communication with a display generation component and one or more input devices. The one or more programs include instructions for: while displaying, via the display generation component, a first user interface, receiving, via the one or more input devices, a request to navigate to a second user interface that is different from the first user interface; and in response to receiving the request to navigate to the second user interface: in accordance with a determination that the first user interface is included in a real-time communication session that is active on the computer system, displaying, via the display generation component, a first user interface element that, when selected, causes the computer system to maintain display of the first user interface; and in accordance with a determination that the first user interface is not included in a real-time communication session that is active on the first computer system, displaying, via the display generation component, the second user interface.

In accordance with some embodiments, a transitory computer-readable storage medium is described. The transitory computer-readable storage medium stores one or more programs configured to be executed by one or more processors of a computer system that is in communication with a display generation component and one or more input devices. The one or more programs include instructions for: while displaying, via the display generation component, a first user interface, receiving, via the one or more input devices, a request to navigate to a second user interface that is different from the first user interface; and in response to receiving the request to navigate to the second user interface: in accordance with a determination that the first user interface is included in a real-time communication session that is active on the computer system, displaying, via the display generation component, a first user interface element that, when selected, causes the computer system to maintain display of the first user interface; and in accordance with a determination that the first user interface is not included in a real-time communication session that is active on the first computer system, displaying, via the display generation component, the second user interface.

In accordance with some embodiments, a computer system configured to communicate with a display generation component and one or more input devices is described. The computer system comprises: one or more processors; and memory storing one or more programs configured to be executed by the one or more processors, the one or more programs including instructions for: while displaying, via the display generation component, a first user interface, receiving, via the one or more input devices, a request to navigate to a second user interface that is different from the first user interface; and in response to receiving the request to navigate to the second user interface: in accordance with a determination that the first user interface is included in a real-time communication session that is active on the computer system, displaying, via the display generation component, a first user interface element that, when selected, causes the computer system to maintain display of the first user interface; and in accordance with a determination that the first user interface is not included in a real-time communication session that is active on the first computer system, displaying, via the display generation component, the second user interface.

In accordance with some embodiments, a computer system configured to communicate with a display generation component and one or more input devices is described. The computer system comprises: means for, while displaying, via the display generation component, a first user interface, receiving, via the one or more input devices, a request to navigate to a second user interface that is different from the first user interface; and means for, in response to receiving the request to navigate to the second user interface: in accordance with a determination that the first user interface is included in a real-time communication session that is active on the computer system, displaying, via the display generation component, a first user interface element that, when selected, causes the computer system to maintain display of the first user interface; and in accordance with a determination that the first user interface is not included in a real-time communication session that is active on the first computer system, displaying, via the display generation component, the second user interface.

In accordance with some embodiments, a computer program product is described. The computer program product comprises one or more programs configured to be executed by one or more processors of a computer system that is in communication with a display generation component and one or more input devices. The one or more programs include instructions for: while displaying, via the display generation component, a first user interface, receiving, via the one or more input devices, a request to navigate to a second user interface that is different from the first user interface; and in response to receiving the request to navigate to the second user interface: in accordance with a determination that the first user interface is included in a real-time communication session that is active on the computer system, displaying, via the display generation component, a first user interface element that, when selected, causes the computer system to maintain display of the first user interface; and in accordance with a determination that the first user interface is not included in a real-time communication session that is active on the first computer system, displaying, via the display generation component, the second user interface.

In accordance with some embodiments, a method is described. The method comprises: at a computer system that is in communication with a display generation component and one or more input devices: while displaying, via the display generation component, a user interface, detecting, via the one or more input devices, a request to display a system-level menu; and in response to detecting the request to display the system-level menu, displaying, via the display generation component, the system-level menu, including: in accordance with a determination that the computer system is operating in a first context, displaying, via the display generation component, a sub-menu corresponding to a first menu option in the system-level menu; and in accordance with a determination that the computer system is operating in a second context that is different from the first context, displaying, via the display generation component, a sub-menu corresponding to a second menu option in the system-level menu that is different from the first menu option.

In accordance with some embodiments, a non-transitory computer-readable storage medium is described. The non-transitory computer-readable storage medium stores one or more programs configured to be executed by one or more processors of a computer system that is in communication with a display generation component and one or more input devices. The one or more programs include instructions for: while displaying, via the display generation component, a user interface, detecting, via the one or more input devices, a request to display a system-level menu; and in response to detecting the request to display the system-level menu, displaying, via the display generation component, the system-level menu, including: in accordance with a determination that the computer system is operating in a first context, displaying, via the display generation component, a sub-menu corresponding to a first menu option in the system-level menu; and in accordance with a determination that the computer system is operating in a second context that is different from the first context, displaying, via the display generation component, a sub-menu corresponding to a second menu option in the system-level menu that is different from the first menu option.

In accordance with some embodiments, a transitory computer-readable storage medium is described. The transitory computer-readable storage medium stores one or more programs configured to be executed by one or more processors of a computer system that is in communication with a display generation component and one or more input devices. The one or more programs include instructions for: while displaying, via the display generation component, a user interface, detecting, via the one or more input devices, a request to display a system-level menu; and in response to detecting the request to display the system-level menu, displaying, via the display generation component, the system-level menu, including: in accordance with a determination that the computer system is operating in a first context, displaying, via the display generation component, a sub-menu corresponding to a first menu option in the system-level menu; and in accordance with a determination that the computer system is operating in a second context that is different from the first context, displaying, via the display generation component, a sub-menu corresponding to a second menu option in the system-level menu that is different from the first menu option.

In accordance with some embodiments, a computer system configured to communicate with a display generation component and one or more input devices is described. The computer system comprises: one or more processors; and memory storing one or more programs configured to be executed by the one or more processors, the one or more programs including instructions for: while displaying, via the display generation component, a user interface, detecting, via the one or more input devices, a request to display a system-level menu; and in response to detecting the request to display the system-level menu, displaying, via the display generation component, the system-level menu, including: in accordance with a determination that the computer system is operating in a first context, displaying, via the display generation component, a sub-menu corresponding to a first menu option in the system-level menu; and in accordance with a determination that the computer system is operating in a second context that is different from the first context, displaying, via the display generation component, a sub-menu corresponding to a second menu option in the system-level menu that is different from the first menu option.

In accordance with some embodiments, a computer system configured to communicate with a display generation component and one or more input devices is described. The computer system comprises: means for, while displaying, via the display generation component, a user interface, detecting, via the one or more input devices, a request to display a system-level menu; and means for, in response to detecting the request to display the system-level menu, displaying, via the display generation component, the system-level menu, including: in accordance with a determination that the computer system is operating in a first context, displaying, via the display generation component, a sub-menu corresponding to a first menu option in the system-level menu; and in accordance with a determination that the computer system is operating in a second context that is different from the first context, displaying, via the display generation component, a sub-menu corresponding to a second menu option in the system-level menu that is different from the first menu option.

In accordance with some embodiments, a computer program product is described. The computer program product comprises one or more programs configured to be executed by one or more processors of a computer system that is in communication with a display generation component and one or more input devices. The one or more programs include instructions for: while displaying, via the display generation component, a user interface, detecting, via the one or more input devices, a request to display a system-level menu; and in response to detecting the request to display the system-level menu, displaying, via the display generation component, the system-level menu, including: in accordance with a determination that the computer system is operating in a first context, displaying, via the display generation component, a sub-menu corresponding to a first menu option in the system-level menu; and in accordance with a determination that the computer system is operating in a second context that is different from the first context, displaying, via the display generation component, a sub-menu corresponding to a second menu option in the system-level menu that is different from the first menu option.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for electronic communication and connecting a camera to a device, thereby increasing the effectiveness, efficiency, and user satisfaction with such devices. Such methods and interfaces may complement or replace other methods for electronic communication and connecting a camera to a device.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIG. 5C illustrates an exemplary diagram of a communication session between electronic devices in accordance with some embodiments.

FIGS. 6A-6I illustrate user interfaces for managing a real-time communication session, in accordance with some embodiments.

FIG. 7 is a flow diagram illustrating methods for managing a real-time communication session, in accordance with some embodiments.

FIGS. 8A-8P illustrate user interfaces for connecting cameras to devices, in accordance with some embodiments.

FIG. 9 is a flow diagram illustrating methods for connecting cameras to devices, in accordance with some embodiments.

FIGS. 10A-10I illustrate user interfaces for managing a real-time communication session, in accordance with some embodiments.

FIG. 11 is a flow diagram illustrating methods for managing a real-time communication session, in accordance with some embodiments.

FIGS. 12A-120 illustrate user interfaces for managing a real-time communication session, in accordance with some embodiments.

FIG. 13 is a flow diagram illustrating methods for managing a real-time communication session, in accordance with some embodiments.

FIGS. 14A-14E illustrate user interfaces for providing a menu, in accordance with some embodiments.

FIG. 15 is a flow diagram illustrating methods for providing a menu, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for electronic communication and connecting a camera to a device. In some embodiments, when a set of handoff criteria are met, a first computer system displays a handoff user interface element for initiating a handoff process that includes capturing video for a real-time communication session using one or more camera sensors of the first computer system while a user interface of the real-time communication session is displayed by a second computer system. In some embodiments, in response to detecting a request to display an application that uses data captured by a camera sensor, a first computer system displays the application or displays a connection user interface element for initiating a process for connecting the first computer system with a second computer system based on whether the first computer system is connected to a camera. In some embodiments, while a real-time communication session is active on a computer system, in response to receiving a request to display a set of one or more control user interface elements, the computer system designates for selection a control user interface element for ending the real-time communication session. In some embodiments, in response to receiving a request to navigate from a first user interface to a second user interface, a computer system displays the second user interface or displays a user interface element for maintaining display of the first user interface based on whether the first user interface is included in a real-time communication session. In some embodiments, a computer system displays a system-level menu with options of a sub-menu displayed based on the context in which the computer system is operating. Such techniques can reduce the cognitive burden on a user who perform electronic communication and connect a camera to a device, thereby enhancing productivity. Further, such techniques can reduce processor and battery power otherwise wasted on redundant user inputs.

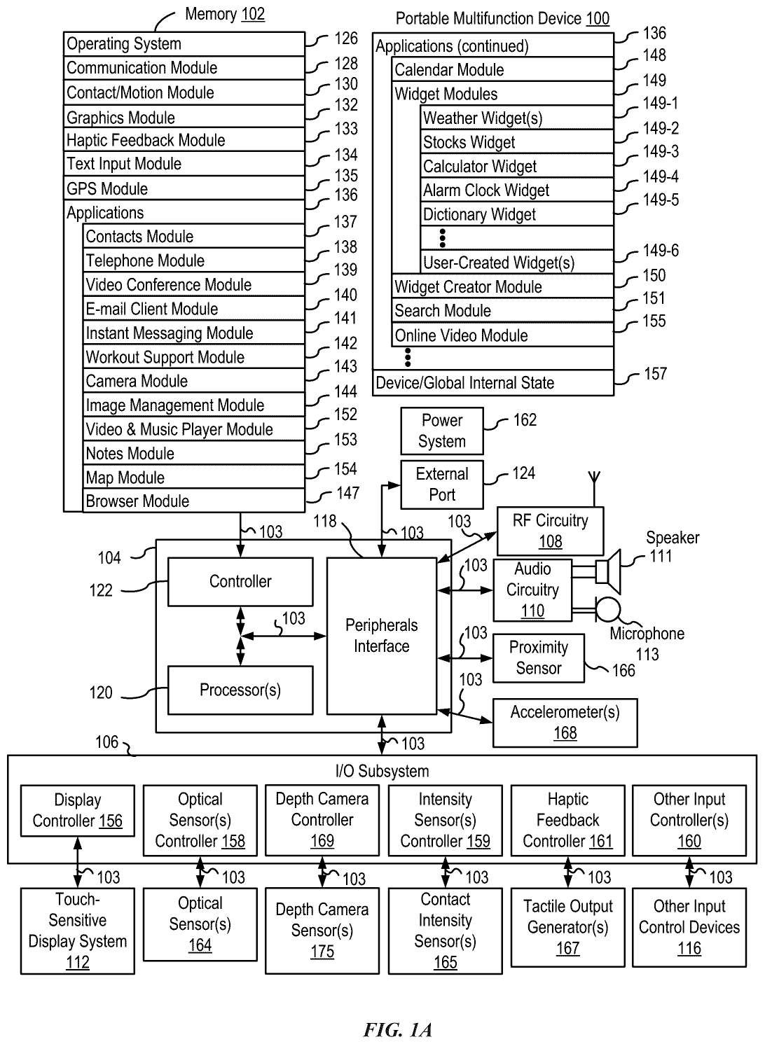

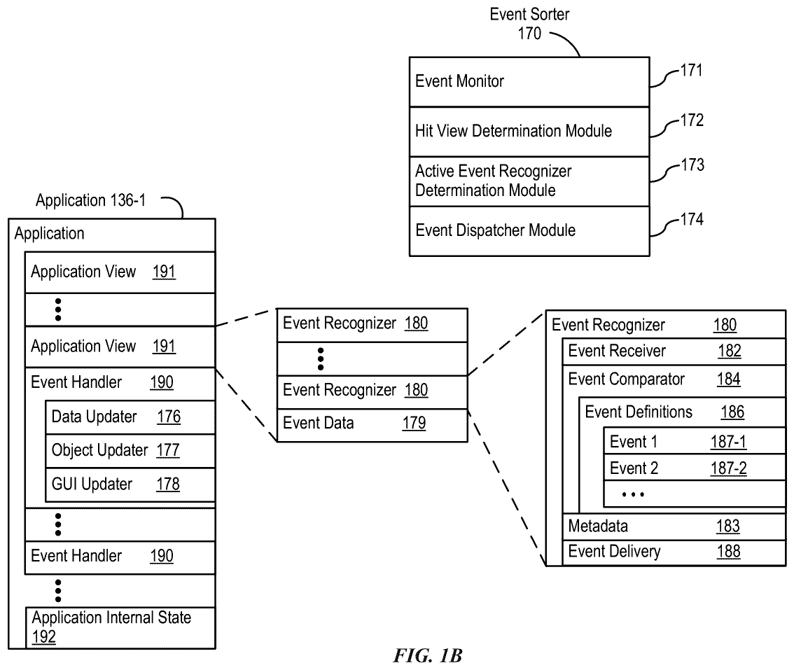

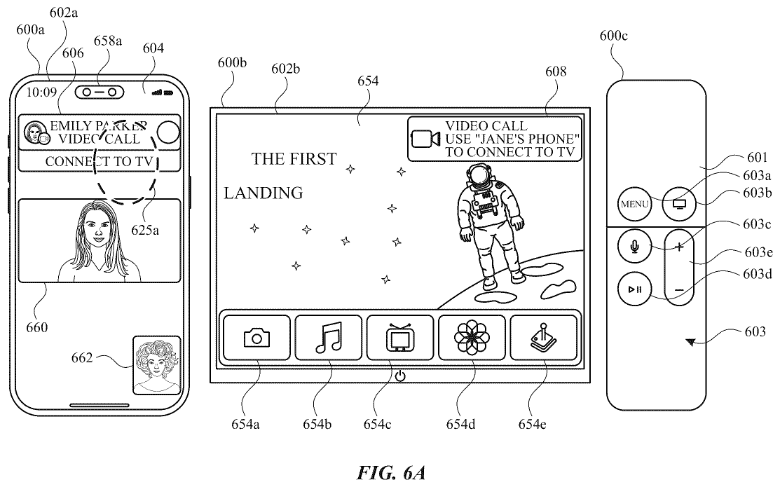

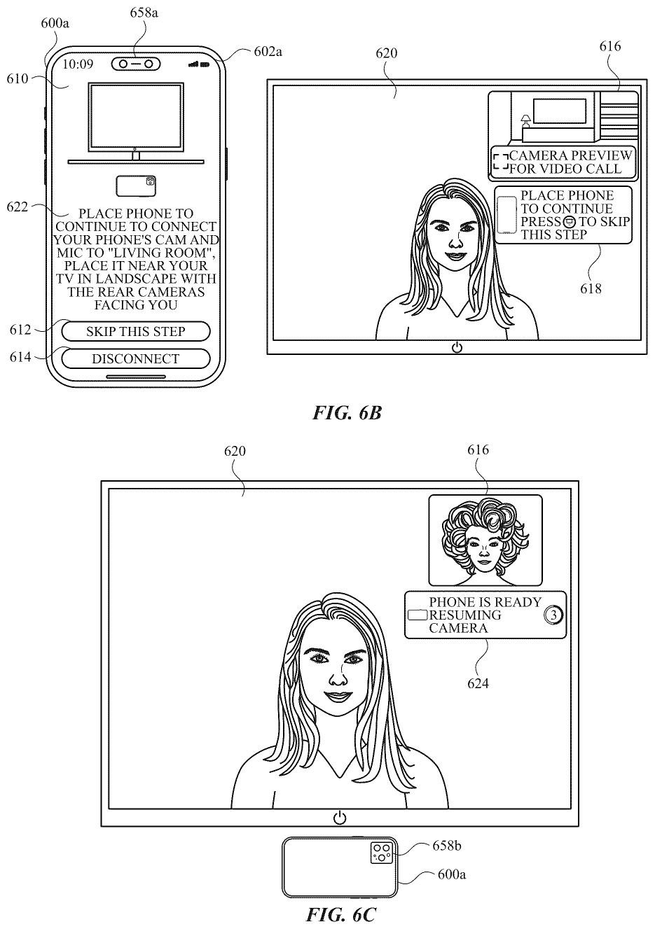

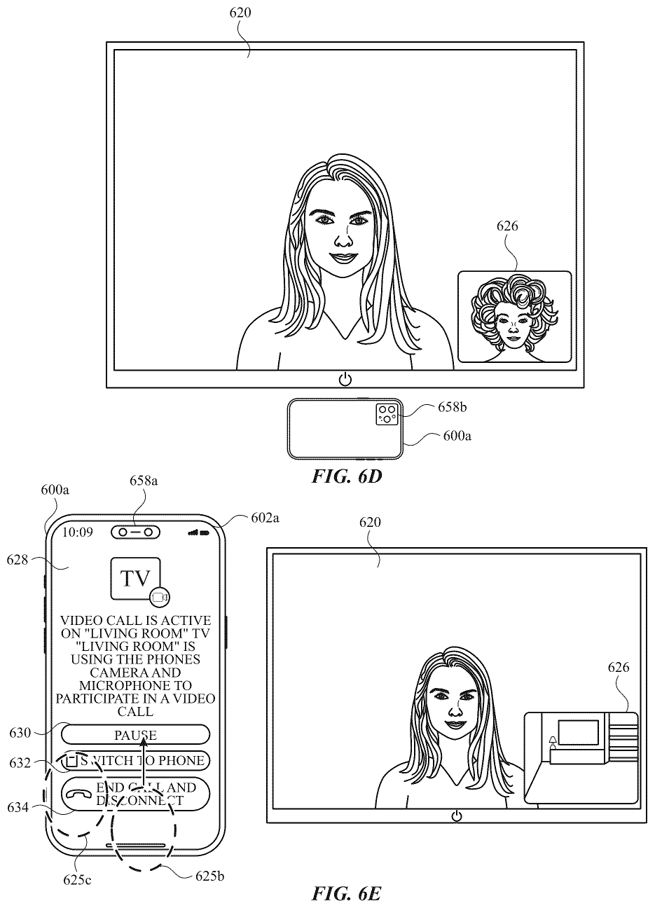

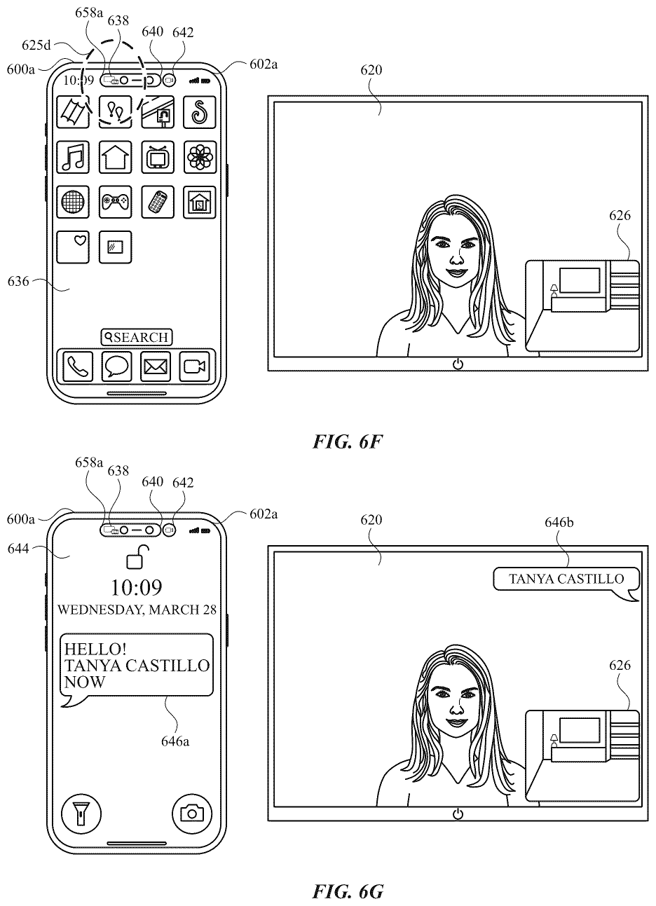

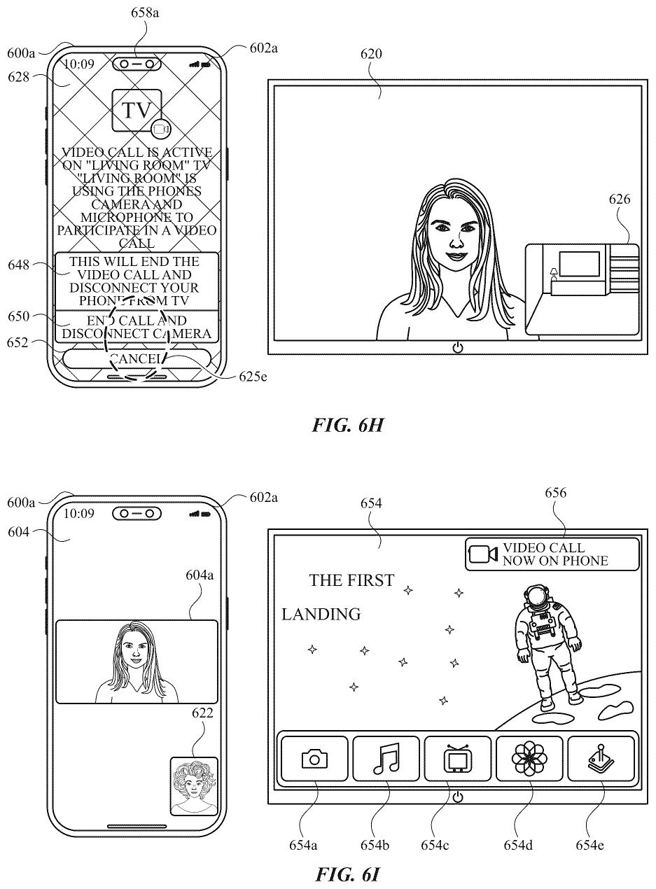

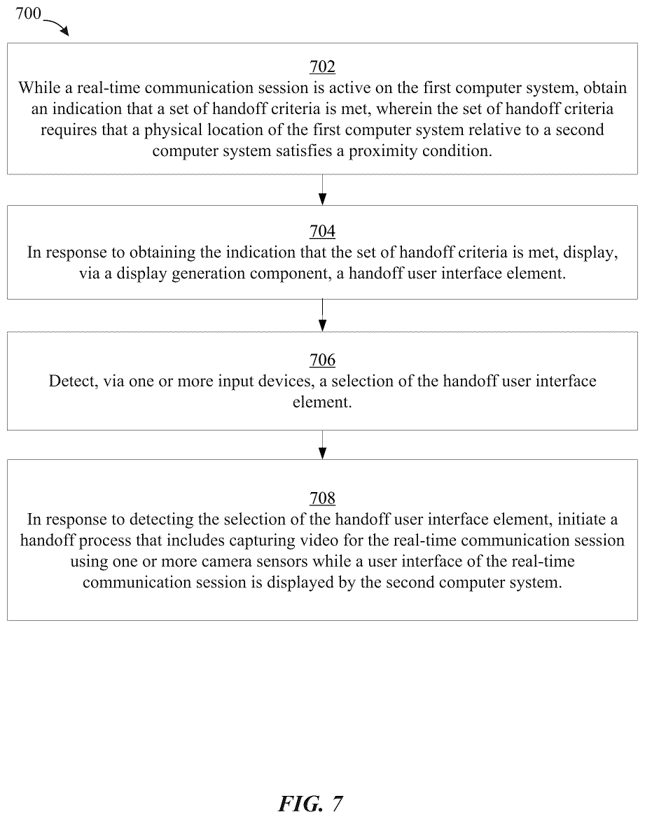

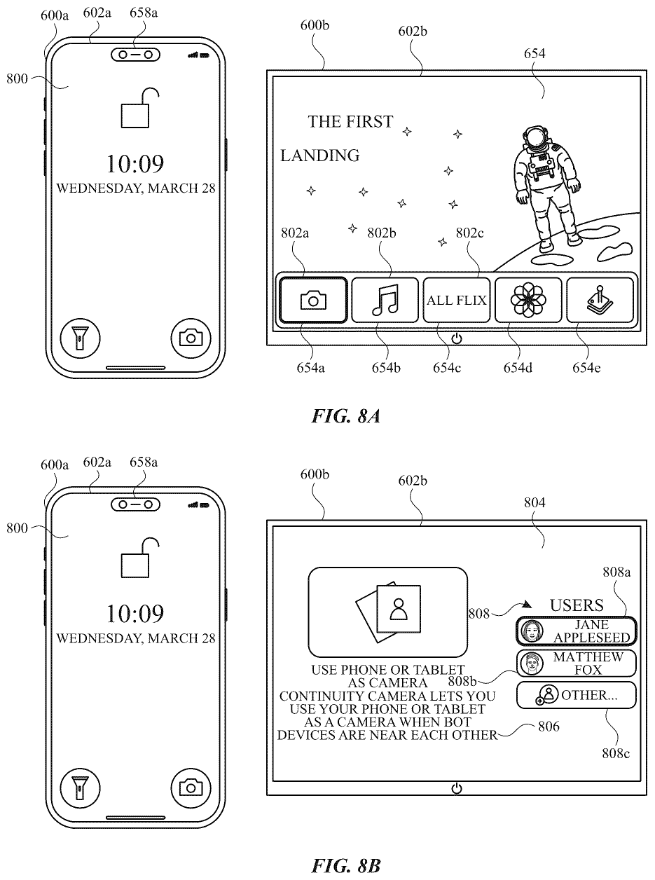

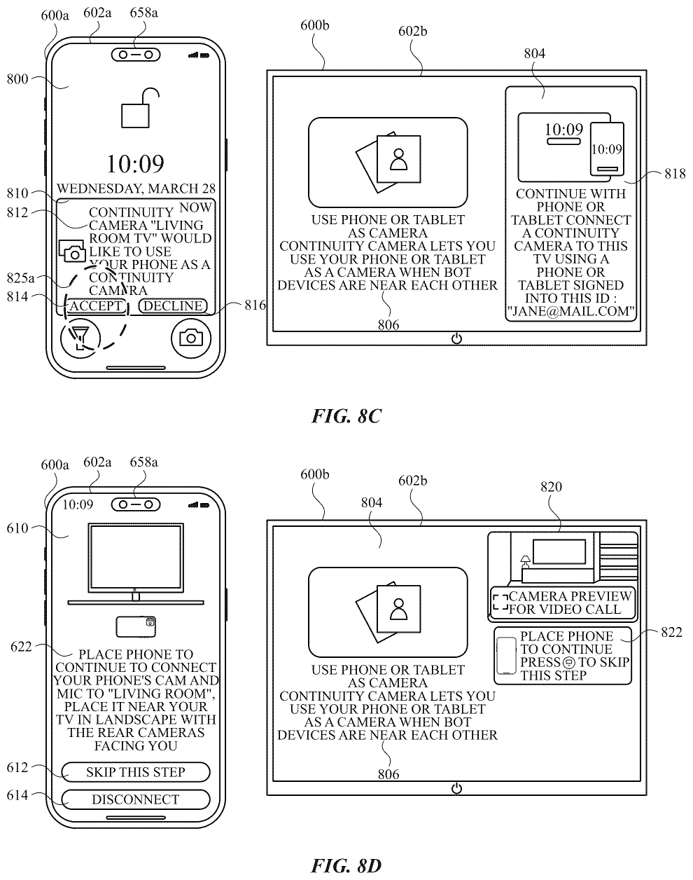

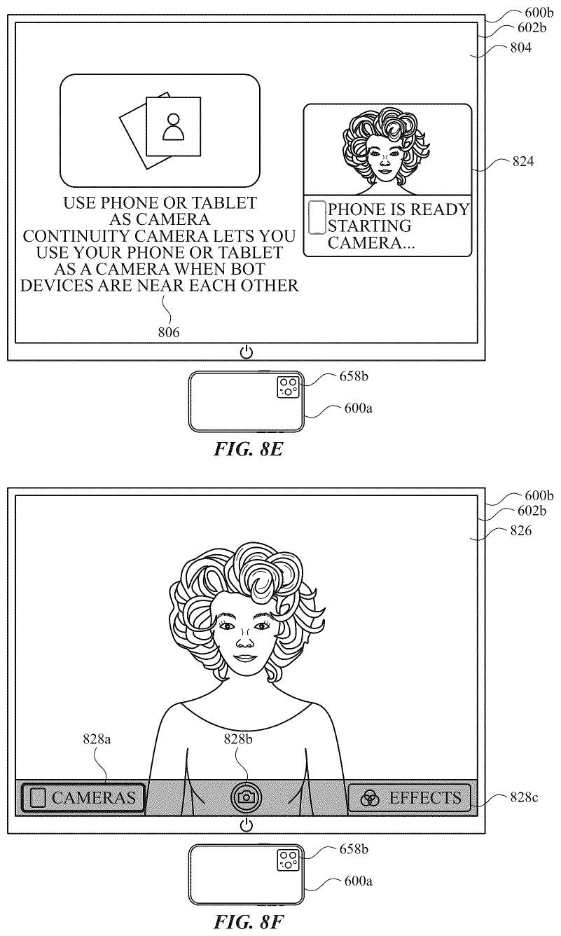

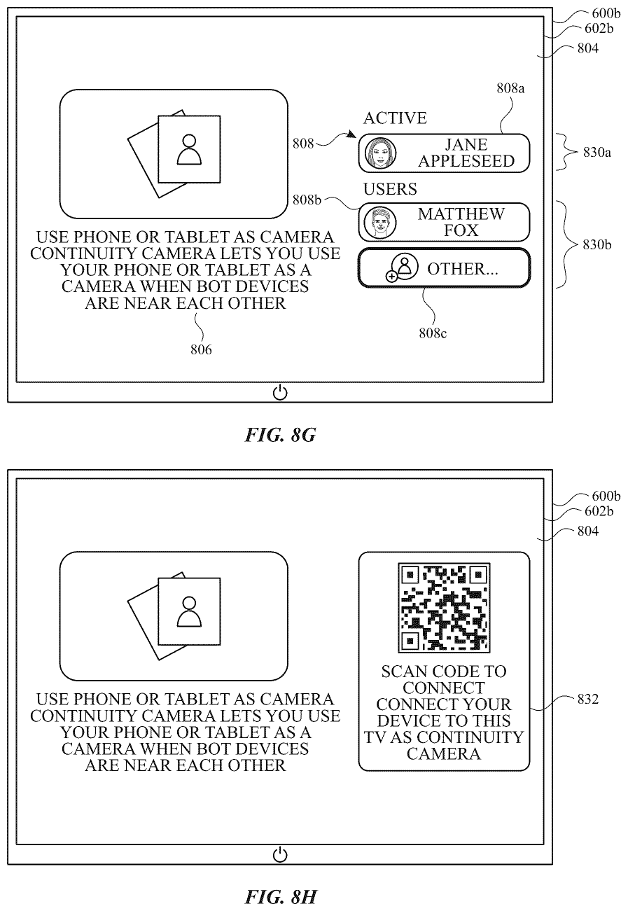

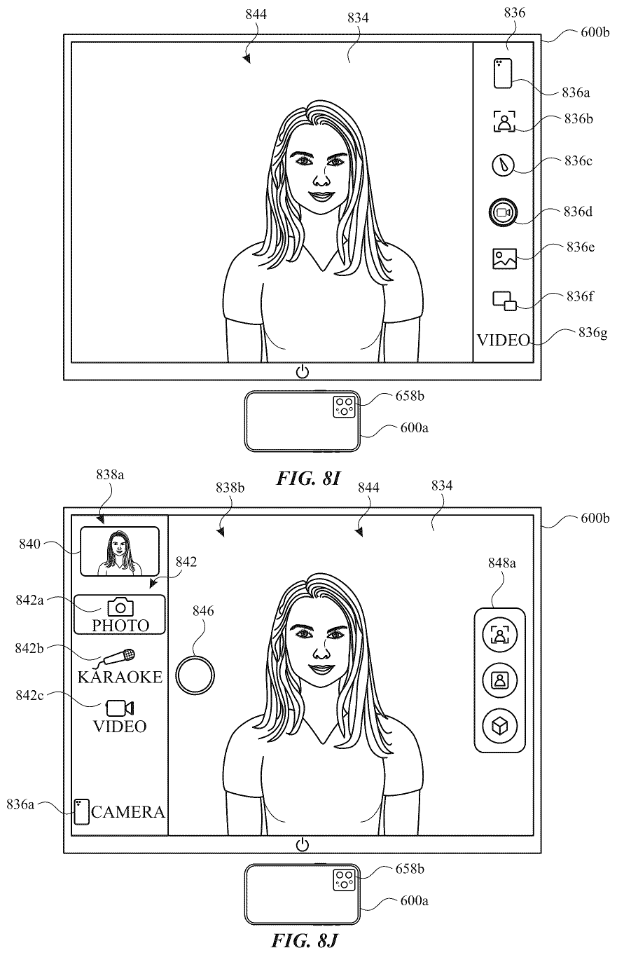

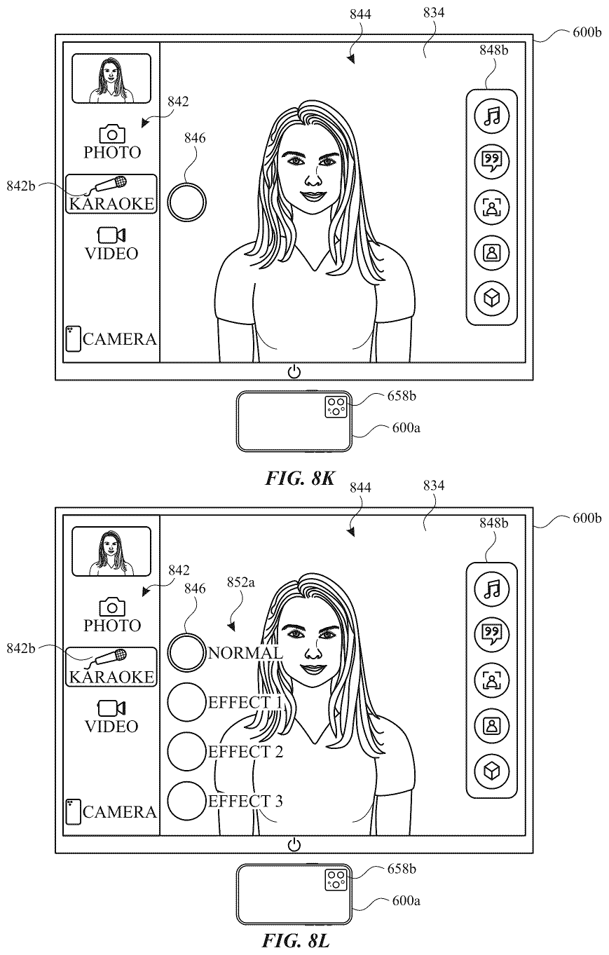

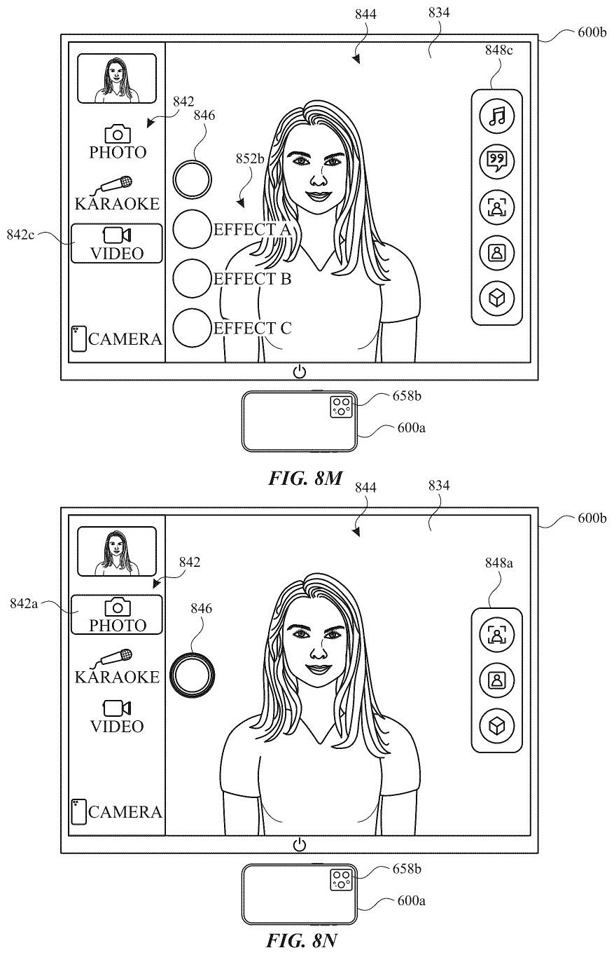

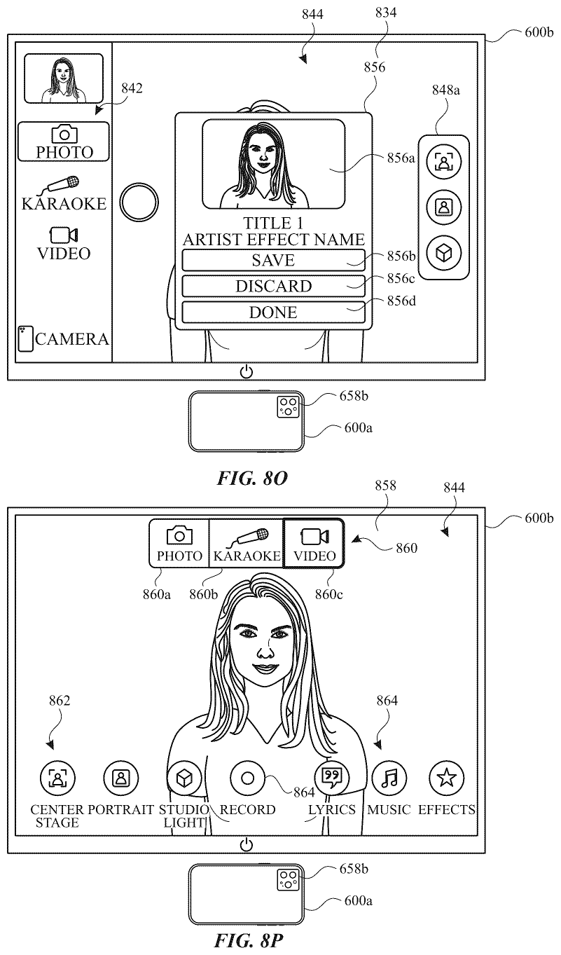

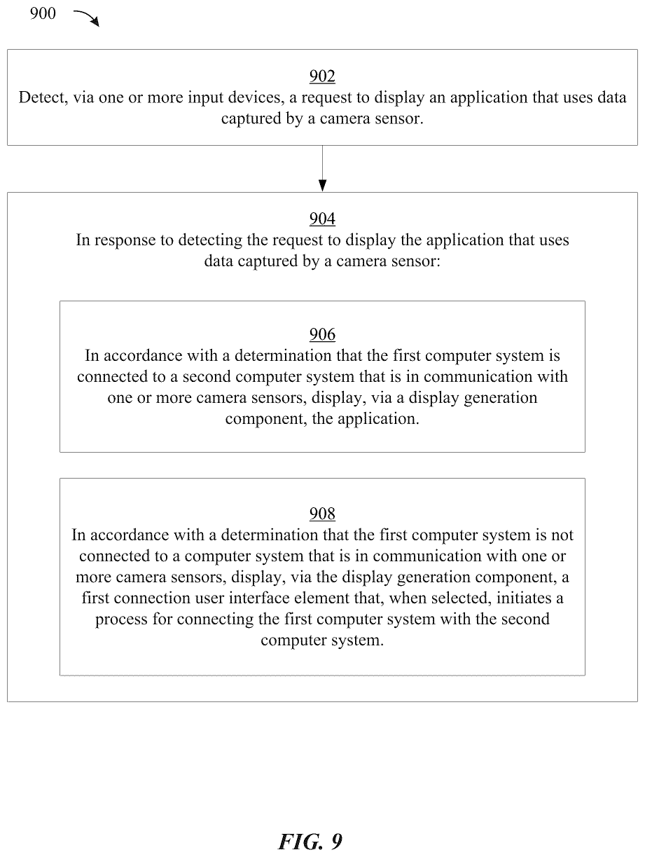

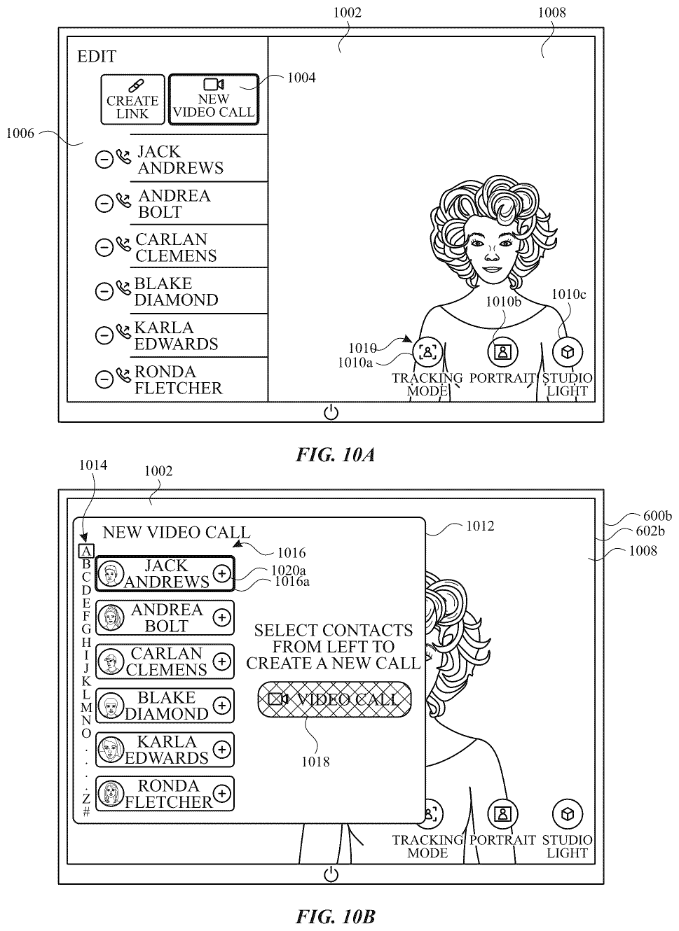

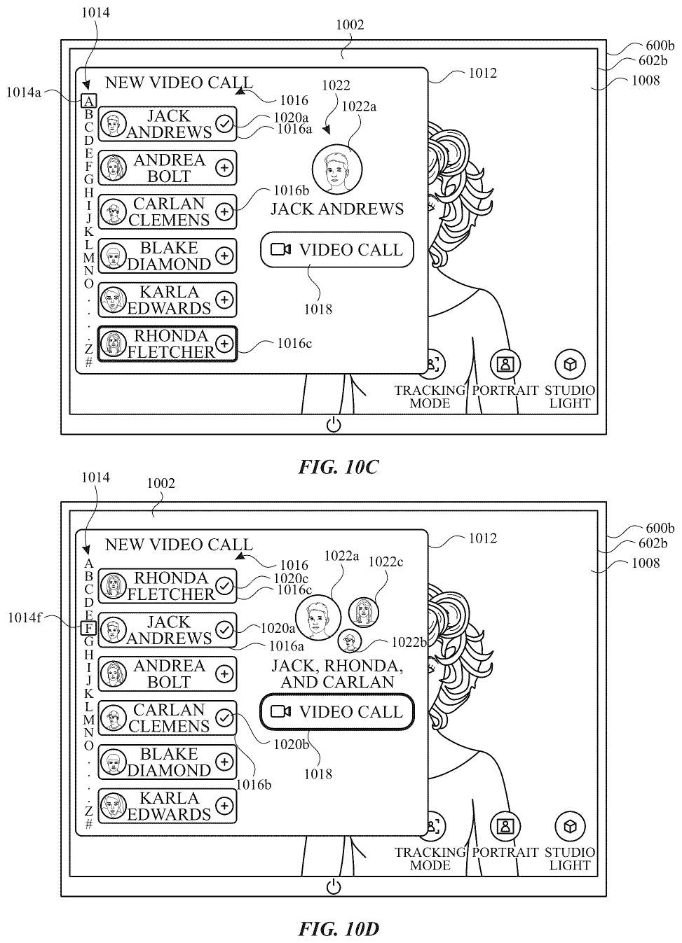

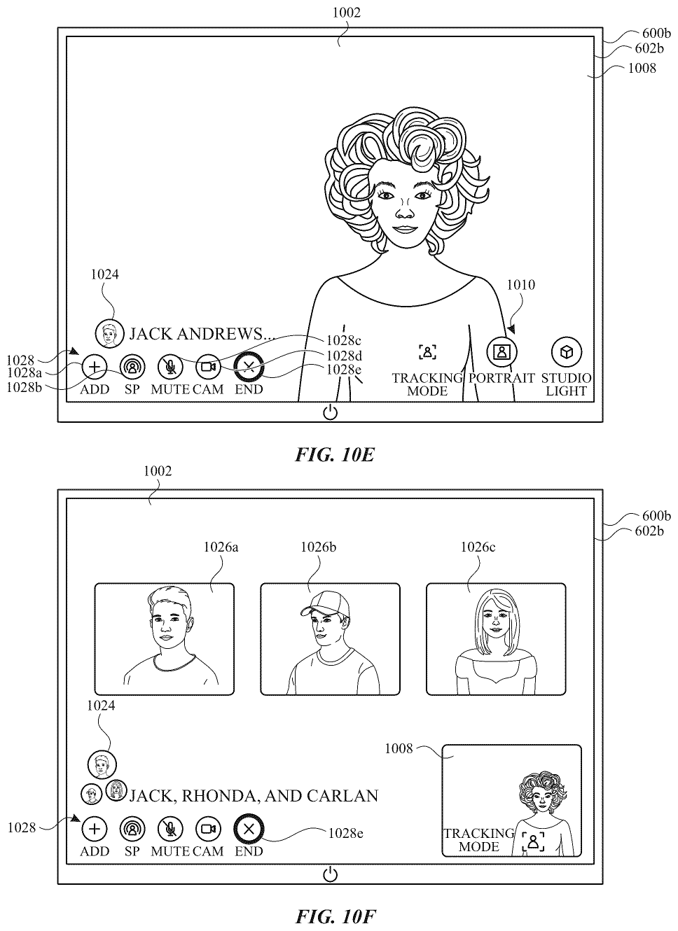

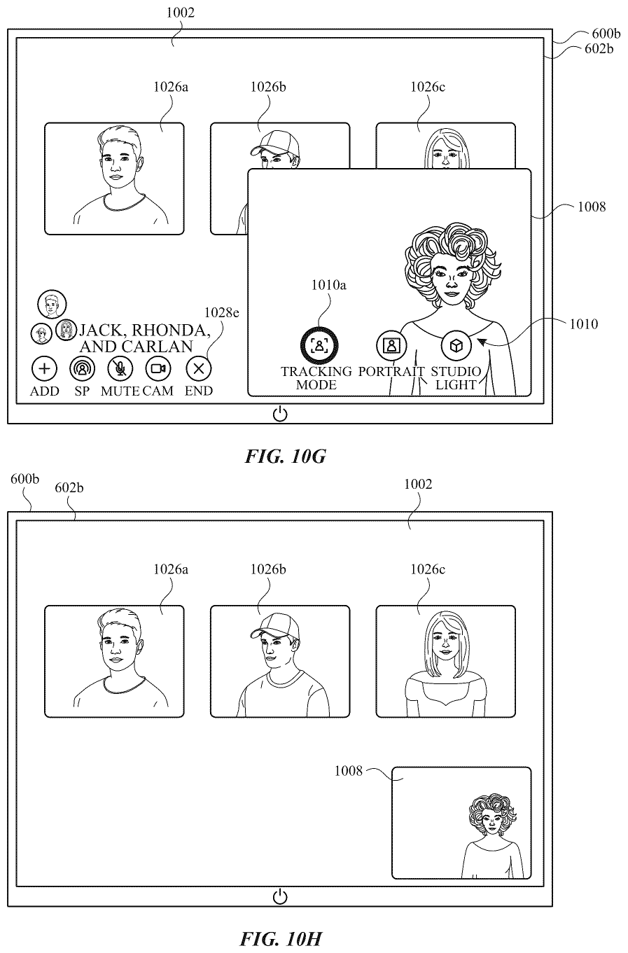

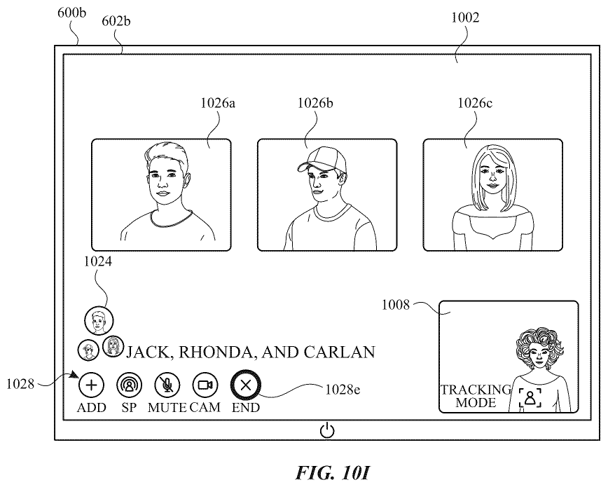

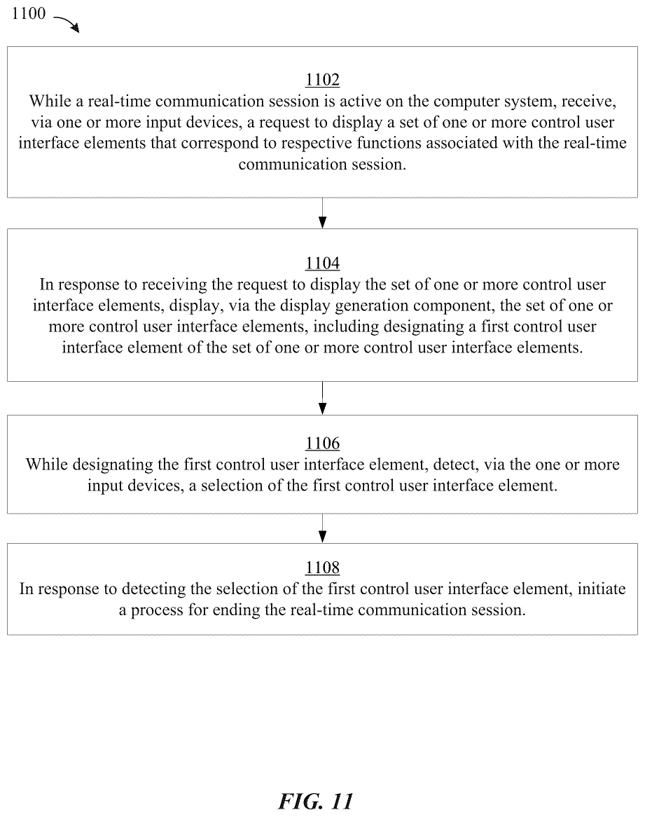

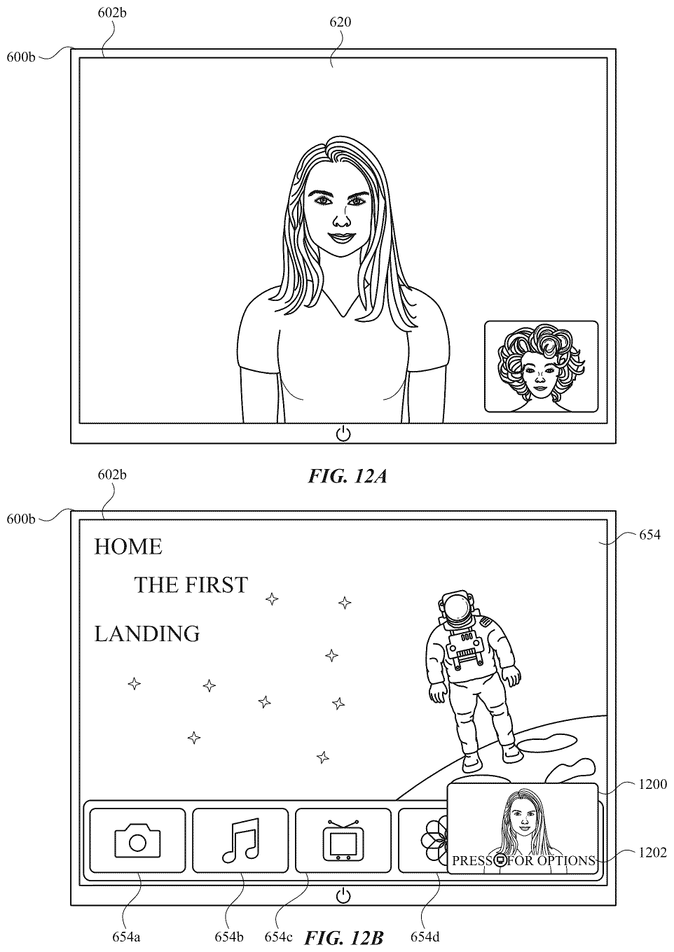

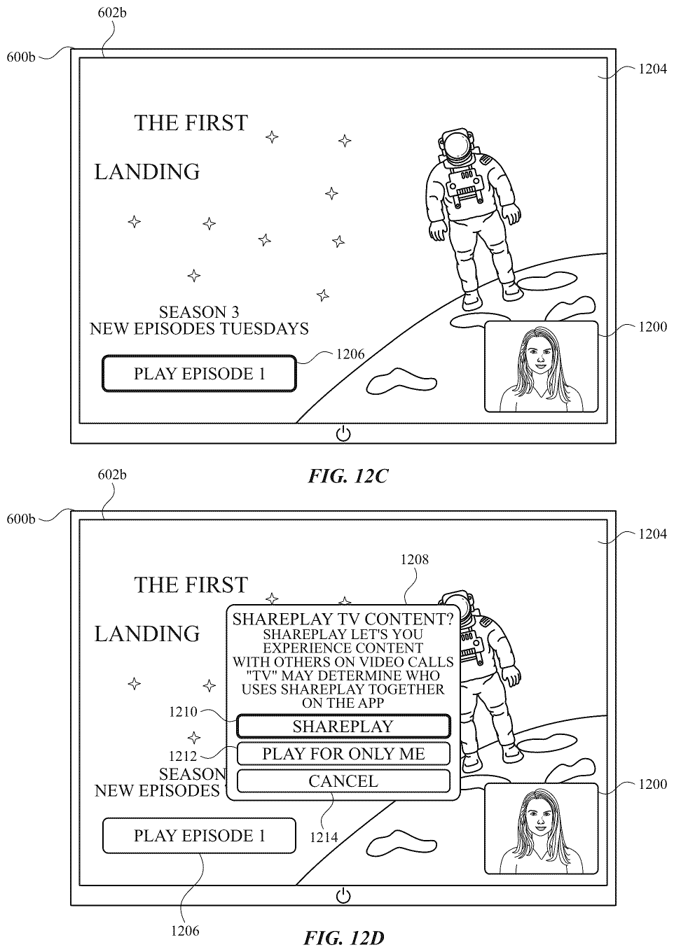

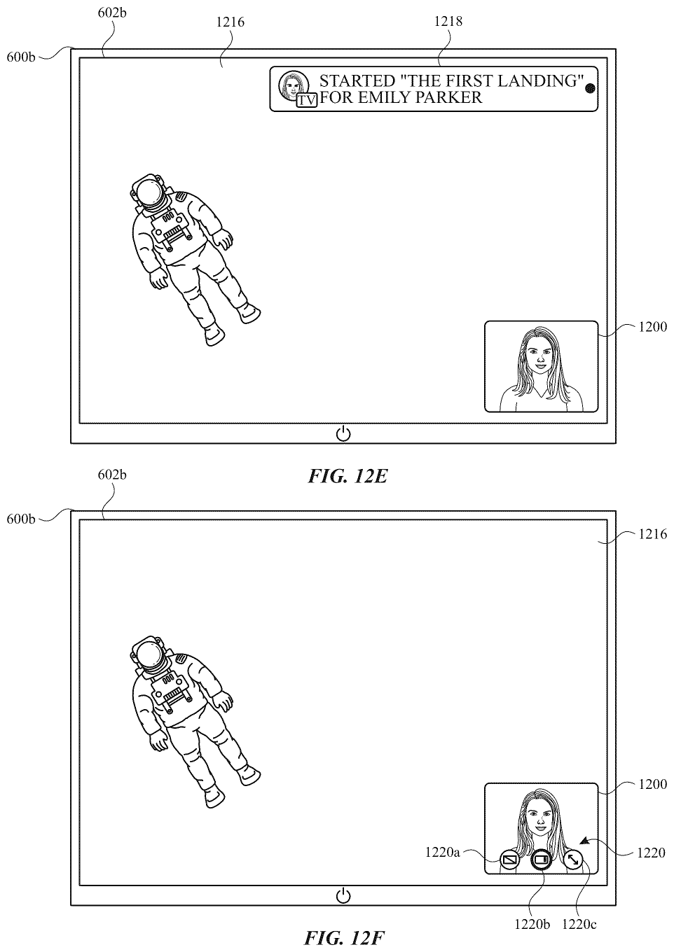

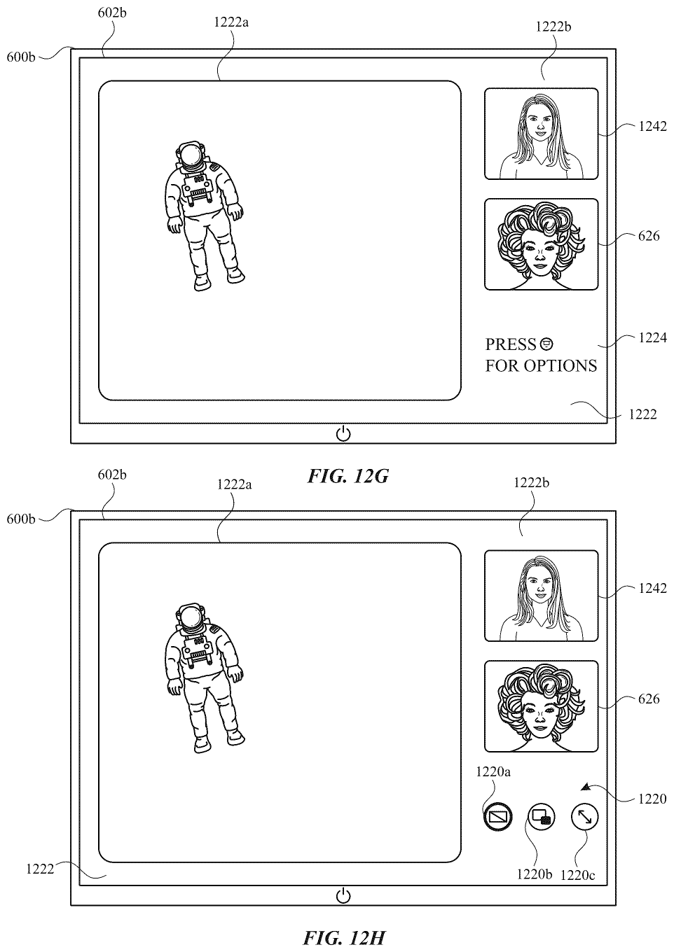

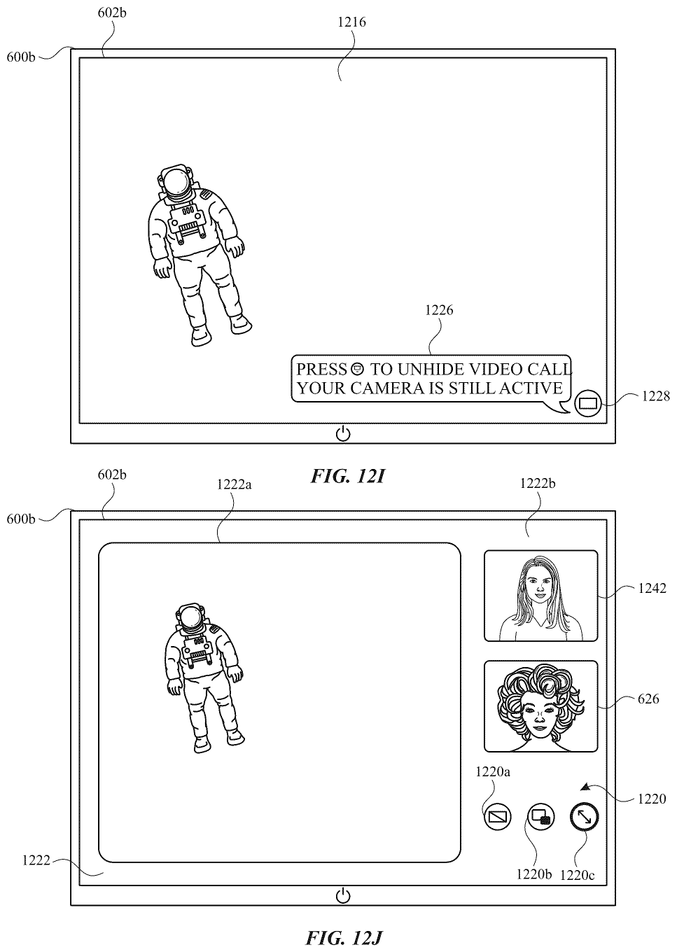

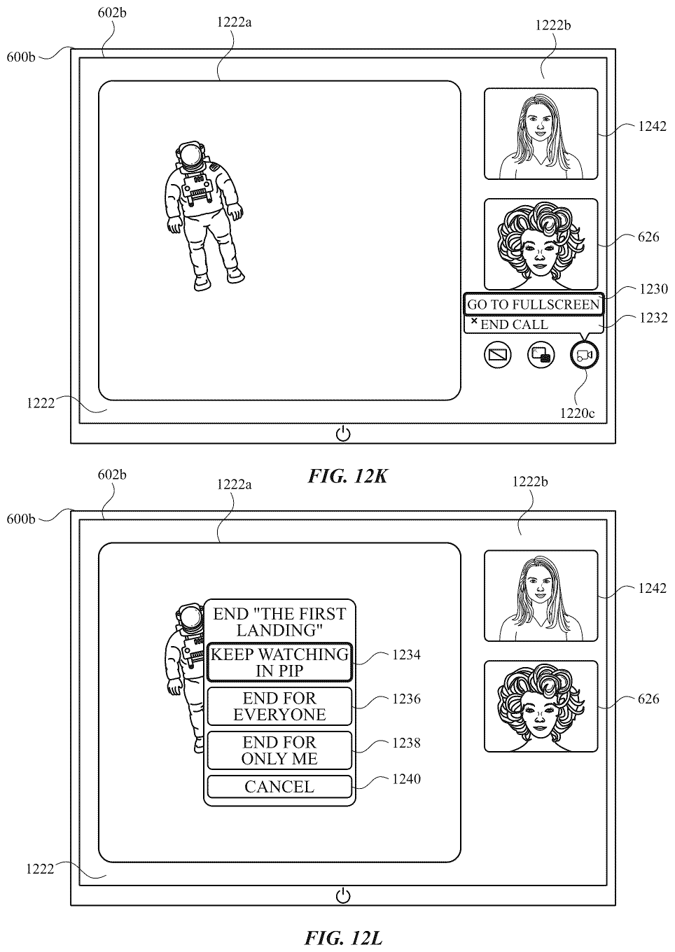

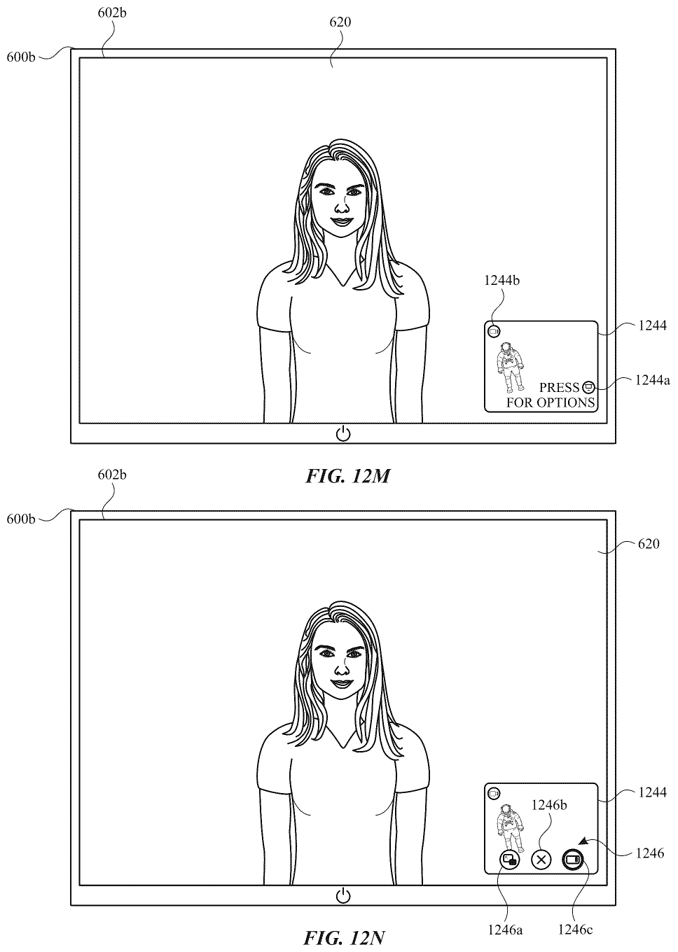

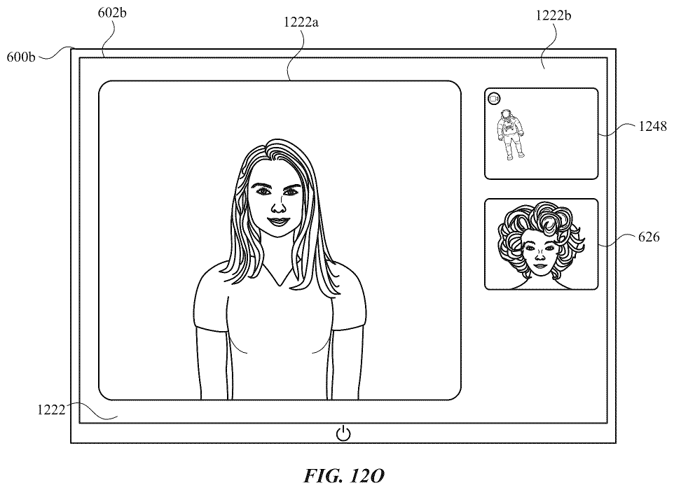

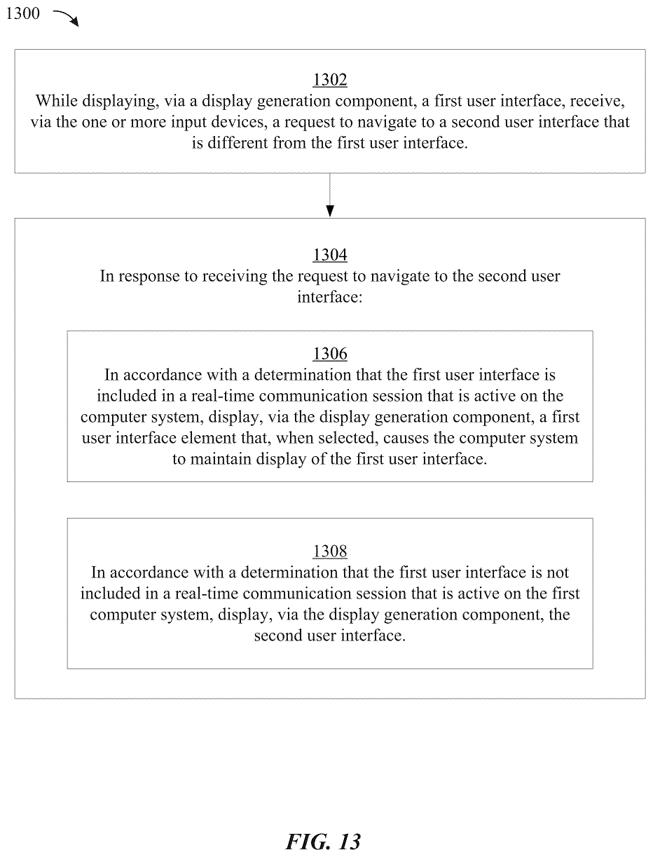

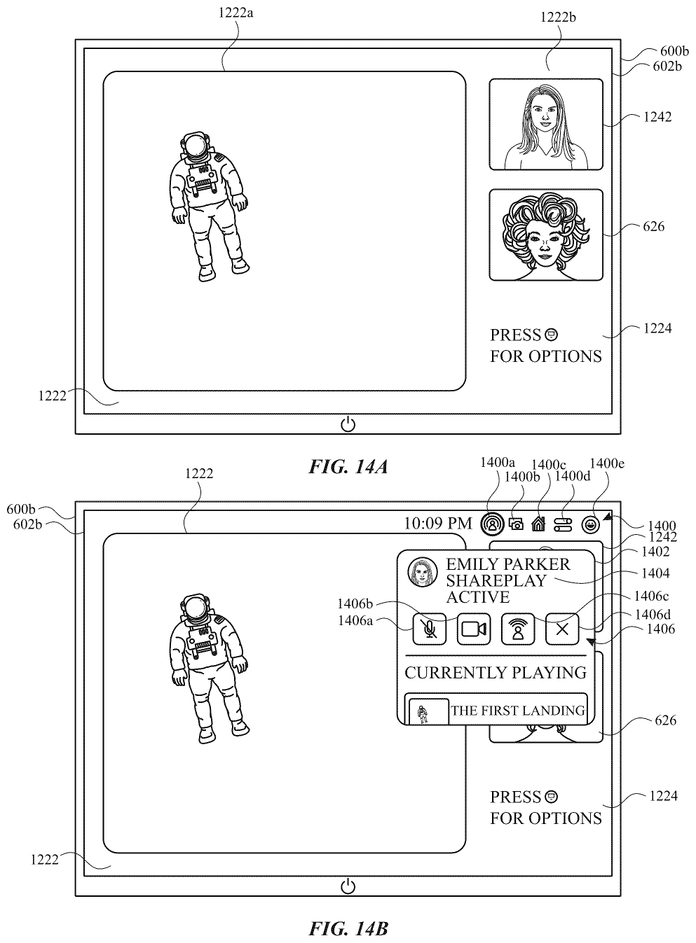

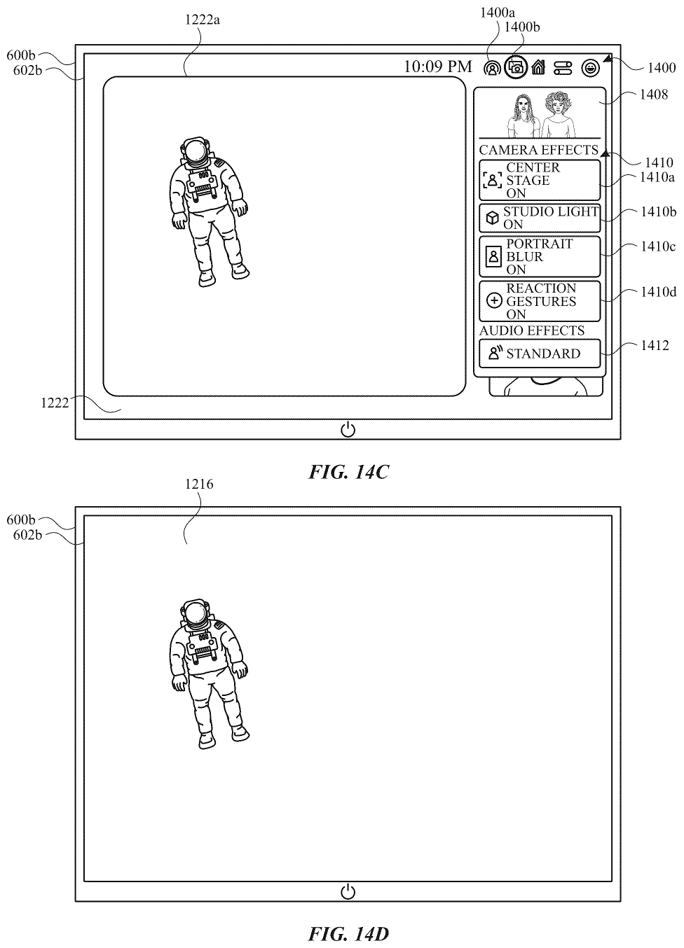

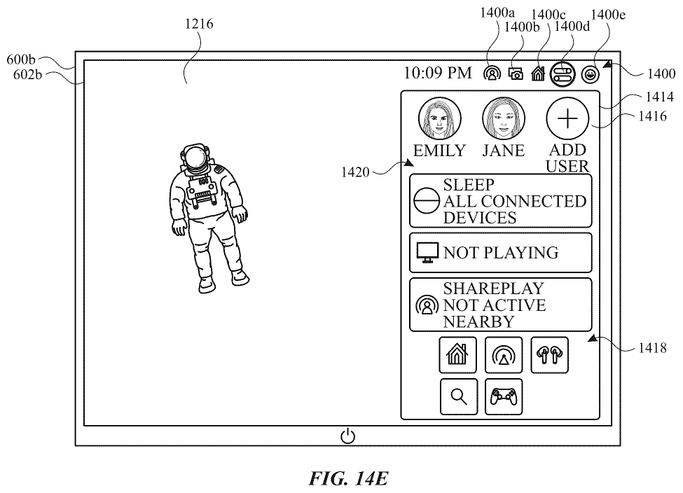

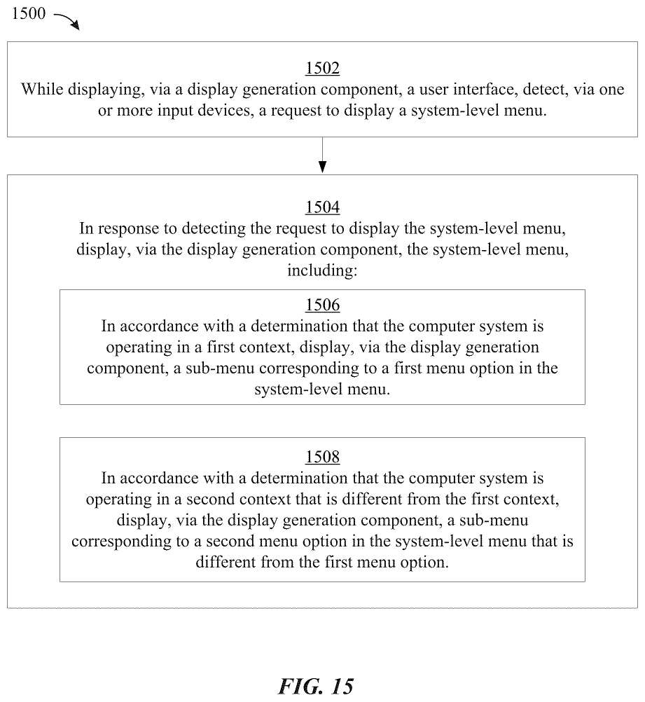

Below, FIGS. 1A-1B, 2, 3, 4A-4B, and 5A-5C provide a description of exemplary devices for performing the techniques for managing event notifications. FIGS. 6A-61 illustrate exemplary user interfaces for managing event notifications. FIG. 7 is a flow diagram illustrating methods of managing event notifications in accordance with some embodiments. The user interfaces in FIGS. 6A-61 are used to illustrate the processes described below, including the processes in FIG. 7. FIGS. 8A-8P illustrate exemplary user interfaces for accessing event notifications. FIG. 9 is a flow diagram illustrating methods of accessing event notifications in accordance with some embodiments. The user interfaces in FIGS. 8A-8P are used to illustrate the processes described below, including the processes in FIG. 9. FIGS. 10A-10I illustrate exemplary user interfaces for accessing event notifications. FIG. 11 is a flow diagram illustrating methods of accessing event notifications in accordance with some embodiments. The user interfaces in FIGS. 10A-101 are used to illustrate the processes described below, including the processes in FIG. 11. FIGS. 12A-120 illustrate exemplary user interfaces for accessing event notifications. FIG. 13 is a flow diagram illustrating methods of accessing event notifications in accordance with some embodiments. The user interfaces in FIGS. 12A-120 are used to illustrate the processes described below, including the processes in FIG. 13. FIGS. 14A-14E illustrate exemplary user interfaces for accessing event notifications. FIG. 15 is a flow diagram illustrating methods of accessing event notifications in accordance with some embodiments. The user interfaces in FIGS. 14A-14E are used to illustrate the processes described below, including the processes in FIG. 15.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, providing improved privacy and security, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

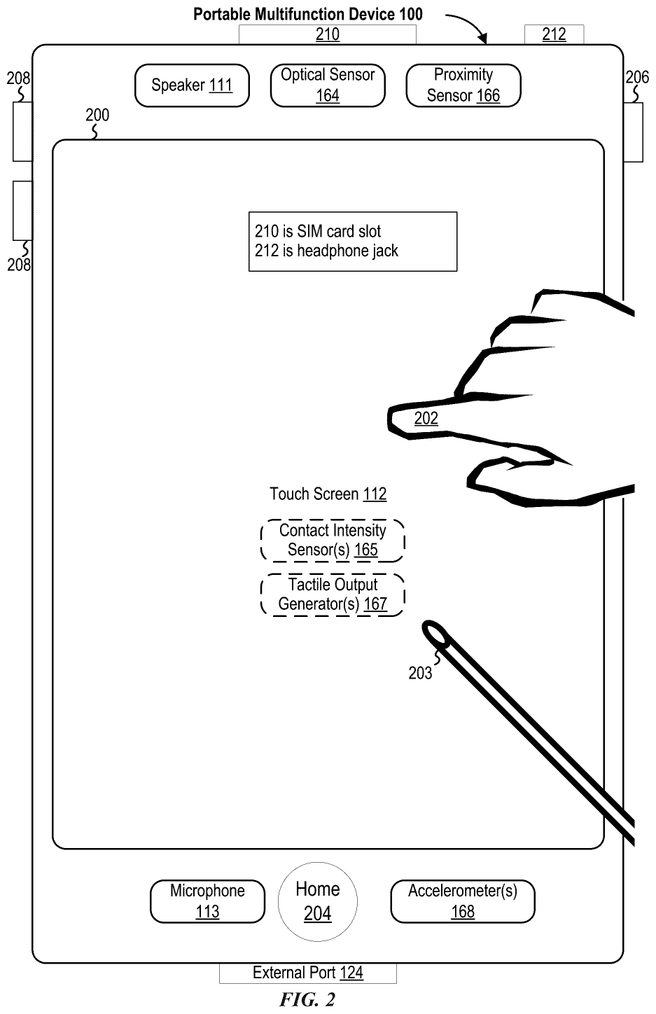

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

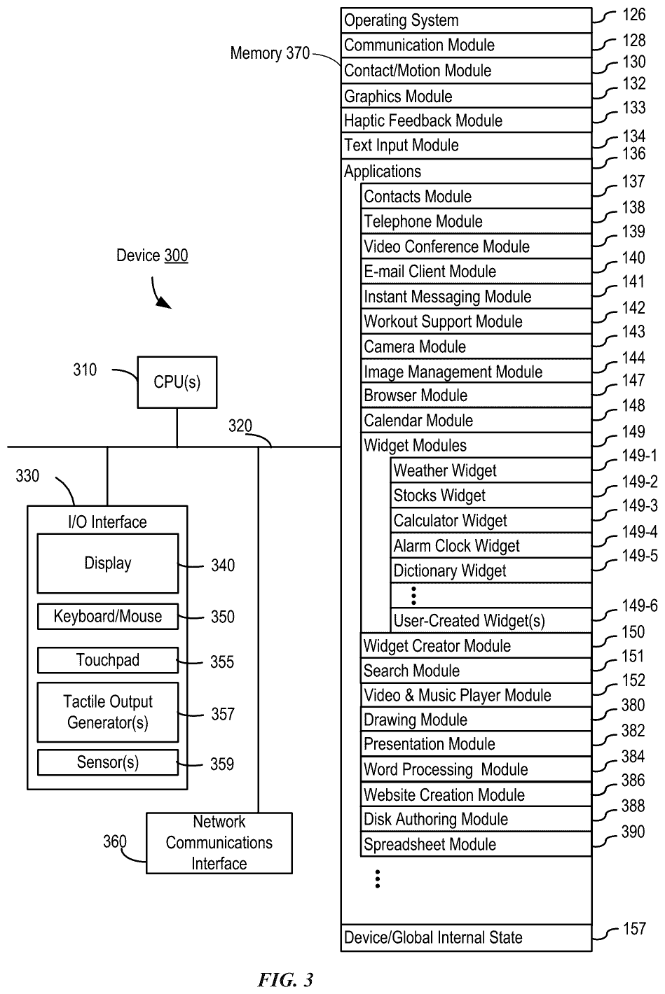

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

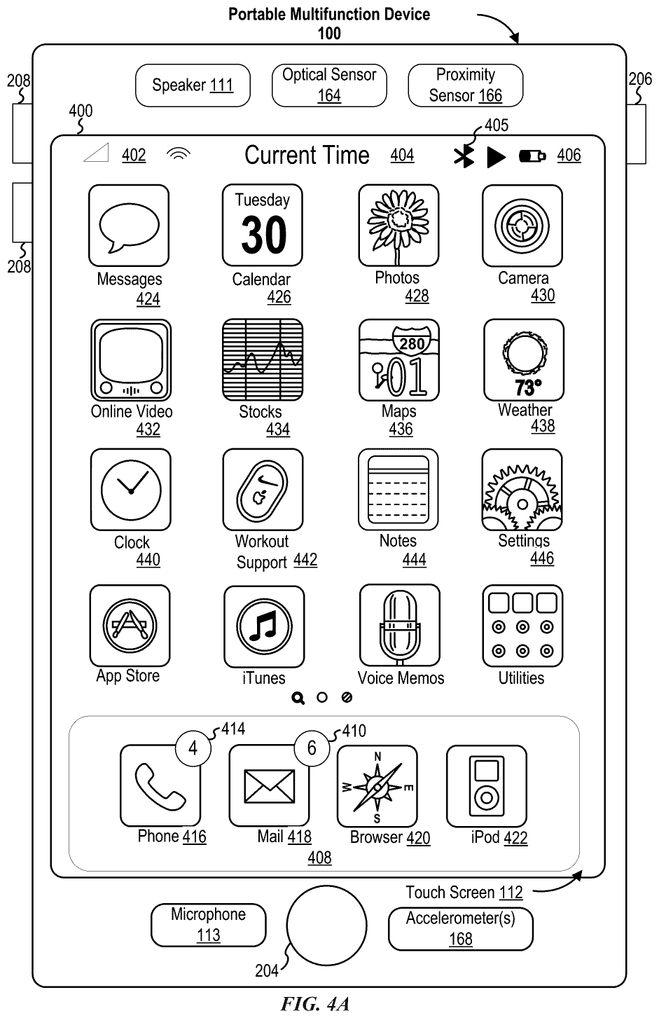

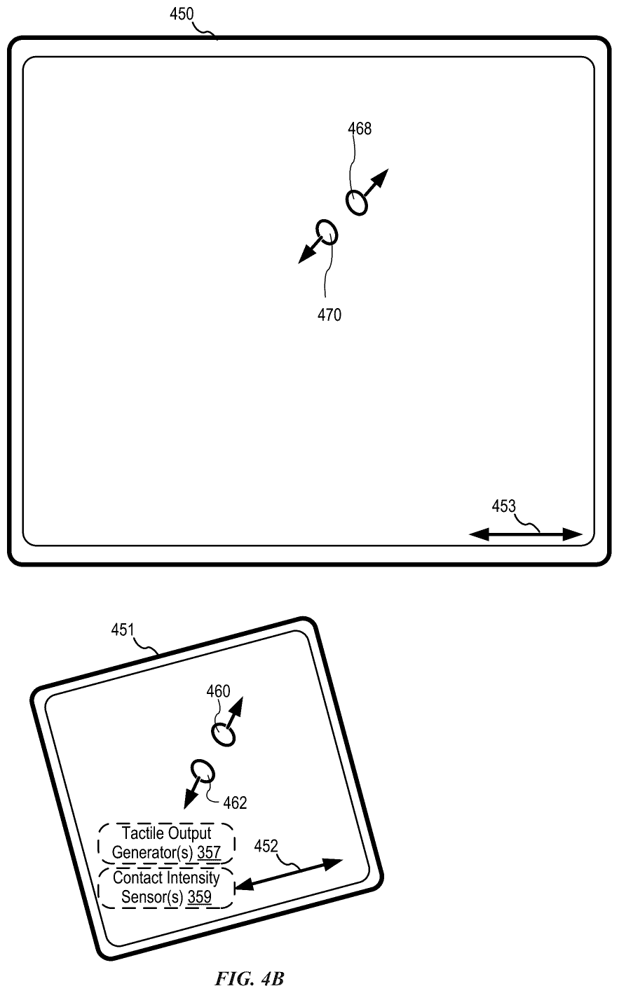

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

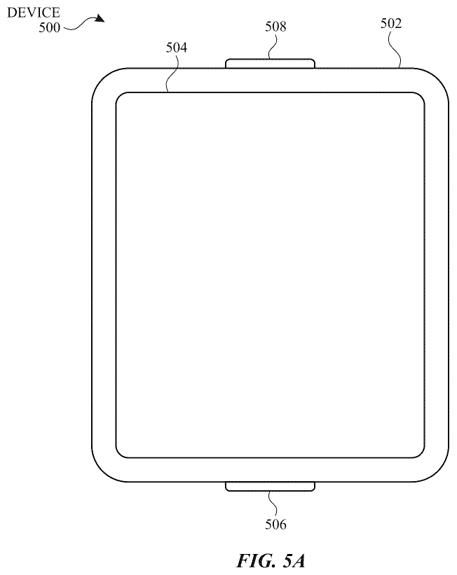

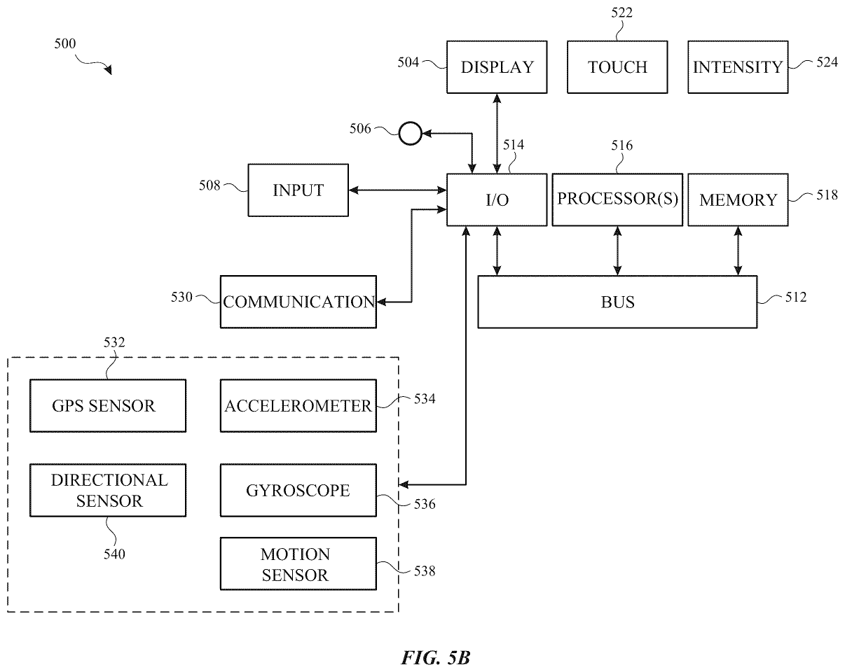

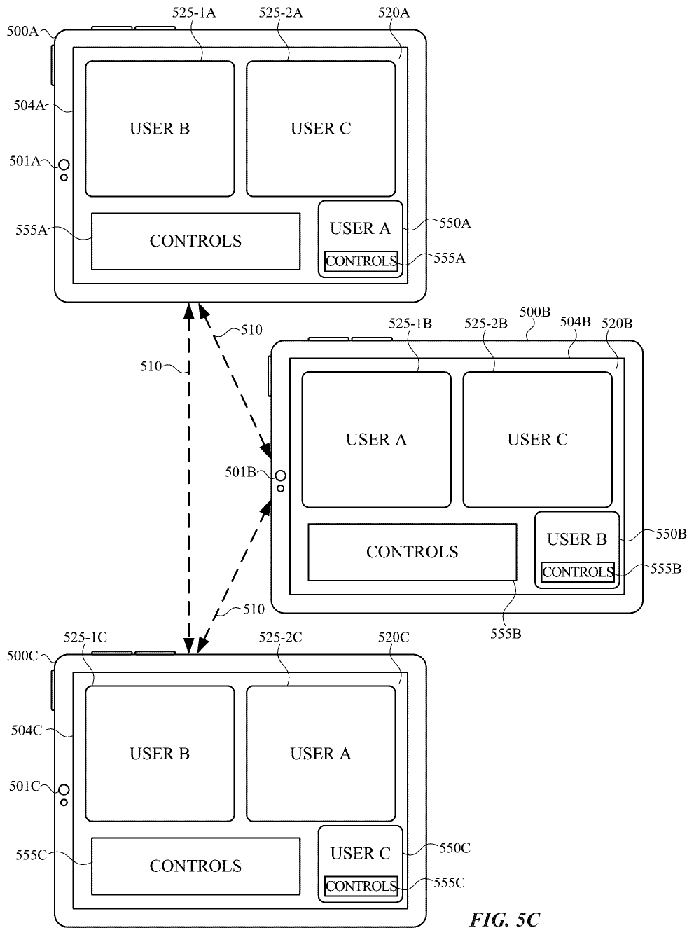

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, 900, 1100, 1300, and 1500 (FIGS. 7, 9, 11, 13, and 15). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C depicts an exemplary diagram of a communication session between electronic devices 500A, 500B, and 500C. Devices 500A, 500B, and 500C are similar to electronic device 500, and each share with each other one or more data connections 510 such as an Internet connection, Wi-Fi connection, cellular connection, short-range communication connection, and/or any other such data connection or network so as to facilitate real time communication of audio and/or video data between the respective devices for a duration of time. In some embodiments, an exemplary communication session can include a shared-data session whereby data is communicated from one or more of the electronic devices to the other electronic devices to enable concurrent output of respective content at the electronic devices. In some embodiments, an exemplary communication session can include a video conference session whereby audio and/or video data is communicated between devices 500A, 500B, and 500C such that users of the respective devices can engage in real time communication using the electronic devices.

In FIG. 5C, device 500A represents an electronic device associated with User A. Device 500A is in communication (via data connections 510) with devices 500B and 500C, which are associated with User B and User C, respectively. Device 500A includes camera 501A, which is used to capture video data for the communication session, and display 504A (e.g., a touchscreen), which is used to display content associated with the communication session. Device 500A also includes other components, such as a microphone (e.g., 113) for recording audio for the communication session and a speaker (e.g., 111) for outputting audio for the communication session.

Device 500A displays, via display 504A, communication UI 520A, which is a user interface for facilitating a communication session (e.g., a video conference session) between device 500B and device 500C. Communication UI 520A includes video feed 525-1A and video feed 525-2A. Video feed 525-1A is a representation of video data captured at device 500B (e.g., using camera 501B) and communicated from device 500B to devices 500A and 500C during the communication session. Video feed 525-2A is a representation of video data captured at device 500C (e.g., using camera 501C) and communicated from device 500C to devices 500A and 500B during the communication session.

Communication UI 520A includes camera preview 550A, which is a representation of video data captured at device 500A via camera 501A. Camera preview 550A represents to User A the prospective video feed of User A that is displayed at respective devices 500B and 500C.

Communication UI 520A includes one or more controls 555A for controlling one or more aspects of the communication session. For example, controls 555A can include controls for muting audio for the communication session, changing a camera view for the communication session (e.g., changing which camera is used for capturing video for the communication session, adjusting a zoom value), terminating the communication session, applying visual effects to the camera view for the communication session, activating one or more modes associated with the communication session. In some embodiments, one or more controls 555A are optionally displayed in communication UI 520A. In some embodiments, one or more controls 555A are displayed separate from camera preview 550A. In some embodiments, one or more controls 555A are displayed overlaying at least a portion of camera preview 550A.

In FIG. 5C, device 500B represents an electronic device associated with User B, which is in communication (via data connections 510) with devices 500A and 500C. Device 500B includes camera 501B, which is used to capture video data for the communication session, and display 504B (e.g., a touchscreen), which is used to display content associated with the communication session. Device 500B also includes other components, such as a microphone (e.g., 113) for recording audio for the communication session and a speaker (e.g., 111) for outputting audio for the communication session.

Device 500B displays, via touchscreen 504B, communication UI 520B, which is similar to communication UI 520A of device 500A. Communication UI 520B includes video feed 525-1B and video feed 525-2B. Video feed 525-1B is a representation of video data captured at device 500A (e.g., using camera 501A) and communicated from device 500A to devices 500B and 500C during the communication session. Video feed 525-2B is a representation of video data captured at device 500C (e.g., using camera 501C) and communicated from device 500C to devices 500A and 500B during the communication session. Communication UI 520B also includes camera preview 550B, which is a representation of video data captured at device 500B via camera 501B, and one or more controls 555B for controlling one or more aspects of the communication session, similar to controls 555A. Camera preview 550B represents to User B the prospective video feed of User B that is displayed at respective devices 500A and 500C.

In FIG. 5C, device 500C represents an electronic device associated with User C, which is in communication (via data connections 510) with devices 500A and 500B. Device 500C includes camera 501C, which is used to capture video data for the communication session, and display 504C (e.g., a touchscreen), which is used to display content associated with the communication session. Device 500C also includes other components, such as a microphone (e.g., 113) for recording audio for the communication session and a speaker (e.g., 111) for outputting audio for the communication session.

Device 500C displays, via touchscreen 504C, communication UI 520C, which is similar to communication UI 520A of device 500A and communication UI 520B of device 500B. Communication UI 520C includes video feed 525-1C and video feed 525-2C. Video feed 525-1C is a representation of video data captured at device 500B (e.g., using camera 501B) and communicated from device 500B to devices 500A and 500C during the communication session. Video feed 525-2C is a representation of video data captured at device 500A (e.g., using camera 501A) and communicated from device 500A to devices 500B and 500C during the communication session. Communication UI 520C also includes camera preview 550C, which is a representation of video data captured at device 500C via camera 501C, and one or more controls 555C for controlling one or more aspects of the communication session, similar to controls 555A and 555B. Camera preview 550C represents to User C the prospective video feed of User C that is displayed at respective devices 500A and 500B.

While the diagram depicted in FIG. 5C represents a communication session between three electronic devices, the communication session can be established between two or more electronic devices, and the number of devices participating in the communication session can change as electronic devices join or leave the communication session. For example, if one of the electronic devices leaves the communication session, audio and video data from the device that stopped participating in the communication session is no longer represented on the participating devices. For example, if device 500B stops participating in the communication session, there is no data connection 510 between devices 500A and 500C, and no data connection 510 between devices 500C and 500B. Additionally, device 500A does not include video feed 525-1A and device 500C does not include video feed 525-1C. Similarly, if a device joins the communication session, a connection is established between the joining device and the existing devices, and the video and audio data is shared among all devices such that each device is capable of outputting data communicated from the other devices.

The embodiment depicted in FIG. 5C represents a diagram of a communication session between multiple electronic devices, including the example communication sessions depicted in FIGS. 6A-61, 10A-101, 12A-120, and/or 14A-14E. In some embodiments, the communication sessions depicted in FIGS. 6A-61, 10A-101, 12A-120, and/or 14A-14E include two or more electronic devices, even if other electronic devices participating in the communication session are not depicted in the figures.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

In some embodiments, the computer system is in a locked state or an unlocked state. In the locked state, the computer system is powered on and operational but is prevented from performing a predefined set of operations in response to user input. The predefined set of operations optionally includes navigation between user interfaces, activation or deactivation of a predefined set of functions, and activation or deactivation of certain applications. The locked state can be used to prevent unintentional or unauthorized use of some functionality of the computer system or activation or deactivation of some functions on the computer system. In some embodiments, in the unlocked state, the computer system is powered on and operational and is not prevented from performing at least a portion of the predefined set of operations that cannot be performed while in the locked state. When the computer system is in the locked state, the computer system is said to be locked. When the computer system is in the unlocked state, the computer is said to be unlocked. In some embodiments, the computer system in the locked state optionally responds to a limited set of user inputs, including input that corresponds to an attempt to transition the computer system to the unlocked state or input that corresponds to powering the computer system off.

Attention is now directed towards embodiments of user interfaces (“UI”) and associated processes that are implemented on an electronic device, such as portable multifunction device 100, device 300, or device 500.

FIGS. 6A-61 illustrate exemplary user interfaces for managing a real-time communication session, in accordance with some embodiments. The user interfaces in these figures are used to illustrate the processes described below, including the processes in FIG. 7.

FIG. 6A illustrates computer system 600a, computer system 600b, and remote control 600c, in accordance with some embodiments. Computer system 600a includes display 602a and computer system 600b includes display 602b. In the embodiment illustrated in FIG. 6A, computer system 600a is a smartphone and computer system 600b is a TV, smart TV, monitor, video streaming device, and/or computer system that provides image data (e.g., a video feed) for display on display 602b. In FIG. 6A, computer system 600a, computer system 600b, and remote control 600c are not to scale. In some embodiments, display 602 is larger (e.g., significantly larger) than display 602a. In some embodiments, display 602a has a diagonal size between five inches and ten inches. In some embodiments, display 602b has a diagonal size between twenty inches and one hundred inches.

Remote control 600c is in communication with and/or configured to control (e.g., via an RF and/or IR signal) computer system 600b. Remote control 600c includes input area 601, which can detect inputs such as, e.g., presses and/or touch gestures. In some embodiments, input area 601 can detect directional inputs such as swipe gestures and/or tap and drag gestures. In some embodiments, can detect inputs corresponding to different portions of input area 601 (e.g., an input at a top of input area 601 is an up input, an input at a right side of input area 601 is a right direction input, an input at a left side of input area 601 is a left direction input, and an input at a bottom of input area 601 is a down direction input). Input area 601 can be used to designate and/or select user interface elements displayed by computer system 600b (e.g., to change which user interface element is designated for selection and/or to select a designated user interface element). Button 603a is a menu button, button 603b is a TV button (e.g., for displaying TV controls and/or options on computer system 600b), button 603c is a microphone button for controlling a microphone and/or providing voice inputs for computer system 600b via a microphone, button 603d is a play/pause button, and button 603e is a volume control button.

In FIG. 6A, a real-time communication session (e.g., a video call or video conference) is active on computer system 600a. Computer system 600a displays, on display 602a, user interface 604 of a real-time communication application. User interface 604 includes representation 662 (e.g., a self-view) of video captured by camera sensor 658a of computer system 600a and representation 660 of a remote participant of the real-time communication session. In FIG. 6A, computer system 600a satisfies a proximity condition relative to computer system 600b (e.g., a physical location of computer system 600a relative to computer system 600b satisfies the proximity condition). In FIG. 6A, the real-time communication is not active on computer system 600b.

In FIG. 6A, a set of handoff criteria is met, where the set of handoff criteria requires that a physical location of the first computer system relative to a second computer system satisfies a proximity condition. In some embodiments, the set of handoff criteria includes an orientation condition that requires computer system 600a to be in a predetermined orientation, such as a landscape orientation or landscape mode. In response to obtaining an indication that the set of handoff criteria is met, computer system 600a displays handoff user interface element 606. Handoff user interface element 606 prompts the user hand off the real-time communication session to computer system 600b. In some embodiments, handing off the real-time communication session to computer system 600b includes opening a real-time communication application and/or displaying a user interface for the real-time communication session on computer system 600b. In some embodiments, handing off the real-time communication session to computer system 600b includes connecting computer system 600a and/or a camera of computer system 600a to computer system 600b.

In response to obtaining an indication that the set of handoff criteria is met, computer system 600b displays handoff instructions 608, which instructs the user to use computer system 600a (e.g., Jane's phone) to connect to computer system 600b. In FIGS. 6A-61, the user of computer system 600a is the same as the user of computer system 600b (e.g., computer system 600a and computer system 600b have the same user). In FIG. 6A, computer system 600a detects selection 625a of handoff user interface element 606. In response to detecting selection 625a, computer system 600a displays handoff user interface 610 and computer system 600b displays representation 620 of the remote participant of the real-time communication session (e.g., the remote participant represented by representation 660 in FIG. 6A), as shown in FIG. 6B. In the example illustrated in FIG. 6B, computer system 600b displays an expanded (e.g., full-screen) view of representation 620. In some embodiments, if the real-time communication session includes two or more remote participants (e.g., participants other than the user of computer system 600a and 600b), computer system 600b displays representations (e.g., separate representations) of two or more remote participants of the real-time communication session (e.g., as shown in FIG. 10F).

In the example illustrated in FIG. 6B, computer system 600a and computer system 600b have initiated a process of handing off the real-time communication session to computer system 600b. For example, in some embodiments, the real-time communication session is active on computer system 600b but computer system 600b is not providing video (e.g., outgoing video) to the real-time communication session. In response to selection 625a (e.g., or other request to initiate a process of handing off the real-time communication session to computer system 600b), computer system 600b displays camera preview 616 and/or instructions 618, as shown in FIG. 6B. Camera preview 616 includes a representation (e.g., a live video feed) of image data captured by a camera of computer system 600a. In the example illustrated in FIG. 6B, camera preview 616 includes video captured by camera sensor 658b (shown, e.g., in FIG. 6C) located on an opposite side of computer system 600a from the side on which camera sensor 658a is located. In FIG. 6B, the video captured by camera sensor 658b is not provided to the real-time communication session (e.g., the video of the user of computer system 600a and computer system 600b in the real-time communication session is paused).

In FIG. 6B, computer system 600a displays instructions 622 for connecting a camera sensor and/or a microphone of computer system 600a to computer system 600b (e.g., for use in the real-time communication session). Instructions 622 illustrate and describe how to place computer system 600a to connect a camera sensor and microphone of computer system 600a to computer system 600b (e.g., for use in the real-time communication session). Skip option 612 provides an option to bypass placing computer system 600a as described in instructions 622. For example, in response to detecting selection of skip option 612, a camera (e.g., camera sensor 658a and/or camera sensor 658b) and microphone of computer system 600a is connected to computer system 600b (e.g., for use in the real-time communication session). Disconnect option 614 provides an option to disconnect computer system 600a from computer system 600b. For example, in response to detecting selection of disconnect option 612, the real-time communication session is resumed on computer system 600a (e.g., computer system 600a displays user interface 604 shown in FIG. 6A, without handoff user interface element 606) and deactivated on computer system 600b (e.g., computer system 600b closes the real-time communication application and/or ceases display of representation 620, camera preview 616, and instructions 618). Instructions 618 indicate that computer system 600a can be placed to continue the handoff process and provide instructions for continuing the handoff process via an input at computer system 600b (e.g., via remote control 600c in communication with computer system 600b) without placing computer system 600a.

Turning to FIG. 6C, computer system 600a has been placed according to instructions 622 and/or instructions 618 (e.g., in a predetermined position, such as in a landscape orientation and/or within a predetermined distance of computer system 600b). In response to a determination that computer system 600a is positioned according to instructions 622 and/or instructions 618 (e.g., that a position of computer system 600a satisfies a set of position conditions and/or is in a predetermined position, orientation (e.g., a landscape orientation), and/or location), computer system 600b displays notification 624, which includes an indication (e.g., text) that computer system 600a is properly placed and that video from a camera (e.g., camera sensor 658a and/or camera sensor 658b) of computer system 600a will be (e.g., will resume being) provided to the real-time communication session. Notification 624 includes a countdown indicator (e.g., a ring with a fill that indicates progress and/or a numerical countdown) that indicates an amount of time until video from a camera of computer system 600a will be (e.g., will resume being) provided to the real-time communication session. In some embodiments, computer system 600b displays the user interface shown in FIG. 6C (e.g., notification 624) in response to selection of skip option 612 at computer system 600a and/or an input at computer system 600b according to instructions 618 (e.g., a press of a specified button on a remote control).

When the countdown expires, video from a camera of computer system 600a is (e.g., resumes being) provided to the real-time communication session computer system 600b (e.g., viewable by the remote participants of the real-time communication session), and computer system 600b displays representation 626 (e.g., a self-view) of the video captured by camera 658b (e.g., concurrently with representation 620). In some embodiments, computer system 600b displays the user interface as shown in FIG. 6D in response to a determination that computer system 600a is positioned according to instructions 622 and/or instructions 618 without displaying notification 624 (e.g., the user interface shown in FIG. 6C) and/or without providing a countdown. In some embodiments, computer system 600b displays the user interface shown in FIG. 6D (e.g., notification 624) in response to selection of skip option 612 at computer system 600a and/or an input at computer system 600b according to instructions 618 (e.g., a press of a specified button on a remote control). In some embodiments, when computer system 600a is placed in the position shown in FIGS. 6C and 6D (e.g., in the position that automatically initiates connection of a camera to computer system 600b), computer system 600b deactivates display 602b and/or places display 602b in an inactive, reduced power, and/or dimmed state.

Turning to FIG. 6E, computer system 600a is moved from the position in FIGS. 6C and 6D (e.g., a user has picked up computer system 600a). In some embodiments, when computer system 600a is moved from the position in FIGS. 6C and 6D, computer system 600a activates display 602b and/or transitions display 602b into a normal operating state. In FIG. 6E, representation 626 is updated to show the video currently being captured by camera sensor 658b, which is now facing computer system 600b. In response to computer system 600a being moved, computer system 600a displays user interface 628, including pause option 630, switch option 632, and end option 634. User interface 628 includes text notifying the user that the real-time communication session is active on computer system 600b and that computer system 600b is using a camera and microphone of computer system 600a to participate in the real-time communication session (e.g., “Video call is active on ‘Living Room’ TV; ‘Living Room’ is using the phone's camera and microphone to participate in a video call”).

In response to detecting selection of pause option 630, video captured by a camera (e.g., camera sensor 658a and/or camera sensor 658b) of computer system 600a ceases being provided to the real-time communication session (e.g., is paused and/or is not updated). In response to request 625b (e.g., a swipe up gesture from the bottom of user interface 628) to navigate away from user interface 628, computer system 600a ceases display of user interface 628 and displays user interface 636 (e.g., a home screen that includes application icons for launching other applications). In FIG. 6F, computer system 600b remains unchanged from FIG. 6E. In some embodiments, ceasing display of user interface 628 enables computer system 600a to be used for other user interfaces and/or applications while the real-time communication session is active on computer system 600b. While displaying user interface 636, computer system 600a displays real-time communication indicator 638 and camera indicator 642. Real-time communication indicator 638 informs the user that the real-time communication session is active. Real-time communication indicator is displayed in dynamic region 640. In FIG. 6F, dynamic region 640 is in an expanded state compared to the state of dynamic region 640 in FIG. 6E (e.g., dynamic region 640 expands to provide room for real-time communication indicator 638). Camera indicator 642 informs the user that a camera of computer system 600a is active (e.g., providing video to the real-time communication session). In some embodiments, camera indicator 642 is displayed in dynamic region 640 (e.g., dynamic region 640 expands to provide room for camera indicator 642). In response to detecting selection 625d of real-time communication indicator 638, computer system 600a displays (e.g., returns to) user interface 628 shown in FIG. 6E.

Turning to FIG. 6G, computer system 600a is in the same physical position as in FIGS. 6E and 6F and is displaying user interface 644 (e.g., a wake screen and/or a lock screen). In FIG. 6G, computer system 600a receives a text message. In response to the text message, computer system 600a displays notification 646a corresponding to the text message, and computer system 600b displays notification 646b corresponding to the text message. Notification 646b on computer system 600b includes less information about the text message received by computer system 600a than notification 646a displayed on computer system 600a. In some embodiments, since computer system 600b includes a larger display that is more likely to be viewed by other people, displaying notification 646b with less information provides privacy while still informing the user of compute system 600a of the text message.

Returning to FIG. 6E, in some examples, selection 625c corresponds to selection of end option 634. In response to detecting selection of end option 634, computer system 600a displays confirmation notification 648, confirm option 650, and cancel option 652, as shown in FIG. 6H. Confirmation notification 648 informs the user that selecting confirm option 650 will end the real-time communication session (e.g., for all participants or just for the user of computer system 600a and computer system 600b) and disconnect computer system 600a from computer system 600b. In response to detecting selection of end option 650, the real-time communication session is ended (e.g., for all participants or just for the user of computer system 600a and computer system 600b) and computer system 600a is disconnected from computer system 600b. In FIG. 6H, computer system 600a detects selection 625e of cancel option 625e and, in response, removes display of notification 648, confirm option 650, and cancel option 652 (e.g., displays user interface 628 as shown in FIG. 6E).

In some examples, selection 625c corresponds to selection of switch option 632. In response to detecting selection of switch option 632, the real-time communication session is switched (e.g., switched back) to computer system 600a. As a result, computer system 600a displays user interface 604 (without handoff user interface element 606) and computer system 600b displays user interface 654 (without handoff instructions 608), as shown in FIG. 6I. When the real-time communication session is switched back to computer system 600a, computer system 600a switches to using camera sensor 658a for the real-time communication session (e.g., as indicated by representation 662 in FIG. 6I), and computer system 600b displays notification 656 indicating that the real-time communication session is now active on computer system 600a (e.g., and no longer active on computer system 600b).

FIG. 7 is a flow diagram illustrating a method for managing a real-time communication session using a computer system in accordance with some embodiments. Method 700 is performed at a first computer system (e.g., 100, 300, 500, and or 600a) (e.g., a smart phone, a smart watch, a tablet computer, a laptop computer, a desktop computer, a wearable device, and/or head-mounted device) that is in communication with (e.g., includes and/or is connected to) a display generation component (e.g., 602a) (e.g., a display, touch-screen display, a monitor, a holographic display system, and/or a head-mounted display system), one or more camera sensors (e.g., 658a and/or 658b), and one or more input devices (e.g., 602a) (e.g., a touch-sensitive surface (e.g., a touch-sensitive display); a mouse; a keyboard; a remote control; a visual input device (e.g., one or more cameras such as, e.g., an infrared camera, a depth camera, a visible light camera, and/or a gaze tracking camera); an audio input device; a biometric sensor (e.g., a fingerprint sensor, a face identification sensor, a gaze tracking sensor, and/or an iris identification sensor); and/or one or more mechanical input devices (e.g., a depressible input mechanism; a button; a rotatable input mechanism; a crown; and/or a dial)). Some operations in method 700 are, optionally, combined, the orders of some operations are, optionally, changed, and some operations are, optionally, omitted.

While a real-time communication session (e.g., a video call, a video conference, an audio/video call, and/or an audio call that includes a capability to include video) is active (e.g., ongoing and/or in progress) on the first computer system (e.g., the real-time communication session on 600a in FIG. 6A), the first computer system obtains (702) (e.g., receives and/or detects) an indication (e.g., data and/or information) that a set of handoff criteria is met, wherein the set of handoff criteria requires that (e.g., is met only if; or is not met unless) a physical location of the first computer system relative to a second computer system (e.g., 600b) (e.g., a measured physical distance, a detected physical distance, a determined physical distance, and/or a calculated physical distance) satisfies (or, in some embodiments, is determined to satisfy) a proximity condition (e.g., the first computer system is within a threshold distance of the second computer system; and/or the first computer system is in a same room as the second computer system). In some embodiments, obtaining the indication that that the set of handoff criteria is met includes detecting (e.g., via one or more sensors of the first computer system and/or one or more sensors of the second computer system) and/or determining a physical location of the first computer system relative to the second computer system. In some embodiments, the indication that the set of handoff criteria is met is based at least in part on the physical location of the first computer system relative to the second computer system (e.g., the detected and/or determined physical location of the first computer system relative to the second computer system). In some embodiments, obtaining the indication that that the set of handoff criteria is met includes the first computer system detecting and/or determining that that the set of handoff criteria is met (e.g., the first computer system detects and/or determines that that the set of handoff criteria is met). In some embodiments, obtaining the indication that that the set of handoff criteria is met includes receiving data from the second computer system indicating that the set of handoff criteria is met (e.g., the second computer system detects and/or determines that the set of handoff criteria is met and sends an indication to the first computer system that the set of handoff criteria is met). In some embodiments, obtaining the indication that that the set of handoff criteria is met includes receiving data from the second computer system indicating that a subset of the set of handoff criteria is met (e.g., detecting and/or determining that the set of handoff criteria is met is performed in part by the second computer system and in part by the first computer system).

In response to obtaining the indication that the set of handoff criteria is met, the first computer system displays (704), via the display generation component, a handoff user interface element (e.g., 606) (e.g., a visual prompt, a graphical element, a notification, an alert, a banner, an icon, a button, an affordance, a selectable option, a selectable element, a user-interactive graphical element, text, instructions, an animation, and/or a pop up). In some embodiments, in response to obtaining the indication that the set of handoff criteria is met, the computer system displays a prompt to use the second computer system for the real-time communication session (e.g., to hand off one or more functions of the real-time communication session, such as displaying a user interface of the real-time communication session, to the second computer system). Displaying a handoff user interface element in response to obtaining the indication that the set of handoff criteria is met informs the user that the real-time communication session can be handed off to the second computer system and enables the user to quickly and efficiently initiate the handoff process without additional inputs, thereby providing improved visual feedback to the user, reducing the number of inputs needed to perform an operation, providing additional control options without cluttering the user interface with additional displayed controls, and performing an operation when a set of conditions has been met without requiring further user input.

The first computer system detects (706), via the one or more input devices, a selection (e.g., 625a) (e.g., input, touch gesture, air gesture, voice command, and/or other selection) of the handoff user interface element. In some embodiments, detecting the selection of the handoff user interface element includes detecting an input corresponding to selection of the handoff user interface element (e.g., a tap and/or other selection input on the handoff user interface element). In response to detecting the selection of the handoff user interface element, the first computer system initiates (708) a handoff process that includes capturing video for the real-time communication session using the one or more camera sensors while a user interface (e.g., 620 and/or 626; and/or the user interface displayed on 600b in FIGS. 6D, 6E, 6F, 6G, and/or 6H) of the real-time communication session is displayed by the second computer system (e.g., while the real-time communication session is active on the second computer system). Initiating the handoff process in response to detecting the selection of the handoff user interface element enables the user to quickly and efficiently initiate the handoff process without additional inputs, thereby providing improved visual feedback to the user, reducing the number of inputs needed to perform an operation, and providing additional control options without cluttering the user interface with additional displayed controls. In some embodiments, the handoff process includes transferring the real-time communication session to the second computer system (e.g., activating the real-time communication session on the second computer system). In some embodiments, transferring the real-time communication session to the second computer system includes activating, launching, opening, and/or displaying a user interface of the real-time communication session at the second computer system. In some embodiments, the handoff process includes connecting the one or more camera sensors to the second computer system (e.g., for providing video to the real-time communication session). In some embodiments, the handoff process includes connecting one or more microphones of the first computer system to the second computer system (e.g., for providing audio to the real-time communication session). In some embodiments, the handoff process includes opening (e.g., launching and/or displaying) a real-time communication application on the second computer system (e.g., a real-time communication application that provides the user interface of the real-time communication session).

In some embodiments, the set of handoff criteria includes a criterion that is met when the second computer system (e.g., 600b) is turned on (e.g., powered on, activated, and/or transitions from an off, sleep, or reduced power state to a normal operating state). Including a criterion that is met when the second computer system is turned on in the set of handoff criteria enables the first computer system to automatically provide the handoff user interface element for initiating the handoff process when the user turns on the second computer system, when the handoff user interface element is likely to be relevant to the user, thereby providing improved visual feedback to the user, reducing the number of inputs needed to perform an operation, providing additional control options without cluttering the user interface with additional displayed controls, and performing an operation when a set of conditions has been met without requiring further user input.

In some embodiments, in response to detecting the selection of the handoff user interface element, the first computer system pauses transmission of the video captured by the one or more camera sensors to the real-time communication session (e.g., transmission of video captured by 658a and/or 658b of computer system 600a to the real-time communication session is paused in FIG. 6B and/or FIG. 6C). Pausing transmission of the video to the real-time communication session in response to detecting selection of the handoff user interface element enables the user to position the one or more camera sensors for use by the real-time communication session and provides the user with privacy while the one or more cameras are being positioned without having to manually pause the one or more camera sensors, thereby reducing the number of inputs needed to perform an operation and providing improved privacy and security. In some embodiments, after pausing transmission of the video captured by the one or more camera sensors to the real-time communication session (or, in some embodiments, after the handoff process is complete and/or in response to a determination that the handoff process is complete), the first computer system resumes (e.g., automatically resumes) transmission of the video captured by the one or more camera sensors to the real-time communication session (e.g., transmission of video captured by 658a and/or 658b of computer system 600a to the real-time communication session is resumed in FIG. 6D). Resuming transmission of the video captured by the one or more camera sensors enables the user to resume using the one or more camera sensors of the real-time communication without requiring additional inputs, thereby reducing the number of inputs needed to perform an operation.

In some embodiments, in response to detecting the selection (e.g., 625a) of the handoff user interface element (e.g., 606), the first computer system transmits (e.g., the first computer system continues transmitting) audio captured by a microphone of the first computer system (e.g., 600a) to the real-time communication session (e.g., computer system 600a transmits audio to the real-time communication session in FIG. 6B). Transmitting audio captured by a microphone of the first computer system to the real-time communication session in response to detecting the selection of the handoff user interface element enables the user to continue using the microphone of the first computer system for the real-time communication session without requiring additional inputs, thereby reducing the number of inputs needed to perform an operation.

In some embodiments, in response to detecting the selection of the handoff user interface element, the first computer system displays, via the display generation component, instructions (e.g., 622) (e.g., text and/or audio) to position the first computer system in a predetermined position (e.g., the position of 600a in FIG. 6C) (e.g., a predetermined position relative to the second computer system, a predetermined location within a range of locations, and/or a predetermined orientation within a range of orientations). In some embodiments, the predetermined position is a location that is within a threshold distance of a portion of the second computer system, a landscape orientation, and an orientation in which a predetermined camera sensor (e.g., 658b, a rear-facing camera sensor, and/or a camera sensor on a back of the first computer system) of the one or more camera sensors is facing a predetermined direction, such as toward a user. Displaying instructions to position the first computer system in a predetermined position in response to detecting the selection of the handoff user interface element informs the user how to initiate the handoff process without additional inputs and/or to begin using the one or more camera sensors of the first computer system for the real-time communication session while the real-time communication session is active on the second device, thereby providing improved visual feedback to the user and reducing the number of inputs needed to perform an operation.

In some embodiments, after initiating the handoff process, in response to a determination that the first computer system is in a predetermined position (e.g., the position of computer system 600a in FIG. 6C) (e.g., a predetermined location and/or a predetermined orientation), the first computer system captures (and/or provides) video for the real-time communication session using the one or more camera sensors (e.g., 658a and/or 658b) while a user interface of the real-time communication session is displayed by the second computer system (e.g., while computer system 600b is displaying 620, 626, and/or the user interface displayed on 600b in FIGS. 6D, 6E, 6F, 6G, and/or 6H) (e.g., while the real-time communication session is active on the second computer system; and/or the first computer system completes the handoff process in response to the first computer system being placed in the predetermined position). Capturing video for the real-time communication session using the one or more camera sensors while a user interface of the real-time communication session is displayed by the second computer system in response to a determination that the first computer system is in a predetermined position enables the first computer system to automatically use (or resume using) the one or more camera sensors for the real-time communication session without additional input, thereby performing an operation when a set of conditions has been met without requiring further user input and reducing the number of inputs needed to perform an operation.

In some embodiments, in response to detecting the selection (e.g., 625a) of the handoff user interface element (e.g., 606), the first computer system displays, via the display generation component, a continue user interface element (e.g., 612) (e.g., a user-interactive user interface element, a button, a selectable icon, a selectable option, and/or an affordance); the first computer system detects, via the one or more input devices, a selection (e.g., input, touch gesture, air gesture, voice command, and/or other selection) of the continue user interface element (e.g., a tap or other input on 612 in FIG. 6B); and in response to detecting the selection of the continue user interface element, the first computer system captures video for the real-time communication session using the one or more camera sensors (e.g., 658a and/or 658b) while a user interface of the real-time communication session is displayed by the second computer system (e.g., while computer system 600b is displaying 620, 626, and/or the user interface displayed on 600b in FIGS. 6D, 6E, 6F, 6G, and/or 6H) (e.g., while the real-time communication session is active on the second computer system; and/or the first computer system completes the handoff process in response to detecting selection of the continue user interface element regardless of whether the first computer system is in the predetermined position). In some embodiments, in response to detecting the selection of the continue user interface element, the first computer system transmits video captured by the one or more camera sensors to the second computer system for user in the real-time communication session. Displaying a continue user interface element for capturing video for the real-time communication session using the one or more camera sensors while a user interface of the real-time communication session is displayed by the second computer system in response to detecting the selection of the handoff user interface element enables the user to quickly and efficiently continue the handoff process without having to navigate to another user interface, thereby providing improved visual feedback to the user, providing additional control options without cluttering the user interface with additional displayed controls, and reducing the number of inputs needed to perform an operation.

In some embodiments, after initiating the handoff process (and, in some embodiments, after completing the handoff process), the first computer system displays, via the display generation component, a disconnect user interface element (e.g., 614) (e.g., a user-interactive user interface element, a button, a selectable icon, a selectable option, and/or an affordance); the first computer system detects, via the one or more input devices, a selection (e.g., input, touch gesture, air gesture, voice command, and/or other selection) of the disconnect user interface element (e.g., a tap or other input on 614 in FIG. 6B); and in response to detecting the selection of the disconnect user interface element, the first computer system causes the second computer system (e.g., 600b) to be disconnected from the real-time communication session (e.g., causing the second computer system to stop displaying the user interface of the real-time communication session) and displaying, via the display generation component, a user interface (e.g., 604, 660 and/or 662) of the real-time communication session. In some embodiments, the first computer system displays the disconnect user interface element in response to detecting that the first computer system has moved from the predetermined position (e.g., location and/or orientation). Displaying a disconnect user interface element for disconnecting the second computer system from the real-time communication session and displaying a user interface of the real-time communication session at the first computer system after initiating the handoff process enables the user to quickly and efficiently transfer the real-time communication session to (e.g., back to) the first computer system.

In some embodiments, while capturing video for the real-time communication session using the one or more camera sensors (e.g., 658a and/or 658b) while a user interface of the real-time communication session is displayed by the second computer system (e.g., while computer system 600b is displaying 620, 626, and/or the user interface displayed on 600b in FIGS. 6D, 6E, 6F, 6G, and/or 6H) (e.g., while the real-time communication session is active on the second computer system), the first computer system displays, via the display generation component, an indication (e.g., 638 and/or 642) that the real-time communication session is active on the second computer system (e.g., that the second computer system is displaying the user interface of the real-time communication session and/or a representation of the video captured by the one or more camera sensors). Displaying an indication that the real-time communication session is active on the second computer system while capturing video for the real-time communication session using the one or more camera sensors informs the user that the one or more camera sensors are active, thereby providing improved visual feedback and providing improved privacy and security.

In some embodiments, while capturing video for the real-time communication session using the one or more camera sensors (e.g., 658a and/or 658b) while a user interface of the real-time communication session is displayed by the second computer system (e.g., while computer system 600b is displaying 620, 626, and/or the user interface displayed on 600b in FIGS. 6D, 6E, 6F, 6G, and/or 6H) (e.g., while the real-time communication session is active on the second computer system), the first computer system displays, via the display generation component, a pause user interface element (e.g., 630) (e.g., a user-interactive user interface element, a button, a selectable icon, a selectable option, and/or an affordance); the first computer system detects, via the one or more input devices, a selection (e.g., input, touch gesture, air gesture, voice command, and/or other selection) of the pause user interface element (e.g., a tap or other input on 630 in FIG. 6E); and in response to detecting the selection of the pause user interface element, the first computer system ceases to provide video captured by the one or more camera sensors (and/or audio captured by the first computer system) to the real-time communication session. In some embodiments, in response to detecting the selection of the pause user interface element, the first computer system causes the real-time communication session to be paused (e.g., the second computer system ceases to display video captured by the one or more camera sensors, ceases to display the real-time communication session, or ceases to update the user interface of the real-time communication session). Displaying the pause user interface element for ceasing to provide video captured by the one or more camera sensors to the real-time communication session enables the user to quickly and efficiently stop providing video to the real-time communication session without having to navigate a user interface, thereby providing additional control options without cluttering the user interface with additional displayed controls and reducing the number of inputs needed to perform an operation.

In some embodiments, while capturing video for the real-time communication session using the one or more camera sensors (e.g., 658a and/or 658b) while a user interface of the real-time communication session is displayed by the second computer system (e.g., while computer system 600b is displaying 620, 626, and/or the user interface displayed on 600b in FIGS. 6D, 6E, 6F, 6G, and/or 6H) (e.g., while the real-time communication session is active on the second computer system), the first computer system displays, via the display generation component, a transfer user interface element (e.g., 632) (e.g., a user-interactive user interface element, a button, a selectable icon, a selectable option, and/or an affordance); the first computer system detects, via the one or more input devices, a selection (e.g., 625b) (e.g., input, touch gesture, air gesture, voice command, and/or other selection) of the transfer user interface element (e.g., 632); and in response to detecting the selection of the transfer user interface element, the first computer system transfers the real-time communication session to the first computer system (e.g., transition from FIG. 6E to FIG. 6I) (e.g., the first computer system activates, launches, opens, and/or displays a user interface of the real-time communication session). In some embodiments, transferring the real-time communication session to the first computer system includes causing the real-time communication session to cease on the second computer system. Displaying a transfer user interface element for transferring the real-time communication session to the first computer system enables the user to quickly and efficiently transfer the real-time communication session to (e.g., back to) the first computer system without navigating the user interface, thereby providing improved visual feedback and reducing the number of inputs needed to perform an operation.

In some embodiments, while capturing video for the real-time communication session using the one or more camera sensors (e.g., 658a and/or 658b) while a user interface of the real-time communication session is displayed by the second computer system (e.g., while computer system 600b is displaying 620, 626, and/or the user interface displayed on 600b in FIGS. 6D, 6E, 6F, 6G, and/or 6H) (e.g., while the real-time communication session is active on the second computer system), the first computer system displays, via the display generation component, an end call user interface element (e.g., 634) (e.g., a user-interactive user interface element, a button, a selectable icon, a selectable option, and/or an affordance); the first computer system detects, via the one or more input devices, a selection (e.g., 625b) (e.g., input, touch gesture, air gesture, voice command, and/or other selection) of the end call user interface element (e.g., 634); and in response to detecting the selection of the transfer user interface element, the first computer system ends the real-time communication session. In some embodiments, in response to detecting the selection of the transfer user interface element, the first computer system disconnects from the second computer system, disconnects the one or more camera sensors from the second computer system, and/or disconnects a microphone of the first computer system from the second computer system. Displaying the end call user interface element enables the use to quickly and efficiently end the real-time communication session without navigating a user interface, thereby providing improved visual feedback and reducing the number of inputs needed to perform an operation.

In some embodiments, while capturing video for the real-time communication session using the one or more camera sensors (e.g., 658a and/or 658b) while a user interface of the real-time communication session is displayed by the second computer system (e.g., while computer system 600b is displaying 620, 626, and/or the user interface displayed on 600b in FIGS. 6D, 6E, 6F, 6G, and/or 6H) (e.g., while the real-time communication session is active on the second computer system), the first computer system displays, via the display generation component, a camera indicator (e.g., 642) that indicates that the one or more camera sensors are capturing video (e.g., and transmitting a video feed to the second computer system for the real-time communication session). Displaying the camera indicator informs the user that the one or more camera sensors is providing video for the real-time communication session, thereby providing improved visual feedback and providing improved privacy and security.

In some embodiments, displaying the handoff user interface element (e.g., 606) includes displaying the handoff user interface element in a dynamic user interface region (e.g., 640) that changes (e.g., in size and/or shape) over time. Displaying the handoff user interface element in a dynamic user interface region informs the user that the real-time communication session can be handed off to the second computer system and enables the user to quickly and efficiently initiate the handoff process without additional inputs, thereby providing improved visual feedback to the user, reducing the number of inputs needed to perform an operation, providing additional control options without cluttering the user interface with additional displayed controls, and performing an operation when a set of conditions has been met without requiring further user input.

In some embodiments, the set of handoff criteria includes a criterion that is met when the second computer system (e.g., 600b) is in communication with a display (e.g., 602b) that is larger than a display (e.g., 602a) of the first computer system (e.g., 600a). Displaying the handoff user interface when the second computer system is in communication with a display that is larger than a display of the first computer system enables the user to quickly and efficiently transfer the real-time communication session to a larger display, thereby providing improved visual feedback, performing an operation when a set of conditions has been met without requiring further user input, and reducing the number of inputs needed to perform an operation.

In some embodiments, the second computer system (e.g., 600b) displays a prompt (e.g., 608) to use the first computer system (e.g., 600a) to initiate the handoff process while the first computer system displays the handoff user interface element (e.g., 606). Displaying a prompt on the second computer system to initiate the handoff process informs the user that the real-time communication session can be transferred to the second computer system and enables the user to quickly and efficiently initiate the handoff process without navigating a user interface, thereby providing improved visual feedback, providing additional control options without cluttering the user interface with additional displayed controls, and reducing the number of inputs needed to perform an operation.

In some embodiments, in response to detecting the selection (e.g., 625a) of the handoff user interface element (e.g., 606), the first computer system causes the second computer system (e.g., 600b) to display a representation (e.g., 620) (e.g., a video feed) of a remote participant of the real-time communication session (e.g., the second computer system opens the real-time communication session application and/or displays a user interface of the real-time communication session and displays the representation of the remote participant). Causing the second computer system to display a representation of a remote participant in response to detecting selection of handoff user interface element informs the user that the handoff process has been initiated, thereby providing improved visual feedback to the user.

In some embodiments, in response to detecting the selection (e.g., 625a) of the handoff user interface element (e.g., 606), the first computer system causes the second computer system to display a representation (e.g., 616) (e.g., a video feed and/or a camera preview) of video captured by the one or more camera sensors (e.g., 658a and/or 658b) (e.g., video captured by the one or more camera sensors and transmitted to the second computer system). In some embodiments, the second computer system displays the representation of video captured by the one or more camera sensors while the first computer system displays instructions for initiating the handoff process. Causing the second computer system to display a representation of video captured by the one or more camera sensors enables the user to view the video being captured before it is provided to the real-time communication session, thereby providing improved visual feedback to the user and providing improved privacy and security.

In some embodiments, after the first computer system (e.g., 600a) detects the selection (e.g., 625a) of the handoff user interface element (e.g., 606), the second computer system (e.g., 600b) displays instructions (e.g., 618) for positioning the first computer system. Displaying instructions for positioning the first computer system on the second computer system informs the user how to continue the handoff process without further input, thereby providing improved visual feedback and reducing the number of inputs needed to perform an operation.

In some embodiments, after the first computer system (e.g., 600a) detects the selection (e.g., 625a) of the handoff user interface element (e.g., 606) (and, in some embodiments, before providing video captured by the one or more camera sensors in the real-time communication session on the second computer system), the second computer system (e.g., 600b) displays instructions (e.g., 618) for continuing to connect the one or more camera sensors to the second computer system using the second computer system (e.g., a remote control of the second computer system); the second computer system detects an input (e.g., a press of button 603b on remote control 600c) (e.g., an enter button, a return button, a home button, and/or a menu button); and in response to obtaining an indication that the second computer system detected the input, the first computer system transmits video captured by the one or more camera sensors (e.g., 658a and/or 658b) to the second computer system (e.g., 600b) for (e.g., for user in) the real-time communication session. Transmitting video captured by the one or more camera sensors to the second computer system for the real-time communication session in response to input detected by the second computer system enables the user to quickly and efficiently continue the handoff process without navigating a user interface, thereby reducing the number of inputs needed to perform an operation and providing additional control options without cluttering the user interface with additional displayed controls.

In some embodiments, before providing video captured by the one or more camera sensors (e.g., 658a and/or 658b) to the real-time communication session (e.g., in FIG. 6B and/or FIG. 6C) (e.g., before resuming user of the one or more camera sensors for the real-time communication session), the second computer system (e.g., 600b) displays a countdown (e.g., 624) of an amount of time until video captured by the one or more camera sensors is (or will be) provided to the real-time communication session. Displaying a countdown at the second computer system informs the user that video captured by the one or more camera sensors is going to be provided to the real-time communication session, thereby providing improved visual feedback and providing improved privacy and security.

In some embodiments, while the one or more camera sensors are connected to the second computer system (e.g., in FIGS. 6D, 6E, 6F, 6G, and/or 6H) (or, in some embodiments, while the first computer system is connected to the second computer system), the first computer system receives an alert of an event (e.g., an incoming phone call, an incoming video call, a text message, a battery condition, and/or a thermal condition) (e.g., the text message corresponding to notification 646a); and in response to receiving an alert of an event, the first computer system causes the second computer system (e.g., 600b) to display a notification (e.g., 646b) that includes a first set of information (e.g., a name of the person that sent the message (“TANYA CASTILLO”)) about the event. Displaying a notification at the second computer system that includes information about an alert of an event received at the first computer system informs the user of the event without having to view or provide inputs at the first computer system, thereby providing improved visual feedback to the user and reducing the number of inputs needed to perform and operation. In some embodiments, in response to receiving the alert of the event, the first computer system displays, via the display generation component, a notification (e.g., 646a) that includes a second set of information (e.g., a preview of a message (“HELLO!”), a name of the person that sent the message (“TANYA CASTILLO”), and when the message was received (“NOW”)) about the event, wherein the second set of information includes more information than the first set of information. Displaying a notification at the first computer system that includes more information about the event than the notification displayed at the second computer system reduces the amount of information that is viewable by other people viewing the second computer system, thereby providing improved privacy and security.

As described below, method 700 provides an intuitive way for managing a real-time communication session. The method reduces the cognitive burden on a user for managing a real-time communication session, thereby creating a more efficient human-machine interface. For battery-operated computing devices, enabling a user to manage a real-time communication session faster and more efficiently conserves power and increases the time between battery charges.

Note that details of the processes described above with respect to method 700 (e.g., FIG. 7) are also applicable in an analogous manner to the methods described below. For example, methods 900, 1100, 1300, and/or 1500 optionally includes one or more of the characteristics of the various methods described above with reference to method 700. For example, the handoff process described in method 700 can used to hand off the real-time communication sessions described in method 1100 and 1300. For brevity, these details are not repeated below.

FIGS. 8A-8P illustrate exemplary user interfaces for connecting cameras to devices, in accordance with some embodiments. The user interfaces in these figures are used to illustrate the processes described below, including the processes in FIG. 9.

FIG. 8A illustrates computer system 600a and computer system 600b described above. In some embodiments, computer system 600b is in communication with (e.g., controlled by) remote control 600c described above. In FIG. 8A, computer system 600a displays user interface 800 (e.g., a wake screen) and computer system 600b displays user interface 654 with application icons 654a-654e corresponding to respective applications that can be activated on computer system 600b. Application icon 654a corresponds to a camera application and is designated for selection in FIG. 8A. In response to detecting selection of application icon 654a (e.g., an input on remote control 600c), if computer system 600b is connected to a camera (e.g., if computer system 600b includes a camera or is connected to another computer system with a camera that is configured to provide image data to computer system 600b), computer system 600b opens the camera application corresponding to application icon 654a and displays a user interface of the camera application (e.g., user interface 826 described with reference to FIG. 8F with a representation of image data captured by the camera connected to computer system 600b).

If computer system 600b is not connected to a camera (e.g., if computer system 600b does not include a camera and/or is not connected to another computer system with a camera that is configured to provide image data to computer system 600b), computer system 600b displays camera selection user interface 804 as shown in FIG. 8B. In FIG. 8B, camera selection user interface 804 includes indication 806 (e.g., instructions) informing the user that computer system 600b can use a camera of another computer system (e.g., for the camera application corresponding to application icon 654a). Camera selection user interface 804 includes list 808 of representations (e.g., user representations) corresponding to users associated with computer systems that satisfy a proximity condition relative to computer system 600b (e.g., computer systems that are near or within a threshold distance of computer system 600b). In some embodiments, computer system 600b only displays representations corresponding to users associated with computer systems that are logged into an account (e.g., “jane@mail.com”) to which computer system 600b is logged into (e.g., computer systems that satisfy the proximity condition and are logged into the same user account as computer system 600b). In some embodiments, a representation corresponds to a user that is associated with two or more computer systems (e.g., multiple computer systems associated with a user).

Representation 808a corresponds to a user (e.g., Jane Appleseed) of computer system 600a. In FIG. 8B, representation 808a is selected (e.g., via input on remote control 600c while representation 808a is designated). In response to detecting selection of representation 808a, computer system 600a and computer system 600b initiate a process for connecting computer system 600a (and/or a camera of computer system 600a) with computer system 600b). For example, computer system 600b displays instructions 818 and computer system 600a displays prompt 810, as shown in FIG. 8C. Instructions 818 include instructions to use computer system 600a to connect a camera to computer system 600b. Prompt 810 includes indication 812, accept option 814, and decline option 816. Indication 812 notifies the user that computer system 600a has been selected to be used as a camera by computer system 600b. In response to detecting selection of decline option 816, computer system 600a ceases display of prompt 810 (e.g., returns to display of user interface 800 as shown in FIGS. 8A and 8B).

In response to detecting selection 825a of accept option 814 (e.g., a tap or other input selecting accept option 814), computer system 600a begins connecting to computer system 600b. For example, computer system 600a begins providing image date from a camera (e.g., 658a and/or 658b) of computer system 600a to computer system 600b. As shown in FIG. 8D, in response to detecting selection 825a of accept option 814, computer system 600a displays user interface 610 and computer system 600b displays camera preview 820 and instructions 822. User interface 610, camera preview 820, and instructions 822 displayed in FIG. 8D are analogous to (e.g., similar to or the same as) user interface 610, camera preview 616, and instructions 618, respectively, described above with reference to FIG. 6B. For example, instructions 622 illustrate and describe how to place computer system 600a to continue to connect a camera sensor and/or microphone of computer system 600a to computer system 600b (e.g., for use in the camera application). Skip option 612 provides an option to bypass placing computer system 600a as described in instructions 622. For example, in response to detecting selection of skip option 612, a camera (e.g., camera sensor 658a and/or camera sensor 658b) and microphone of computer system 600a is connected to computer system 600b (e.g., for use in the application) without placing computer system 600a. Disconnect option 614 provides an option to disconnect computer system 600a from computer system 600b. For example, in response to selection of disconnect option 612, computer system 600a stops providing image data for camera preview 820 to computer system 600b and ceases display of user interface 610. In some embodiments, in response to selection of disconnect option 612, computer system 600b and ceases display of user interface 804 or displays (e.g., re-displays) list 808 as shown in FIG. 8B. Camera preview 820 includes image data (e.g., a video feed) captured by camera sensor 658b (e.g., the back camera of computer system 600a) and instructions 822 indicate that computer system 600a can continue to connect a camera and/or microphone of computer system 600a to computer system 600b by being placed in a predetermined position or via an input at computer system 600b (e.g., via an input on remote control 600c in communication with computer system 600b) without placing computer system 600a. In some embodiments, in response to selection of skip option 612 and/or the input indicated in instructions 822, computer system 600a and/or computer system 600b continue connecting a camera and/or microphone of computer system 600a to computer system 600b for use in the camera application. In some embodiments, in response to selection of skip option 612 and/or the input indicated in instructions 822, computer system 600b displays user interface 826 of the camera application as shown and described with reference to FIG. 8F.

Turning to FIG. 8E, computer system 600a is placed in the position indicated in instructions 622 to continue to connect a camera and/or microphone of computer system 600a to computer system 600b. In response to a determination that computer system 600a is placed in the position indicated in instructions 622 (e.g., a predetermined position), computer system 600b displays indication 824 that computer system 600a is ready to begin providing image data for the camera application on computer system 600b. Indication 824 includes a preview (e.g., an updated preview) of image data being captured by camera sensor 658b (e.g., camera sensor 658b is now facing the user of computer system 600a instead of facing computer system 600b as in FIG. 8D).

After displaying indication 824 (e.g., for a predetermined amount of time or until a camera and/or microphone of computer system 600a has completed connecting to computer system 600b), computer system 600b displays user interface 826 of the camera application. User interface 826 includes a representation (e.g., a video feed) of image data captured by camera sensor 658b of computer system 600a, cameras menu option 828a, camera control 828b, and camera effects option 828c. In some embodiments, in response to detecting selection of camera control 828b, computer system 600b performs a function (e.g., record, pause, and/or stop) associated with the camera of computer system 600a and/or displays a menu of options for controlling the camera of computer system 600a. In some embodiments, in response to detecting selection of camera effects option 828c, computer system 600b displays selectable options for adding, creating, and/or editing effects (e.g., lighting effects, avatars, and/or other content) for the image data captured by the camera of computer system 600a.

In FIG. 8F, cameras menu option 828a is designated for selection as indicted by the bold outline of cameras menu option 828a (e.g., compared to camera control 828b and effects option 828c). In response to selection of cameras menu option 828a, computer system 600b displays (e.g., re-displays) user interface 804 as shown in FIG. 8G. In FIG. 8G, because computer system 600a is connected to computer system 600b (e.g., computer system 600a is actively connected to computer system 600b and/or a camera of computer system 600a is actively being used by computer system 600b, such as to capture image data for the camera application), computer system 600b displays representation 808a of the user of computer system 600a in active device region 830a. Because a computer system (or a camera of a computer system) associated with a user (e.g., Matthew Fox) represented by representation 808b is not connected to computer system 600b (e.g., not actively connected to computer system 600b and/or a camera of a computer system associated with Matthew Fox is not actively being used by computer system 600b), computer system 600b displays representation 808b in users region 830b.

In FIG. 8G, users region 830b includes representation 808c, which corresponds to an option to connect a computer system to computer system 600b by another process (e.g., by scanning a quick response code, near field communication, and/or another technique). In response to selection of representation 808c, computer system 600b displays prompt 832 for connecting to computer system 600b, as shown in FIG. 8H. Prompt 832 includes a quick response code and instructions to scan the quick response code to connect a camera of a device with computer system 600b. Providing another process for a computer system to connect to computer system 600b enables a user to connect a computer system that is not otherwise represented in user interface 804 and/or associated with a user represented in list 808.

In response to obtaining (e.g., detecting and/or receiving) an indication that the quick response code has been scanned (e.g., by a smartphone similar to computer system 600a, a tablet computer with a camera, or other computer system with a camera), a process is initiated for connecting computer system 600b with the computer system that scanned the quick response code (and/or connecting a camera of the computer system that scanned the quick response code to computer system 600b). For example, in some embodiments, in response to obtaining an indication that the quick response code has been scanned, computer system 600b displays user interface 804 as shown in FIG. 8C, and the computer system that scanned the quick response code displays prompt 810 as shown in FIG. 8C (e.g., prior to starting to connect to computer system 600b). In some embodiments, in response to obtaining an indication that the quick response code has been scanned, computer system 600b displays user interface 804 as shown in FIG. 8D (e.g., including camera preview 820 of image data captured by the computer system that scanned the quick response code), and the computer system that scanned the quick response code displays user interface 610 as shown in FIG. 8D (e.g., including skip option 612 and/or disconnect option 614).

Turning to FIG. 8I, computer system 600b displays example user interface 834 of a camera application. In some embodiments, computer system 600b is connected to a camera of an external device (e.g., computer system 600a) and displays images captured by a camera of the external device (e.g., camera sensor 658b of computer system 600a). User interface 834 includes representation 844 (e.g., a preview) of image data captured by a camera in communication with computer system 600b.

User interface 834 includes menu region 836, which includes various options associated with the camera application. In some embodiments, in response to detecting selection of camera selection option 836a, computer system 600b displays options for selecting and/or changing a camera source (e.g., as shown in FIG. 8G). In some embodiments, in response to detecting selection of tracking option 836b, computer system 600b sets (or displays options for setting) one or more camera tracking settings. In some embodiments, in response to detecting selection of multimedia functionality option 836c, computer system 600b displays a user interface for a multimedia feature (e.g., selecting a media item, playing a media item, and/or recording media content). In some embodiments, in response to detecting selection of media library option 836e, computer system 600b displays a library of stored media items (e.g., photos and/or videos). In some embodiments, in response to detecting selection of display configuration option 836f (e.g., a picture-in-picture option), computer system 600b changes (or displays options for changing) a layout of user interface 834. For example, in some embodiments, in response to detecting selection of display configuration option 836f, computer system 600b displays a different user interface (e.g., 654 or an interface of a different application, such as 1204) with a preview (e.g., 616 or 1200) of the captured image data (e.g., image data captured by the camera is displayed as a picture-in-picture window with other content). In some embodiments, in response to detecting selection of video option 836g, computer system 600b displays a user interface for creating video content.

In FIG. 8I, computer system 600b detects selection of camera applications option 836d. In response to detecting selection of camera applications option 836d, computer system 600b displays features and options for using a camera as shown in FIG. 8J. In FIG. 8J, computer system 600b displays camera preview 840, application options 842, and camera selection option 836a in first region 838. In second region 838b, computer system 600b displays shutter button 846 and application menu 848a. In some embodiments, camera preview 840 displays the same portion of the field of view of the camera as representation 844, a smaller portion of the field of view of the camera than representation 844, or a larger portion (e.g., the entirety) of the field of view of the camera than representation 844. For example, in some embodiments, representation 844 displays a portion of the field of view that is used for a selected application, feature, or mode and camera preview 840 displays a different (e.g., larger) portion of the field of view (e.g., to provide context to the user of the actual field of view of the camera), or vice versa.

Application options 842 include options corresponding to respective camera applications (or camera functions or camera modes). In FIG. 8J, application option 842a is selected. In some embodiments, application option 842a corresponds to an application (e.g., a camera application) for capturing photos (e.g., by selecting shutter button 846). Application menu 848a includes options for settings associated with the selected camera application or function (e.g., the application represented by application option 842a).

In FIG. 8J, computer system 600b detects selection of application option 842b. In some embodiments, application option 842b corresponds to a karaoke application. In some embodiments, a karaoke application enables a user to select a song, play a song, and/or capture a video (e.g., of a user) during playback of the song. As shown in FIG. 8L, in response to detecting selection of application option 842b, computer system 600b displays application menu 848b, which includes options for settings associated with the application represented by application option 842b. In FIG. 8L, focus is placed on shutter button 846 (e.g., shutter button 846 is designated but not activated). While shutter button 846 is designated, computer system 600b displays image capture options 852a corresponding to image capture options for the application represented by selected application option 842b. In some embodiments, when shutter button 846 is designated while application option 842a is selected, computer system 600 displays image capture options corresponding to image capture options for the application represented by application option 842a.

Turning to FIG. 8M, in response to detecting selection of application option 842c, computer system 600b displays application menu 848c, which includes options for settings associated with the application represented by application option 842c. In some embodiments, application option 842c corresponds to a video capture application. In FIG. 8M, focus is placed on shutter button 846 (e.g., shutter button 846 is designated but not activated). While shutter button 846 is designated, computer system 600b displays image capture options 852b corresponding to image capture options for the application represented by selected application option 842c.

In some embodiments, application options 842 include more than three application options or fewer than three application options. In some embodiments, application options 842 include one or more application options corresponding to a fitness application, a workout application, a video conferencing application, a presentation application, and/or other application that uses a camera. For example, in some embodiments, a fitness application captures video of a person exercising while playing an instructional video or providing a live video feed of an instructor and/or other participants. In some embodiments, a presentation application records a screen of a device while concurrently displaying content (e.g., a video, webpage, window, and/or user interface of another application) and video captured by a camera (e.g., of a user presenting the content), such as a reaction video. In some embodiments, an application synchronizes a screen recording with an operation of a camera (e.g., capturing video with a camera).

In some embodiments, a tracking function, such as a video tracking function or an image tracking function, is performed on image data captured by a camera. In some embodiments, display of image data captured by the camera is based on the tracking function. In some embodiments, the tracking function tracks one or more objects in a field of view of the camera and adjusts display of the image data based on a state (e.g., a position, speed, velocity, acceleration, location, orientation, gaze, and/or pose) of the one or more objects. For example, in some embodiments, computer system 600b digitally zooms and/or pans a displayed portion of the field of view of the camera to keep an object (e.g., a person, animal, and/or inanimate object of interest) at or near a center of the displayed portion of the field of view. In some embodiments, a tracking function is performed differently for different applications, or different tracking functions are performed for different applications. For example, in some embodiments, a tracking function tracks a first portion of a subject (e.g., a torso, a centroid, and/or a body as a whole) for a first application (e.g., a fitness or workout application) and tracks a second portion of a subject (e.g., a head and/or face) for a second application (e.g., a video conferencing application). In some embodiments, a representation of a field of view of the camera is displayed differently for different applications. In some embodiments, a representation of a field of view of the camera is adjusted (e.g., zoomed, cropped, and/or panned) differently for different applications. In some embodiments, a first portion of the field of view of the camera is displayed for a first application (e.g., a video application) and a second portion of the field of view is displayed for a second application (e.g., a photo application). For example, when application option 842a is selected (e.g., in FIG. 8J), computer system 600b displays a larger portion of the field of view, where the field of view is zoomed out and representation 844 is smaller, than when application option 842c is selected (e.g., in FIG. 8M) (e.g., when application option 842c is selected, computer system 600b displays a smaller portion of the field of view of the camera where the field of view is zoomed in and representation 844 is larger than in FIG. 8I).

In FIG. 8M, computer system 600b detects selection of application option 842a. In response to detecting selection of application option 842a, computer system 600b displays (e.g., re-displays) the options corresponding to application option 842a, as shown in FIG. 8N. In FIG. 8N, computer system 600b detects selection (e.g., activation) of shutter button 846. In response to detecting selection of shutter button 846 while application option 842a is selected, computer system 600b captures image data (e.g., a photo or video) using a camera in communication with computer system 600b. After capturing the image data, computer system 600b displays menu 856 shown in FIG. 8O. Menu 856 includes representation 856a (e.g., a preview and/or thumbnail) of the captured image data, save option 856b, discard option 856c, and done option 856d. In some embodiments, in response to detecting selection of discard option 856c, computer system 600b deletes the captured image data. In some embodiments, in response to detecting selection of save option 856b saves (or displays options of locations in which to save) the captured image data. In some embodiments, computer system 600b saves (e.g., automatically or in response to input) the captured image data to computer system 600b, one or more nearby devices (e.g., devices within a threshold distance of computer system 600b), cloud-based storage, temporary storage, a computer system connected to computer system 600b, and/or a computer system (e.g., 600a) that includes a camera (e.g., 658a and/or 658b) connected to computer system 600b used to capture the image data. In some embodiments, computer system 600b saves (e.g., automatically or in response to input) the captured image data to a media library and/or album of a user account associated with computer system 600b and/or a computer system (e.g., 600a) that includes a camera (e.g., 658a and/or 658b) connected to computer system 600b used to capture the image data. In some embodiments, after capturing the image data, computer system 600b displays (e.g., in menu 856) options for sending the captured image data to one or more devices and/or recipients (e.g., via text message, an instant message, an email, a content transfer protocol, near-field communication, a cloud service, or other technique). In some embodiments, in response to detecting selection of done option 856d, computer system 600b removes display of menu 856 and, optionally, saves and/or sends the captured image data to a default location or device.

Turning to FIG. 8P, computer system 600b displays example user interface 858 of a camera application (e.g., an alternative layout and/or configuration for the camera application in FIGS. 8F and/or 81-80). User interface 858 includes representation 844 of image data captured by a camera in communication with computer system 600b, application options 860, and capture button 864. Application options 860 include application option 860a, application option 860b, and application option 860c. In some embodiments, application options 860 correspond to (e.g., are the same as) application options 842 described above. In FIG. 8P, application option 860c is selected. In some embodiments, application option 860c corresponds to a video capture application or feature. In some embodiments, selection of capture button 864 initiates recording (e.g., when a video is not being recorded) and/or stops or pauses a recording (e.g., when a video is being recorded). Because application option 860c is selected, computer system 600b displays menu 862 and menu 864, which include options associated with application option 860c.

In some embodiments, if computer system 600a is moved from the location shown in FIGS. 8E-8F and 81-8P, computer system 600a displays one or more selectable options for controlling operation of one or more cameras (e.g., 658a and/or 658b) of computer system 600a for use by the displayed application (e.g., the application corresponding to user interface 826, user interface 834, and/or user interface 858; and/or an application corresponding to one or more of application options 842 or application options 860). For example, in some embodiments, in response to being moved (e.g., picked up), computer system 600a displays an option to pause or stop capturing video with the camera, start capturing video with the camera, pause recording video captured by the camera, stop recording video captured by the camera, and/or start recording video captured by the camera.

FIG. 9 is a flow diagram illustrating a method for connecting cameras to devices using a computer system in accordance with some embodiments. Method 900 is performed at a first computer system (e.g., 100, 300, 500, and/or 600b) (e.g., a smart phone, a smart watch, a tablet computer, a laptop computer, a desktop computer, a wearable device, and/or head-mounted device) that is in communication with (e.g., includes and/or is connected to) a display generation component (e.g., 602b) (e.g., a display, touch-screen display, a monitor, a holographic display system, and/or a head-mounted display system) and one or more input devices (e.g., 602 and/or 600c) (e.g., a touch-sensitive surface (e.g., a touch-sensitive display); a mouse; a keyboard; a remote control; a visual input device (e.g., one or more cameras such as, e.g., an infrared camera, a depth camera, a visible light camera, and/or a gaze tracking camera); an audio input device; a biometric sensor (e.g., a fingerprint sensor, a face identification sensor, a gaze tracking sensor, and/or an iris identification sensor); and/or one or more mechanical input devices (e.g., a depressible input mechanism; a button; a rotatable input mechanism; a crown; and/or a dial)). Some operations in method 900 are, optionally, combined, the orders of some operations are, optionally, changed, and some operations are, optionally, omitted.

As described below, method 900 provides an intuitive way for connecting cameras to devices. The method reduces the cognitive burden on a user for connecting cameras to devices, thereby creating a more efficient human-machine interface. For battery-operated computing devices, enabling a user to connect cameras to devices faster and more efficiently conserves power and increases the time between battery charges.

The first computer system detects (902), via the one or more input devices, a request (e.g., an input on 602 and/or 600c) to display (e.g., to launch and/or bring to a foreground) an application (e.g., a camera application, a video conference application, and/or the application corresponding to 654a) that uses (e.g., obtains and/or displays, optionally in real time) data (e.g., an image, one or more images, video, live data, a live image, live images, and/or a live video) captured by a camera sensor. In some embodiments, the request to display the application that uses data captured by a camera sensor includes an input that corresponds to selection of a user interface element (e.g., an application icon and/or an affordance) corresponding to the application. In response (904) to detecting the request to display the application that uses data captured by a camera sensor: in accordance with a determination that the first computer system (e.g., 600b) is connected (e.g., via a wireless connection and/or a wired connection) to a second computer system (e.g., 600a) that is in communication with one or more camera sensors (e.g., 658a and/or 658b) (e.g., a computer system with a camera sensor that is configured to capture data with the camera sensor and provide the captured data to the application), the first computer system displays (906), via the display generation component, the application (e.g., 826) (e.g., a user interface of the application); and in accordance with a determination that the first computer system (e.g., 600b) is not connected to a computer system (e.g., any other computer system, including the second computer system) that is in communication with one or more camera sensors (e.g., there is no computer system in communication with one or more camera sensors that is connected to the first computer system; and/or the first computer system is not connected to a computer system with a camera sensor that is configured to capture data with the camera sensor and provide the captured data to the application), the first computer system displays (908), via the display generation component, a first connection user interface element (e.g., 808a, 808b, and/or 808c) (e.g., a user-interactive user interface element, a button, a selectable icon, a selectable option, and/or an affordance) that, when selected, initiates a process for connecting the first computer system (e.g., 600b) with the second computer system (e.g., 600a) (e.g., connecting a camera sensor and/or a microphone of the second computer system to (e.g., for use by) the first computer system (e.g., for use by the application on the first computer system)). Displaying the first connection user interface element for initiating a process for connecting the first computer system with a second computer system based on whether the first computer system is connected to a computer system that is in communication with one or more camera sensors informs the user when a camera is required for the application and automatically provides the user with an option to connect a second computer system (e.g., that has a camera) when a camera is required, thereby providing improved visual feedback to the user, reducing the number of inputs needed to perform an operation, providing additional control options without cluttering the user interface with additional displayed controls, and performing an operation when a set of conditions has been met without requiring further user input.

In some embodiments, in response to detecting the request to display the application that uses data captured by a camera sensor and in accordance with the determination that the first computer system is not connected to a computer system that is in communication with one or more camera sensors, the first computer system displays, via the display generation component, a list (e.g., 808) of one or more connection user interface elements (e.g., 808a, 808b, and/or 808c) (e.g., two or more connection user interface elements) (e.g., user-interactive user interface elements, buttons, selectable icons, selectable options, and/or affordances) for connecting the first computer system with respective computer systems, the list of one or more connection user interface elements including the first connection user interface element. Displaying the one or more connection user interface elements in response to detecting the request to display the application that uses data captured by a camera sensor and in accordance with the determination that the first computer system is not connected to a computer system that is in communication with one or more camera sensors enables the user to quickly and efficiently select a computer system to connect with the first computer system, thereby providing improved visual feedback and reducing the number of inputs needed to perform an operation.

In some embodiments, the list (e.g., 808) of one or more connection user interface elements includes (e.g., only includes) connection user interface elements (e.g., 808a and/or 808b) that correspond to respective computer systems that are signed into a same account (e.g., user account and/or Wi-Fi network) as the first computer system (e.g., a computer system (e.g., 600a) of Jane Appleseed is signed into a same user account as computer system 600b). In some embodiments, displaying the list of connection user interface elements includes: in accordance with a determination that a third computer system is signed into a same account as the first computer system, displaying a third connection user interface element corresponding to the third computer system in the list of connection user interface element; and in accordance with a determination that the third computer system is not signed into the same account as the first computer system, displaying the list of connection user interface elements without the third connection user interface element corresponding to the third computer system. Displaying connection user interface elements that correspond to computer system that are signed into a same account of the first computer system provides the user with relevant options of computer system to connect with the first computer system, thereby providing improved visual feedback to the user, providing improved privacy and security, and reducing the number of inputs needed to perform an operation.

In some embodiments, the list (e.g., 808) of one or more connection user interface elements includes (e.g., only includes) connection user interface elements (e.g., 808a) that correspond to respective computer systems (e.g., 600a) that are within a predetermined distance of the first computer system. In some embodiments, displaying the list of connection user interface elements includes: in accordance with a determination that a fourth computer system is within the predetermined distance of the first computer system, displaying a fourth connection user interface element corresponding to the fourth computer system in the list of connection user interface element; and in accordance with a determination that the fourth computer system is not within the predetermined distance of the first computer system, displaying the list of connection user interface elements without the fourth connection user interface element corresponding to the third computer system. Displaying connection user interface elements that correspond to computer systems that are within a predetermined distance of the first computer system provides the user with relevant options of computer system to connect with the first computer system, thereby providing improved visual feedback to the user, providing improved privacy and security, and reducing the number of inputs needed to perform an operation.

In some embodiments, the list (e.g., 808) of connection user interface elements includes a second connection user interface element (e.g., 808c) (e.g., a user-interactive user interface element, a button, a selectable icon, a selectable option, and/or an affordance); the first computer system detects, via the one or more input devices, a selection (e.g., input, touch gesture, air gesture, voice command, and/or other selection) of the second connection user interface element (e.g., selection of 808c in FIG. 8G); and in response to detecting the selection of the second connection user interface element, the first computer system displays, via the display generation component, a quick response code (e.g., the quick response code in 832) that, when scanned by an external computer system (e.g., 600a), initiates a process for connecting (e.g., pairing) the first computer system (e.g., 600b) with the external computer system (e.g., connecting a camera sensor of the external computer system with the first computer system). Displaying a quick response code for connecting the first computer system with an external computer system enables the user to quickly and efficiently connect the first computer system with an external computer system that is not represented by a displayed connection user interface element.

In some embodiments, the first computer system detects, via the one or more input devices, a selection (e.g., input, touch gesture, air gesture, voice command, and/or other selection) of the first connection user interface element (e.g., selection of 808a in FIG. 8B), and after detecting selection of the first connection user interface element, in accordance with a determination that the second computer system (e.g., 600a) is in a predetermined position (e.g., the position of 600a in FIG. 8E) (e.g., a predetermined location and/or orientation relative to the first computer system), the first computer system connects one or more camera sensors (e.g., 658a and/or 658b) of the second computer system (e.g., 600a) with the first computer system (e.g., 600b) (e.g., for use by the first computer system and/or the application). Connecting one or more camera sensors of the second computer system with the first computer system in accordance with a determination that the second computer system is in a predetermined position enables the user to quickly and efficiently connect the one or more camera sensors with the first computer system without navigating an interface, thereby reducing the number of inputs needed to perform an operation, providing additional control options without cluttering the user interface with additional displayed controls, and performing an operation when a set of conditions has been met without requiring further user input.

In some embodiments, in response to detecting the request to display the application that uses data captured by a camera sensor and in accordance with the determination that the first computer system (e.g., 600b) is not connected to a computer system that is in communication with one or more camera sensors, the first computer system displays (e.g., concurrently with the list of connection user interface elements), via the display generation component, instructions (e.g., 806) to select a user (or, in some embodiments, a computer system) associated with a computer system that includes one or more camera sensors that are configured for use with the first computer system. Displaying instructions to select a user in response to detecting the request to display the application that uses data captured by a camera sensor and in accordance with the determination that the first computer system is not connected to a computer system that is in communication with one or more camera sensors informs the user how to connect another computer system and/or camera to the first computer system without having to navigate a user interface, thereby providing improved visual feedback to the user and reducing the number of inputs needed to perform an operation.

In some embodiments, the first computer system detects, via the one or more input devices, a selection (e.g., input, touch gesture, air gesture, voice command, and/or other selection) of the first connection user interface element; and after (e.g., in response to) detecting selection of the first connection user interface element (e.g., selection 808a in FIG. 8B), the first computer system displays, via the display generation component, instructions (e.g., 818) to confirm on the second computer system (e.g., 600a) a request to connect the second computer system (e.g., to connect one or more cameras of the second computer system) with the first computer system. In some embodiments, the second computer system displays an accept user interface element (e.g., an accept option) and a decline user interface element (e.g., a decline option), where selection of the accept user interface element enables one or more camera sensors of the second computer system for use with the first computer system and selection of the decline user interface element foregoes enabling one or more camera sensors of the second computer system for use with the first computer system. Displaying instructions to confirm the request to connect the second computer system with the first computer system informs the user of the request and avoids inadvertently connecting the first computer system with the second computer system, thereby providing improved visual feedback to the user and providing improved privacy and security.

In some embodiments, the first computer system receives an indication that a request to connect the second computer system with the first computer system has been accepted (e.g., at the second computer system) (e.g., receiving an indication of selection 825a on 814 in FIG. 8C); and in response to receiving the indication that the request to connect the second computer system with the first computer system has been accepted, the first computer system displays, via the display generation component, a representation (e.g., 820 and/or 824) (e.g., a camera preview, a picture-in-picture window, and/or a reduced-size representation) of video captured by one or more camera sensors (e.g., 658a and/or 658b) of the second computer system (e.g., 600a). In some embodiments, in response to detecting a request (e.g., selection of an accept user interface element) to accept the request to connect the second computer system with the first computer system, the second computer system transmits video captured by one or more cameras of the second computer system to the first computer system. Displaying a representation of video captured by one or more camera sensors of the second computer system in response to receiving the indication that the request to connect the second computer system with the first computer system has been accepted informs the user that the request has been accepted and assists the user to place the one or more camera sensors in a desired position prior to use in the application, thereby providing improved visual feedback to the user and providing improved privacy and security.

In some embodiments, the first computer system receives an indication that the second computer system (e.g., 600a) (and/or, in some embodiments, that one or more camera sensors of the second computer system) is connected to the first computer system (e.g., 600b); and in response to receiving the indication that the second computer system (and/or, in some embodiments, that one or more camera sensors of the second computer system) is connected to the first computer system, the first computer system displays, via the display generation component, a representation (e.g., 826) (e.g., an expanded representation) of video captured by one or more camera sensors (e.g., 658a and/or 658b) of the second computer system (e.g., 600a) (e.g., the first computer system displays a representation of video captured by one or more camera sensors of the second computer system in a user interface of the application). Displaying a representation of video captured by one or more camera sensors of the second computer system in response to receiving the indication that the second computer system is connected to the first computer system automatically informs the user that the second computer system is connected to the first computer system without having to further navigate a user interface, thereby providing improved visual feedback to the user and reducing the number of inputs needed to perform an operation.

In some embodiments, displaying, via the display generation component, a user interface (e.g., 826) of the application (e.g., in response to receiving an indication that the first computer system has connected with the second computer system), including displaying, in the user interface of the application, one or more control user interface elements (e.g., 828a, 828b, and/or 828c) (e.g., user-interactive user interface elements, buttons, selectable icons, selectable options, and/or affordances) that, when selected, cause the first computer system to perform respective functions associated with the video captured by one or more camera sensors of the second computer system. Displaying one or more control user interface elements for performing functions associated with the captured video enables the user to quickly and efficiently perform functions and/or set parameters for capturing video for the application, thereby reducing the number of inputs needed to perform an operation. In some embodiments, displaying the one or more control user interface elements includes displaying a first control user interface element (e.g., 828a) (e.g., a user-interactive user interface element, a button, a selectable icon, a selectable option, and/or an affordance); and the first computer system detects, via the one or more input devices, a selection (e.g., input, touch gesture, air gesture, voice command, and/or other selection) of the first control user interface element (e.g., selection of 828a in FIG. 8F); and in response to detecting the selection of the first control user interface element, the first computer system displays, via the display generation component: an indication (e.g., “ACTIVE” in region 830a) that the second computer system is actively connected with the first computer system; a user interface element (e.g., 808a) (e.g., a user-interactive user interface element, a button, a selectable icon, a selectable option, and/or an affordance) corresponding to the second computer system; an indication (e.g., “USERS” in region 830b) (e.g., graphical indication, text, animation, color, and/or effect) that other computer systems are available to connect with the first computer system; and a user interface element (e.g., 808b) (e.g., a user-interactive user interface element, a button, a selectable icon, a selectable option, and/or an affordance) corresponding to a third computer system that is different from the first computer system and the second computer system. In some embodiments, the first computer system detects, via the one or more input devices, selection of the user interface element corresponding to the third computer system; and in response to detecting the selection of the user interface element corresponding to the third computer system, the first computer system initiates a process for connecting the third computer system with the first computer system (and, in some embodiments, disconnecting the second computer system from the first computer system). Distinguishing active computer systems from other computer system informs the user of the computer system that is already connected with the first computer system and helps avoid confusion and additional inputs, thereby providing improved visual feedback to the user and reducing the number of inputs needed to perform an operation.

In some embodiments, the first computer system detects, via the one or more input devices, a request (e.g., an input on remote control 600c and/or an input on 602b) to display a system-level control menu (e.g., 1400) (e.g., a menu that includes options and/or controls for features that are controlled at an operating system level (e.g., as opposed to an application)); in response to detecting the request to display the system-level control menu, the first computer system displays the system-level control menu (e.g., 1400), including displaying a camera user interface element (e.g., in 1408) (e.g., a user-interactive user interface element, a button, a selectable icon, a selectable option, and/or an affordance); the first computer system detects, via the one or more input devices, a selection (e.g., input, touch gesture, air gesture, voice command, and/or other selection) of the camera user interface element; and in response to detecting the selection of the camera user interface element, the first computer system displays, via the display generation component, a list (e.g., 808) of connection user interface elements (e.g., 808a, 808b, and/or 808c) (e.g., two or more connection user interface elements) (e.g., user-interactive user interface elements, buttons, selectable icons, selectable options, and/or affordances) for connecting the first computer system with respective computer systems, the list of connection user interface elements including the first connection user interface element. Displaying a system-level control menu with a camera user interface element and displaying a list of connection user interface elements in response to detecting the selection of the camera user interface element provides the user with options for connecting with another computer system, thereby providing improved visual feedback and reducing the number of inputs needed to perform an operation.

In some embodiments, in response to receiving an indication that the second computer system (e.g., 600a) (or, in some embodiments, a user associated with the second computer system) has been selected (e.g., to connect with the first computer system) (e.g., selection of 808a in FIG. 8B), the second computer system (e.g., of the selected user) displays an accept option (e.g., 814) for connecting the second computer system with the first computer system (and in some embodiments, a decline option for foregoing connecting with the first computer system). Displaying an accept option at the second computer system in response to receiving an indication that the second computer system has been selected informs the user that the second computer system has been selected and enables the use to confirm use of the second computer system, thereby providing improved visual feedback and providing improved privacy and security. In some embodiments, in response to receiving an indication that a user associated with the second computer system (e.g., 600a) has been selected at the first computer system (e.g., selection of 808a in FIG. 8B), a fourth computer system (e.g., another computer system associated with the selected user other than the second computer system) displays an accept option for connecting the fourth computer system with the first computer system (and, in some embodiments, a decline option for foregoing connecting with the first computer system). In some embodiments, when the first computer system detects a selection of a user, two or more computer systems associated with the user display respective accept options for connecting respective computer systems with the first computer system. Displaying the accept option at a fourth computer system for connecting the fourth computer system with the first computer system in response to receiving an indication that a user associated with the second computer system has been selected at the first computer system enables another computer system associated with the selected user (e.g., the user associated with the second computer system) to connect with the first computer system and allows the user to select which computer system to connect with the first computer system without having to select multiple computer system individually, thereby providing improved visual feedback and reducing the number of inputs needed to perform an operation. In some embodiments, in response to a determination that the accept option (e.g., 814) for connecting the second computer system with the first computer system has been selected (e.g., selection 825a of 814 in FIG. 8C), the fourth computer system ceases display of the accept option for connecting the fourth computer system with the first computer system (e.g., selection of an accept option on one computer system of the selected user applies to all computer systems associated with the selected user). In some embodiments, in response to a determination that the accept option for connecting the fourth computer system with the first computer system has been selected, the second computer system ceases display of the accept option for connecting the second computer system with the first computer system. Ceasing display of the accept option by the fourth computer system in response to a determination that the accept option for connecting the second computer system with the first computer system has been selected informs the user that the accept option has been selected on another computer system, avoids confusion, eliminates the need for the user to manually dismiss the accept option, and reduces clutter on the user interface, thereby providing improved visual feedback to the user, reducing the number of inputs needed to perform an operation, and providing additional control options without cluttering the user interface with additional displayed controls.

In some embodiments, the second computer system (e.g., 600a) detects a selection (e.g., 825a) (e.g., input, touch gesture, air gesture, voice command, and/or other selection) of the accept option (e.g., 814) for connecting the second computer system with the first computer system and, in response to the second computer system detecting the selection of the accept option for connecting the second computer system with the first computer system, the second computer system initiates a process for connecting with the first computer system (e.g., the transition from FIG. 8C to FIG. 8D) (e.g., the second computer system displays instructions for positioning the second computer system, a skip user interface element to connect the second computer system with the first computer system without placing the second computer system according to the displayed instructions, and/or a disconnect user interface element for disconnecting the second computer system from the first computer system). Initiating a process for connecting the second computer system with the first computer system in response to the selection of the accept option at the second computer system enables the user to accept the option on the computer system that is going to be connected with the first computer system, thereby providing improved privacy and security.

Note that details of the processes described above with respect to method 900 (e.g., FIG. 9 are also applicable in an analogous manner to the methods described below and above. For example, methods 700, 1100, 1300, and/or 1500 optionally includes one or more of the characteristics of the various methods described above with reference to method 900. For example, the techniques for connecting a first computer system with a second computer system can be used to connect a camera for use in the real-time communication sessions described in methods 700, 1100, and 1300. For brevity, these details are not repeated below.

FIGS. 10A-10I illustrate exemplary user interfaces for managing a real-time communication session, in accordance with some embodiments. The user interfaces in these figures are used to illustrate the processes described below, including the processes in FIG. 11.

FIG. 10A illustrates computer system 600b described above. In some embodiments, computer system 600b is configured to be controlled by remote control 600c as described above. In FIG. 10A, computer system 600b displays user interface 1002 of a real-time communication application. In FIG. 10A, computer system 600b is not actively in a real-time communication session. User interface 1002 includes new call option 1004, recent calls list 1006, camera preview 1008, and video control options 1010. Camera preview 1008 includes a representation (e.g., a video feed) of image data captured by one or more cameras in communication with computer system 600b. In some embodiments, camera preview 1008 includes image data captured by a camera of computer system 600b. In some embodiments, computer system 600b is connected to computer system 600a (described above) and camera preview 1008 includes image data captured by a camera (e.g., 658a and/or 658b) of computer system 600a. Video control options 1010 include tracking mode option 1010a (e.g., for enabling and/or disabling a video tracking mode), video effect option 1010b (e.g., for enabling and/or disabling one or more video effects), and lighting option 1010c (e.g., for selecting a lighting mode). In FIG. 10A, computer system 600b detects selection of new call option 1004 (e.g., via an input on remote control 60c while new call option 1004 is designated in user interface 1002).

In response to detecting selection of new call option 1004, computer system 600b displays participant selection user interface 1012. Participant selection user interface 1012 includes letter options 1014, contact list 1016, and start call option 1018, as shown in FIG. 10B. In FIG. 10B, because no contacts have been selected, start call option 1018 is disabled (e.g., greyed out and/or blurred out). Contact list 1016 includes a list of contactable entities that can be selected for a call. Selection indicator 1020a indicates whether a respective contactable entity has been selected. In FIG. 10B, selection indicator 1020a in contact item 1016a indicates that the corresponding contactable entity, Jack Andrews, can be added (e.g., is not selected). In FIG. 10B, contact item 1016a is selected. In response to detecting selection of contact item 1016a, computer system 600b displays participant representation 1022a corresponding to the selected contact item (e.g., “Jack Andrews”) to region 1022 and enables start call option 1018. In FIG. 10C, selection indicator 1020a is updated (e.g., with a check mark) to indicate that the corresponding contactable entity has been selected.

In FIG. 10C, two other contact item 1016b (e.g., “Carlan Clemens”) and contact item 1016c (e.g., “Rhonda Fletcher”) are selected, and letter 1014f (e.g., “F”) is selected in letter options 1014. As shown in FIG. 10D, in response to detecting selection of contact item 1016c and contact item 1016c, computer system 600b adds participant representation 1022b (e.g., corresponding to contact item 1016b) and participant representation 1022c (e.g., corresponding to contact item 1016c) to region 1022. Computer system 600b updates selection indicator 1020b and selection indicator 1020c to indicate that contact item 1016b and contact item 1016c have been selected, respectively. In response to detecting selection of letter 1014f, computer system 600b scrolls letter options 1014.

In FIG. 10D, start call option 1018 is selected. In response to detecting selection of start call option 1018, computer system 600b initiates (or attempts to initiate) a real-time communication session (e.g., a video call or video conference) with the selected participants. While the real-time communication session is being initiated, computer system 600b displays user interface 1002 as shown in FIG. 10E. In FIG. 10E, computer system 600b displays participants representation 1024 and control user interface elements 1028. Control user interface elements 1028 include add option 1028a, share option 1028b, mute option 1028c (e.g., for enabling and/or disabling a microphone used for the real-time communication session), camera option 1018d (e.g., for enabling and/or disabling a camera used for the real-time communication session), and end call option 1028e. In some embodiments, in response to detecting selection of add option 1028a, computer system 600b displays participant selection user interface 1012 to add additional participants to the real-time communication session. In some embodiments, in response to detecting selection of share option 1028b, computer system 600b initiates a process for sharing content (e.g., screen share content, media content, and/or synchronized content) in the real-time communication session. In some embodiments, in response to detecting selection of end call option 1028e, computer system 600b disconnects from the real-time communication session. In some embodiments, in response to detecting selection of end call option 1028e, computer system 600b ends the real-time communication session (e.g., for some or all participants).

As shown in FIG. 10E, when computer system 600b displays (e.g., initiates display) of control user interface elements 1028, computer system 600b designates end call option 1028e such that end call option 10128e can be easily selected. For example, in response to detecting a selection input on remote control 600c while end call option 1028e is designated in FIG. 10E, computer system 600b disconnects from or ends the real-time communication session. This provides the user with an efficient way to end a real-time communication session if, e.g., the real-time communication session is started on accident. After the participants have joined the real-time communication session, computer system 600b displays real-time communication interface 1002 as shown in FIG. 10F. In FIG. 10F, real-time communication interface 1002 includes participant representations 1026a-1026c along with camera preview 1008. Participants representation 1024 is updated to indicate the participants that are currently in the real-time communication session. In FIG. 10F, end call option 1028e remains designated for selection. In some embodiments, computer system 600b removes or ceases display of control user interface element 1028 during the real-time communication session. In some embodiments, while the real-time communication session is active and control user interface elements 1028 are not displayed, computer system 600b detects a request to display control user interface elements 1028. In response to detecting the request to display control user interface elements 1028, computer system 600b displays control user interface elements 1028 and designates (e.g., initially designates) end call option 1028e when control user interface elements 1028 are displayed, as shown in FIG. 10F.

In FIG. 10F, computer system 600b detects a request to display video control options for the real-time communication session. In some embodiments, the request includes an input, such as a directional input or press of a menu button on remote control 600c. In response to detecting the request to display video control options, computer system 600b enlarges camera preview 1008 and displays video control options 1010 in camera preview 1008, as shown in FIG. 10G. Video control options 1010 are described above with reference to FIG. 10A. When computer system 600b displays video control options 1010, tracking mode option 1010a is designated and end call option 1028e is not designated.

Turning to FIG. 10H, computer system 600b reduces the size of camera preview 1008 and displays user interface 1002 without control user interface elements 1028 and video control options 1010 (e.g., ceases display of control user interface elements 1028 and video control options 1010). In some embodiments, computer system 600b displays user interface 1002 as shown in FIG. 10H in response to a user input (e.g., a press of a back button, exit button, or directional button on remote control 600c while displaying user interface 1002 as shown in FIG. 10G). In some embodiments, computer system 600b displays user interface 1002 as shown in FIG. 10H automatically (e.g., without receiving an input) in response to a determination that a threshold amount of time has expired without receiving an input.

While displaying user interface 1002 as shown in FIG. 10H, computer system 600b receives a request to display a set of one or more control user interface elements that correspond to respective functions associated with the real-time communication session. In some embodiments, the request includes an input, such as a directional input or press of a menu button on remote control 600c. In response to receiving the request to display a set of one or more control user interface elements that correspond to respective functions associated with the real-time communication session, computer system 600b displays control user interface elements 1028 and designates end call option 1028c (e.g., automatically and/or by default), as shown in FIG. 10I. In response to detecting selection of end call option 1028c, computer system 600b ends the real-time communication session or initiates a process for ending the real-time communication session. In some embodiments, selection of end call option 1028e includes a selection input (e.g., a press of a button, such as an enter button or an OK button, on remote control 600c; a voice command; an air gesture; and/or a touch gesture) while end call option 1028e is designated. In some embodiments, in response to detecting selection of end call option 1028c, computer system 600b ends (or initiates a process for ending) the real-time communication session for all participants. In some embodiments, in response to detecting selection of end call option 1028e, computer system 600b ends (or initiates a process for ending) the real-time communication session for (e.g., only for) the participant associated with computer system 600b (e.g., the participant associated with computer system 600b leaves the real-time communication session and the real-time communication session continues for other participants).

FIG. 11 is a flow diagram illustrating a method for managing a real-time communication session using a computer system in accordance with some embodiments. Method 1100 is performed at a computer system (e.g., 100, 300, 500, 600a, and/or 600b) (e.g., a smart phone, a smart watch, a tablet computer, a laptop computer, a desktop computer, a wearable device, and/or head-mounted device) that is in communication with (e.g., includes and/or is connected to) a display generation component (e.g., 602a and/or 602b) (e.g., a display, touch-screen display, a monitor, a holographic display system, and/or a head-mounted display system) and one or more input devices (602a, 602b, and/or 600c) (e.g., a touch-sensitive surface (e.g., a touch-sensitive display); a mouse; a keyboard; a remote control; a visual input device (e.g., one or more cameras such as, e.g., an infrared camera, a depth camera, a visible light camera, and/or a gaze tracking camera); an audio input device; a biometric sensor (e.g., a fingerprint sensor, a face identification sensor, a gaze tracking sensor, and/or an iris identification sensor); and/or one or more mechanical input devices (e.g., a depressible input mechanism; a button; a rotatable input mechanism; a crown; and/or a dial)). Some operations in method 1100 are, optionally, combined, the orders of some operations are, optionally, changed, and some operations are, optionally, omitted.

As described below, method 1100 provides an intuitive way for managing a real-time communication session. The method reduces the cognitive burden on a user for managing a real-time communication session, thereby creating a more efficient human-machine interface. For battery-operated computing devices, enabling a user to manage a real-time communication session faster and more efficiently conserves power and increases the time between battery charges.

While a real-time communication session (e.g., an audio communication session, a video communication session, and/or an audio/video communication session) is active (e.g., ongoing and/or in progress) (or, in some embodiments, prior to initiating a real-time communication session) on the computer system (e.g., while computer system 600b is displaying the user interface displayed in FIGS. 6D, 6E, 6F, 6G, 6H, 10D, 10H, 12A, 12M, 12N, 120, and/or 14A), the computer system receives (1102) (e.g., detects), via the one or more input devices, a request (e.g., an input on remote control 600c, an input in input area 601 on remote control 600c, a press of a button on remote control 600c, and/or a tap on display 602b) to display a set of one or more control user interface elements (e.g., 1028 and/or 1010) (e.g., user-interactive user interface elements, buttons, selectable icons, selectable options, and/or affordances) that correspond to respective functions associated with the real-time communication session (e.g., in response to selection of a control user interface element of the set of one or more control user interface elements is selected, the computer system performs a respective function associated with the real-time communication session). In some embodiments, the set of one or more control user interface elements correspond to an end-session function (e.g., ending the real-time communication session), a mute function (e.g., muting a microphone used for the real-time communication session), an unmute function (e.g., unmuting a microphone used for the real-time communication session), a speaker activation function (e.g., activating a speaker used for outputting audio of the real-time communication session), a microphone deactivation function (e.g., deactivating a speaker used for outputting audio of the real-time communication session), an enable camera function (e.g., enabling a camera that is configured to capture an image and/or video for the real-time communication session), a disable camera function (e.g., disenabling a camera that is configured to capture an image and/or video for the real-time communication session), and/or a screensharing function (e.g., sharing and/or transmitting a view of content displayed on a device of a participant of the real-time communication session). In some embodiments, the request to display the set of one or more control user interface elements includes a request to initiate (e.g., start) a real-time communication session.

In response to receiving the request to display the set of one or more control user interface elements, the computer system displays (1104), via the display generation component, the set of one or more control user interface elements (e.g., 1028 and/or 1010), including designating (e.g., visually designating, putting in focus, highlighting, outlining, and/or bolding) a first control user interface element (e.g., 1028e) (e.g., a user-interactive user interface element, a button, a selectable icon, a selectable option, and/or an affordance) of the set of one or more control user interface elements (e.g., the computer system initially designates the first control user interface element by default when displaying the set of one or more control user interface elements). In some embodiments, designating the first control user interface element includes: designating the first control user interface for selection; displaying a visual indication that the first control user interface element is designated; and/or displaying a user interface element associated with (e.g., on, overlapping, and/or adjacent to) the first control user interface element that is distinct from the first control user interface element.

While designating the first control user interface element (e.g., 1028e in FIG. 10F or FIG. 10I) (e.g., while the first control user interface element is designated), the computer system detects (1106), via the one or more input devices, a selection (e.g., input, touch gesture, air gesture, voice command, and/or other selection) of the first control user interface element (e.g., a tap on 1028c, an input on remote control 600c, a press of a button on remote control 600c, and/or an input in input area 601 on remote control 600c while 1028e is designated). In some embodiments, detecting the selection of the first control user interface element includes detecting a press of a button (e.g., an enter button, an “OK” button, or other selection button) and/or other selection input while the first control user interface element is designated. In response to detecting the selection of the first control user interface element, the computer system initiates (1108) a process for ending the real-time communication session. In some embodiments, in response to detecting the selection of the first control user interface element, the computer system ends the real-time communication session. In some embodiments, in response to detecting the selection of the first control user interface element, the computer system displays a prompt to confirm that the real-time communication session is to be ended. Designating a control user interface element for initiating a process for ending the real-time communication session in response to receiving a request to display controls for the real-time communication session informs the user of the option to end the real-time communication session and enables a user to quickly and efficiently end a real-time communication session without having to further navigate a user interface, thereby providing improved visual feedback and reducing the number of inputs needed to perform an operation.

In some embodiments, while the real-time communication session is active on the computer system (e.g., while computer system 600b is displaying the user interface displayed in FIGS. 6D, 6E, 6F, 6G, 6H, 10D, 12A, 12M, 12N, 12O, and/or 14A): the computer system displays, via the display generation component, a user interface of the real-time communication session at a first size (e.g., an expanded size and/or a full-screen size) (e.g., displaying the user interface displayed on 600b in FIGS. 6D, 6E, 6F, 6G, 6H, 10D, 12A, 12M, 12N, 12O, and/or 14A); the computer system detects, via the one or more input devices, a request (e.g., selection of a back button and/or a home button on a remote control in communication with the computer system) to display a second user interface (e.g., 654, 1204, or 1216) that is different from the user interface of the real-time communication session; and in response to detecting the request to display the second user interface, concurrently the computer system displays, via the display generation component: the second user interface (e.g., 654, 1204, or 1216); and the user interface (e.g., 1200) of the real-time communication session at a second size that is smaller than the first size (e.g., the computer system displays the user interface of the real-time communication session as a picture-in-picture window) (e.g., 1200 in FIGS. 12B, 12C, 12D, 12E, and/or 12F). Reducing the size of the user interface of the real-time communication session in response to detecting the request to display the second user interface enables the user to view the second user interface while maintaining context of the real-time communication session (e.g., enables the user to multitask during the real-time communication session), thereby providing improved visual feedback to the user and providing additional control options without cluttering the user interface with additional displayed controls.

In some embodiments, the computer system displays (e.g., before the real-time communication session is active on the computer system), via the display generation component, a first list (e.g., 1006) of real-time communication sessions (e.g., previous real-time communication sessions and/or recent real-time communication sessions), wherein the first list of real-time communication sessions includes a first set of information about the real-time communication session, and wherein the first set of information about the real-time communication sessions includes less information than a second list of the real-time communication session displayed at a second computer system that is different from the computer system. In some embodiments, the second list of the real-time communication sessions includes respective dates and/or time of the real-time communication sessions, and the first list of the real-time communication sessions does not include the respective dates and/or times of the real-time communication sessions. Displaying the first list of real-time communication sessions with less information than on a second computer system provides the user with information about recent calls without revealing potentially personal or private information to others viewing the first list, thereby providing improved visual feedback to the user and providing improved privacy and security.

In some embodiments, the computer system displays, via the display generation component, an add participants user interface element (e.g., 1028a) (e.g., a user-interactive user interface element, a button, a selectable icon, a selectable option, and/or an affordance); the computer system detects, via the one or more input devices, a selection (e.g., input, touch gesture, air gesture, voice command, and/or other selection) of the add participants user interface element (e.g., a tap on 1028a and/or an input on remote control 600c while 1028a is designated on display 602b); and in response to detecting the selection of the add participants user interface element, the computer system displays, via the display generation component, a user interface (e.g., 1012) for selecting one or more participants for the real-time communication session. In some embodiments, the computer system displays the add participants user interface element while the real-time communication session is active (e.g., to add additional participants to the real-time communication session). In some embodiments, the computer system displays the add participants user interface element while no real-time communication session is active (e.g., to select participants for a new real-time communications session). Displaying the add participants user interface element enables the user to quickly and efficiently select participants for a real-time communication session, thereby reducing the number of inputs needed to perform an operation.

In some embodiments, the computer system displays, via the display generation component, a first set (e.g., a first list) of contactable users (e.g., 1016 in FIG. 10B) and a set of letters (e.g., 1014) (e.g., in alphabetical order); the computer system detects, via the one or more input devices, a selection (e.g., input, touch gesture, air gesture, voice command, and/or other selection) of a first letter (e.g., letter F in 1014) in the set of letters; and in response to detecting the selection of the first letter in the set of letters, the computer system displays a second set of contactable users (e.g., 1014 in FIG. 10D) associated with the first letter (e.g., a list of contactable users whose names begin with the first letter). In some embodiments, in response to detecting the selection of the first letter in the set of letters, the computer system visually designates the first letter. Displaying a second set of contactable users associated with the first letter in response to detecting the selection of the first letter enables a user to quickly and efficiently scroll the set of letters to find and add participants to the real-time communication session, thereby providing improved visual feedback to the user and reducing the number of inputs needed to perform and operation.

In some embodiments, the computer system displays (e.g., before the real-time communication session is active), via the display generation component, a user interface (e.g., 1012) for selecting participants for the real-time communication session; the computer system detects, via the one or more input devices, a selection (e.g., input, touch gesture, air gesture, voice command, and/or other selection) of a first participant (e.g., selection of 1016a in FIG. 10B) (e.g., selection of a user interface element corresponding to the first participant); in response to detecting the selection of the first participant, the computer system displays, via the display generation component, a representation (e.g., 1022a) (e.g., a profile picture, a thumbnail, an avatar, and/or a monogram) of the first participant in a participant region (e.g., 1022) of the user interface for selecting participants for the real-time communication session (and, in some embodiments, enabling a start-video-call user interface element); while displaying the representation of the first participant in the participant region, the computer system detects, via the one or more input devices, a request to initiate the real-time communication session (e.g., selection of 1018) with participants corresponding to participant representations in the participant region; and in response to detecting the request to initiate the real-time communication session with the participants corresponding to the participant representations in the participant region, the computer system initiates the real-time communication session with the participants corresponding to the participant representations in the participant region (e.g., as shown and described with reference to FIGS. 10D-10E). In some embodiments, in response to detecting the selection of the first participant, the computer system visually designates (e.g., with a check mark or other identifier) an item (e.g., a second representation) of the first participant (e.g., in a list of contactable users). In some embodiments, displaying the representation of the first participant in the participant region includes displaying an animation of the representation of the first participant moving from a list of contactable users to the participant region. In some embodiments, the computer system detects a selection of a second participant and, in response, displays a representation of the second participant in the participant region with the representation of the first participant, where displaying the representation of the second participant in the participant region includes changing (e.g., reducing) a size of the representation of the first participant. Displaying the representation of the first participant in a participant region informs the user that the first participant had been selected to be included in the real-time communication session, thereby providing improved visual feedback to the user.

In some embodiments, the set of one or more control user interface elements (e.g., 1028 and/or 1010) includes a camera effects user interface element (e.g., 1010a, 1010b, and/or 1010c) (e.g., a user-interactive user interface element, a button, a selectable icon, a selectable option, and/or an affordance); the computer system displays, via the display generation component, a representation (e.g., 1008) (e.g., a video feed) of video captured by one or more cameras (e.g., 658a and/or 658b) in communication with the computer system (e.g., one or more cameras of the computer system and/or one or more cameras of an external computer system that is in communication with the computer system); the computer system detects, via the one or more input devices, a selection (e.g., input, touch gesture, air gesture, voice command, and/or other selection) of the camera effects user interface element; and in response to detecting the selection of the camera effects user interface element, the computer system adjusts the representation of the video captured by the one or more cameras (or, in some embodiments, displays selectable options for adjusting the representation of the video captured by the one or more cameras). In some embodiments, adjusting the representation of the video captured by the one or more cameras includes applying and/or changing a lighting effect, applying and/or changing a tracking function, blurring a background, and/or emphasizing a subject in the field of view of the one or more cameras, and/or adding an avatar to the representation of the video captured by the one or more cameras. Adjusting the representation of the video captured by the one or more cameras in response to detecting the selection of the camera effects user interface element enables the user to quickly and efficiently customize the video, thereby reducing the number of inputs needed to perform an operation.

In some embodiments, the computer system detects (e.g., while displaying a user interface of the real-time communication session, and while the real-time communication session is active) (e.g., while computer system 600b is displaying the user interface displayed in FIGS. 6D, 6E, 6F, 6G, 6H, 10D, 12A, 12M, 12N, 12O, and/or 14A), via the one or more input devices, a press of a hardware button (e.g., on a remote control) (e.g., a press of button 603b on remote control 600c); and in response to detecting the press of the hardware button: in accordance with a determination that the press of the hardware button satisfies a set of audio call option criteria (e.g., that the press of the hardware button has a duration that satisfies a duration threshold), the computer system displays an audio call user interface element (e.g., a user-interactive user interface element, a button, a selectable icon, a selectable option, and/or an affordance); and in accordance with a determination that the press of the hardware button does not satisfy the set of audio call option criteria, the computer system displays a user interface other than the user interface of the real-time communication session (e.g., a home screen); the computer system detects, via the one or more input devices, a selection (e.g., input, touch gesture, air gesture, voice command, and/or other selection) of the audio call user interface element; and in response to detecting the selection of the audio call user interface element, the computer system initiates an audio call (e.g., with the participants of the real-time communication session in FIGS. 6D, 6E, 6F, 6G, 6H, 10D, 12A, 12M, 12N, 12O, and/or 14A) (e.g., a phone call, an audio with selected participants, and/or an audio call with the participants of the real-time communication session). In some embodiments, the computer system initiates an audio call in response to detecting the press of the hardware button and in accordance with a determination that the press of the hardware button does not satisfy the set of audio call option criteria. Displaying the audio call user interface or a user interface other than the user interface of the real-time communication session based on whether the press of the hardware button satisfies a set of audio call option criteria enables the user to quickly and efficiently initiate an audio call without navigating a user interface, thereby performing an operation when a set of conditions has been met without requiring further user input and reducing the number of inputs needed to perform an operation.

Note that details of the processes described above with respect to method 1100 (e.g., FIG. 11 are also applicable in an analogous manner to the methods described below and above. For example, methods 700, 900, 1300, and/or 1500 optionally includes one or more of the characteristics of the various methods described above with reference to method 1100. For example, the techniques for displaying a set of one or more control user interface elements for a real-time communication session can be applied to the real-time communication sessions in methods 700 and 1300. For brevity, these details are not repeated below.

FIGS. 12A-120 illustrate exemplary user interfaces for managing a real-time communication session, in accordance with some embodiments. The user interfaces in these figures are used to illustrate the processes described below, including the processes in FIG. 13.

FIG. 12A illustrates computer system 600b described above. In some embodiments, computer system 600b can be controlled via inputs on remote control 600c as described above. In FIG. 12A, computer system 600b is in an active real-time communication session and displays representation 620 of a remote participant and representation 626 (e.g., a self-view) of the video captured by a camera connected to computer system 600b (e.g., as described with reference to FIG. 6D). In some embodiments, a participant of the real-time communication session can share content in the real-time communication session with other participants such that the participants of the real-time communication session can view and/or hear the content at the same time. In FIG. 12A, computer system 600b is not sharing any content in the real-time communication session.

In FIG. 12A, computer system 600b receives a request to navigate to a different user interface. In some embodiments, the request to navigate to a different user interface includes a press of button 603a, a press of button 603b, and/or an input in input area 601 on remote control 600c. For example, in response to selection of button 603a, computer system 600b displays user interface 654 and reduces the size of the real-time communication. In FIG. 12B, computer system 600b displays the real-time communication session in window 1200 (e.g., a picture-in-picture window and/or overlaid on user interface 654). In some embodiments, window 1200 displays a representation of a participant (e.g., a remote participant and/or a participant who was most recently active in the real-time communication session). In some embodiments, user interface 654 is the same user interface shown and described with reference to FIGS. 6A, 6I, and 8A. In some embodiments, user interface 654 is a home screen or a menu screen with user interface elements corresponding to respective applications. In FIG. 12B, window 1200 includes instructions 1202 for displaying options for the real-time communication session. For example, instructions 1202 describe that computer system 600b displays options for the real-time communication session (e.g., video control options 1010).

In FIG. 12B, computer system 600b detects selection of TV application icon 654c (e.g., an input 7 on remote control 600c while TV application icon 654c is designated). In response to selection of TV application icon 654c, computer system 600b opens a TV application, as shown in FIG. 12C. In FIG. 12C, computer system 600b displays user interface 1204 of the TV application, which includes information about a media item (e.g., a TV episode, “The First Landing, Season 3, Episode 1”), while maintaining display of the real-time communication session in window 1200.

In FIG. 12C, computer system 600b receives selection of play option 1206 (e.g., an input on remote control 600c while play option 1206 is designated). In response to selection of play option 1206, because a real-time communication session is active on computer system 600b, computer system 600 displays menu 1208 with option 1210 for sharing the selected media item in the real-time communication session, option 1212 for playing the media item just on computer system 600b, and option 1214 for canceling the request to play the media item (e.g., to cease display of menu 1208 without playing the media item).

In some embodiments, sharing the selected media item in the real-time communication session includes enabling playback of the media item in a user interface of the real-time communication session on the computer systems of the respective participants so that the participants of the real-time communication session can experience (e.g., watch and/or listen to) playback of the media item at the same time. For example, in response to selection of option 1210 (e.g., an input on remote control 600c while option 1210 is designated), the selected media item is added to the real-time communication session and computer system 600b displays playback of the media item 1216, as shown in FIG. 12E. In FIG. 12E, while displaying playback of media item 1216, computer system 600b maintains display of the real-time communication session in window 1200 and displays notification 1218, which indicates that playback of media item 1216 has started in the real-time communication session (e.g., with participant Emily Parker).

In some embodiments, in response to an input while content is being shared in a real-time communication session, computer system 600b displays options for controlling a view of the shared content and/or the real-time communication session. In FIG. 12E, computer system 600b receives a request to display options for controlling a view (e.g., a layout) of the shared content and/or the real-time communication session. In some embodiments, the request to display options for controlling a view of the shared content and/or the real-time communication session includes a press of button 603b (e.g., as described in instructions 1202 in window 1200 in FIG. 12B). In response to receiving the request to display options for controlling a view of the shared content and/or the real-time communication session, computer system 600b displays view options 1220. In the example illustrated in FIG. 12F, computer system 600b displays view options 1220 in window 1200 of the real-time communication session. View options 1220 include hide option 1220a, split view option 1220b, and expand option 1220c. In FIG. 12F, split view option 1220b is selected. In response to detecting selection of split view option 1220b, computer system 600b displays a split screen view of the real-time communication session and the content being shared in the real-time communication session. For example, in FIG. 12G, computer system 600b displays user interface 1222 with a split screen view in which the shared content is displayed in region 1222a (e.g., a window on a left side of display 602b) and the real-time communication session is displayed in region 1222b (e.g., a region on the right side of display 602b). Region 1222b includes representation 1242 of a participant of the real-time communication session and representation 626 of the video captured by a camera connected to computer system 600b. Instructions 1224 include directions to press button 603b on remote control 600c to display (e.g., re-display) view options 1220.

In FIG. 12G, computer system 600b receives a request to display view options 1220 (e.g., a press of button 603b on remote 600c). In response to receiving the request to display view options 1220, computer system 600b displays view options 1220 as shown in FIG. 12H. In FIG. 12H, hide option 1220a is selected (e.g., via an input on remote control 600c while hide option 1220a is designated at computer system 600b). As shown in FIG. 12I, in response to selection of hide option 1220a, computer system 600b hides the real-time communication session (e.g., removes display of representation 1242 and representation 626) and expands display of the content shared in the real-time communication session. When computer system 600b hides the real-time communication session, computer system 600b displays instructions 1226 and indication 1228 that the real-time communication session is active but hidden. Instructions 1226 include directions to press button 603b on remote control 600c to display (e.g., show and/or unhide) the real-time communication session and an indication that a camera is active (e.g., providing captured video to the real-time communication session).

In FIG. 12I, computer system 600b receives a request to display (e.g., show and/or unhide) the real-time communication session (e.g., button 603b is pressed on remote control 600c). As shown in FIG. 12J, in response to receiving the request to display the real-time communication session, computer system 600b displays (e.g., re-displays) user interface 1222 with the shared content in region 1222a and the real-time communication session in region 1222b (e.g., the same interface that is displayed in FIG. 12H).

In FIG. 12J, expand option 1220c is selected (e.g., via an input on remote control 600c while expand option 1220c is designated on display 602b). As shown in FIG. 12K, in response to selection of expand option 1220c, computer system 600b displays maximize option 1230 to display an expanded (e.g., a maximized and/or full screen) view of the real-time communication session and end call option 1232 to disconnect computer system 600b from the real-time communication session.

In FIG. 12K, maximize option 1230 is selected. In response to selection of maximize option 1230, computer system 600b displays option 1234, option 1236, option 1238, and option 1240 for controlling the content shared in the real-time communication session, as shown in FIG. 12L. Option 1234 enables computer system 600b to continue playing the shared content and displaying the shared content at a smaller size (e.g., in a picture-in-picture window); option 1236 enables computer system 600b to end sharing of the content in the real-time communication session for all participants of the real-time communication session; option 1238 enables computer system 600b to stop playback of the shared content at computer system 600b while maintaining playback of the shared content in the real-time communication session for the other participants; and option 1240 causes computer system 600b to return to the user interface shown in FIG. 12J or FIG. 12K.

In FIG. 12L, option 1234 is selected (e.g., via an input on remote control 600c while option 1234 is designated on computer system 600b). In response to selection of option 1234, computer system 600b enlarges display of the real-time communication session and reduces display of the shared content, while maintaining playback of the shared content in the real-time communication session. For example, in FIG. 12M, in response to selection of option 1234, computer system 600b displays representation 620 of the remote participant of the real-time communication session in an enlarged (e.g., full-screen) state and displays representation 1244 of the shared content. Representation 1244 includes instructions 1244a to press button 603b on remote control 600c for options for viewing the shared content and/or the real-time communication session. While displaying representation 620 of the real-time communication session and representation 1244 of the shared content, computer system 600b displays camera indicator 1244b. Camera indicator 1244b informs the user that a camera of computer system 600b is active and providing video to the real-time communication session (e.g., since a representation of the video captured by the camera is not otherwise displayed, such as in representation 626).

In FIG. 12M, computer system 600b receives a request (e.g., selection of button 603b on remote control 600c) to display options for controlling a view of the shared content and/or the real-time communication session. In response to receiving the request, computer system 600b displays view options 1246. In the example illustrated in FIG. 12F, computer system 600b displays view options 1246 in window 1244 of the shared content. In response to selection of option 1246a, computer system 600b enlarges display of the shared content and reduces the size of the real-time communication session (e.g., as shown in FIG. 12E or FIG. 12F). In response to selection of option 1246b, computer system 600b ends playback of the shared content in the real-time communication session and/or displays option 1234, option 1236, option 1238, and/or option 1240 displayed in FIG. 12L.

In FIG. 12N, option 1246c is selected (e.g., via an input on remote control 600c while option 1246c is designated on display 602b). In response to selection of option 1246c, computer system 600b displays (e.g., returns to) a split view as shown in FIG. 12O. In FIG. 12O, computer system 600b displays user interface 1222 with a representation of the remote participant of the real-time communication session in region 1222a and with representation 1248 of the shared content and representation 626 (e.g., a self-view) of the video of the camera of computer system 600b in region 1222b.

In some embodiments, the techniques for displaying and controlling the real-time communication session and the content shared in the real-time communication session (e.g., hiding the real-time communication session, expanding display of the real-time communication session, switching between layouts, and/or ending the real-time communication session) can be applied to other types of content that is displayed and/or accessed during the real-time communication session. For example, an application with content that is not shared in the real-time communication session can be displayed in place of the content displayed in: 1216 in FIGS. 12E, 12F, and 12I; 1222a in FIGS. 12G, 12H, and 12J-12L; 1244 in FIGS. 12M-12N; and/or 1248 in FIG. 12O.

FIG. 13 is a flow diagram illustrating a method for managing a real-time communication session using a computer system in accordance with some embodiments. Method 1300 is performed at a computer system (e.g., 100, 300, 500, 600a, and/or 600b) (e.g., a smart phone, a smart watch, a tablet computer, a laptop computer, a desktop computer, a wearable device, and/or head-mounted device) that is in communication with (e.g., includes and/or is connected to) a display generation component (e.g., a display, touch-screen display, a monitor, a holographic display system, and/or a head-mounted display system) and one or more input devices (e.g., a touch-sensitive surface (e.g., a touch-sensitive display); a mouse; a keyboard; a remote control; a visual input device (e.g., one or more cameras such as, e.g., an infrared camera, a depth camera, a visible light camera, and/or a gaze tracking camera); an audio input device; a biometric sensor (e.g., a fingerprint sensor, a face identification sensor, a gaze tracking sensor, and/or an iris identification sensor); and/or one or more mechanical input devices (e.g., a depressible input mechanism; a button; a rotatable input mechanism; a crown; and/or a dial)). Some operations in method 1300 are, optionally, combined, the orders of some operations are, optionally, changed, and some operations are, optionally, omitted.

As described below, method 1300 provides an intuitive way for managing a real-time communication session. The method reduces the cognitive burden on a user for managing a real-time communication session, thereby creating a more efficient human-machine interface. For battery-operated computing devices, enabling a user to manage a real-time communication session faster and more efficiently conserves power and increases the time between battery charges.

While displaying, via the display generation component, a first user interface (e.g., a user interface of a first application) (e.g., 654, 1204, 1216, 1222, and/or the content in 1222a), the computer system receives (1302) (e.g., detects), via the one or more input devices, a request (e.g., a press of button 603a and/or button 603b on remote control 600c) to navigate to (e.g., display) a second user interface (e.g., 654) (e.g., a user interface of a second application, a home user interface, or a menu user interface) that is different from the first user interface. In some embodiments, receiving the request to navigate to the second user interface includes detecting selection of a back button or a return button. In response (1304) to receiving the request to navigate to the second user interface: in accordance with a determination that the first user interface (e.g., 1216 and/or the content in 1222a) is included (e.g., being shared) in a real-time communication session (e.g., an audio communication session, a video communication session, and/or an audio/video communication session) that is active on the computer system (e.g., content 1216 is being shared in the real-time communication session in FIG. 12E), the computer system displays (1306), via the display generation component, a first user interface element (e.g., 1234) (e.g., a user-interactive user interface element, a button, a selectable icon, a selectable option, and/or an affordance) that, when selected, causes the computer system to maintain display of the first user interface (e.g., in a current position and/or configuration or in a different position and/or configuration); and in accordance with a determination that the first user interface is not included (e.g., not being shared) in a real-time communication session that is active on the first computer system (e.g., 654 is displayed and/or the content in 1222a is not being shared in the real-time communication session), the computer system displays (1308), via the display generation component, the second user interface (e.g., 1204, a user interface of a selected application, or 654) (and, in some embodiments, ceasing display of the first user interface). Displaying a first user interface element for maintaining display of the first user interface or displaying a second user interface based on whether the first user interface is included in a real-time communication session provides the user with relevant options, provides a response that is relevant to the context of the computer system, and prevents the user from inadvertently ending content that is included in the real-time communication session and requiring additional inputs to restart the content, thereby providing improved visual feedback to the user, reducing the number of inputs needed to perform an operation, providing additional control options without cluttering the user interface with additional displayed controls, and performing an operation when a set of conditions has been met without requiring further user input.

In some embodiments, the first user interface includes (e.g., is) an active media item (e.g., 1216) (e.g., a media item that is being played or a media item that is paused). Displaying a first user interface element for maintaining display of an active media item based on whether the active media item is included in a real-time communication session provides the user with relevant options prevents the user from inadvertently ending the active media item that is included in the real-time communication session and requiring additional inputs to restart the media item, thereby providing improved visual feedback to the user, reducing the number of inputs needed to perform an operation, providing additional control options without cluttering the user interface with additional displayed controls, and performing an operation when a set of conditions has been met without requiring further user input. In some embodiments, in response to receiving the request to navigate to the second user interface and in accordance with the determination that the first user interface is not included in a real-time communication session that is active on the first computer system, the computer system stops playback of the media item (e.g., stopping playback of 1216). Stopping playback of the media item in response to receiving the request to navigate to the second user interface and in accordance with the determination that the first user interface is not included in a real-time communication session enables the user to quickly and efficiently stop playback of the media item when the media item is not being shared in the real-time communication session, thereby reducing the number of inputs needed to perform an operation. In some embodiments, the second user interface (e.g., 1204) includes information about the media items (e.g., the second user interface is an information page for the media item). Displaying information about the media item when the media item is not included in a real-time communication session enables the user to quickly and efficiently obtain information about the media item, thereby providing improved visual feedback to the user and reducing the number of inputs needed to perform an operation.

In some embodiments, while displaying the first user interface, the computer system detects, via the one or more input devices, a first input (e.g., on a remote control in communication with the computer system) (e.g., a press of button 603a and/or button 603b on remote control 600c0; and in response to detecting the first input: in accordance with a determination that the first user interface is included in a real-time communication session (e.g., 1216 in FIG. 12I or the content in 1222a in FIG. 12K), the computer system displays, via the display generation component, a set of control user interface elements (e.g., user-interactive user interface elements, buttons, selectable icons, selectable options, and/or affordances) (e.g., 1220, 1010, 1028, 1234, 1236, and/or 1238) that, when selected, cause the computer system to perform respective functions associated with the real-time communication session. In some embodiments, the set of control user interface elements is displayed in a representation (e.g., a self-view) of video captured by one or more camera sensors of the computer system. Displaying a set of control user interface elements for controlling the real-time communication session in accordance with a determination that the first user interface is included in a real-time communication session enables the user to quickly and efficiently control the real-time communication session while reducing disruption of the first user interface when control of the real-time communication session is not desired, thereby providing improved visual feedback to the user, reducing the number of inputs needed to perform an operation, providing additional control options without cluttering the user interface with additional displayed controls, and performing an operation when a set of conditions has been met without requiring further user input.

In some embodiments, the computer system displays a user interface for the real-time communication session, including displaying one or more representations (e.g., 1200, 1242, and/or 626) (e.g., video feeds) of participants in the real-time communication session; while displaying the one or more representations of participants in the real-time communication session, the computer system detects, via the one or more input devices, a request to hide the one or more representations of participants in the real-time communication session (e.g., selection of 1220a); and in response to detecting the request to hide the one or more representations of participants in the real-time communication session, the computer system ceases display of (e.g., hiding) the one or more representations of participants in the real-time communication session (e.g., as shown in FIG. 12I). In some embodiments, the first user interface is included in the user interface for the real-time communication session. In some embodiments, the user interface for the real-time communication session is the first user interface. In some embodiments, the computer system displays the one or more representations of participants in the real-time communication session concurrently with content (e.g., screenshare content and/or a media item) that is being shared in the real-time communication session. In some embodiments, the request to hide the one or more representations of participants in the real-time communication session includes selection of a hide user interface element displayed in the user interface for the real-time communication session. In some embodiments, in response to detecting the request to hide the one or more representations of participants in the real-time communication session, the computer system maintains display of content that is being shared in the real-time communication session. Ceasing display of the representation of participants in the real-time communication session in response to detecting the request to hide the one or more representations of participants in the real-time communication session enables the user to quickly and efficiently prioritize display of the first user interface, thereby providing improved visual feedback to the user, reducing the number of inputs needed to perform an operation, and providing additional control options without cluttering the user interface with additional displayed controls.

In some embodiments, in response to detecting the request to hide the one or more representations of participants in the real-time communication session, the computer system displays, via the display generation component, instructions (e.g., 1226) for displaying (e.g., re-displaying and/or unhiding) the one or more representations of participants in the real-time communication session. Displaying the instructions in response to detecting the request to hide the one or more representations of participants in the real-time communication session informs the user that the one or more representations are still available for display, and how to display them, thereby providing improved visual feedback to the user and reducing the number of inputs needed to perform an operation. In some embodiments, in response to detecting the request to hide the one or more representations of participants in the real-time communication session, the computer system displays, via the display generation component, an indication (e.g., 1228) (e.g., a user interface element, an animation, text, and/or a color) that a camera sensor is active (e.g., a camera sensor capturing video that is provided to the real-time communication session). Displaying an indication that a camera sensor is active in response to detecting the request to hide the one or more representations of participants in the real-time communication session informs the user that the camera sensor is still capturing image data even though a representation of the image data is not displayed, thereby providing improved visual feedback to the user and providing improved privacy and security. In some embodiments, after ceasing display of the one or more representations of participants in the real-time communication session, the computer system detects, via the one or more input devices, a request (e.g., a press of a button on a remote control) (e.g., a press of button 603b on remote control 600c) to display the one or more representations of participants in the real-time communication session; and in response to detecting the request to display the one or more representations of participants in the real-time communication session, the computer system displays (e.g., re-displays, shows, and/or unhides) the one or more representations (e.g., 1200, 1242, and/or 626) of participants in the real-time communication session. Displaying the one or more representations of participants in the real-time communication session in response to detecting the request to display the one or more representations of participants in the real-time communication session enables the user to quickly and efficiently display the representations of the participants and provides the user with information about the state of the real-time communication session, thereby providing improved visual feedback to the user and reducing the number of inputs needed to perform an operation.

In some embodiments, the computer system displays a user interface for the real-time communication session, including concurrently displaying one or more representations (e.g., video feeds) (e.g., 1200, 1242, and/or 626) of participants in the real-time communication session and a representation (e.g., 1216, the content in 1222a, 1246, and/or 1248) of content (e.g., media content and/or screenshare content) being shared in the real-time communication session; while concurrently displaying one or more representations of participants in the real-time communication session and the representation of content being shared in the real-time communication session, the computer system detects, via the one or more input devices, a second input (e.g., selection of a view mode user interface element for changing a viewing configuration, user interface layout, and/or viewing mode of the real-time communication session) (e.g., selection of 1220b or 1246c); and in response to detecting the second input: in accordance with a determination that the one or more representations of participants in the real-time communication session includes two or more representations of participants in the real-time communication session (e.g., the real-time communication session is in a split view mode) (e.g., FIGS. 12G, 12H, 12J, 12K, and/or 12L), the computer system concurrently displays the representation (e.g., 1216) of content being shared in the real-time communication session and a single representation (e.g., 1200) of a participant in the real-time communication session (e.g., the computer system switches from a split view to a picture-in-picture view) (e.g., FIG. 12E or 12F); and in accordance with a determination that the one or more representations of participants in the real-time communication session includes less than two representations of participants in the real-time communication session (e.g., a single representation of a participant in the real-time communication session in a picture-in-picture window with the shared content) (e.g., FIG. 12E or 12F), the computer system concurrently displays the representation of content being shared in the real-time communication session (e.g., the content in 1222a) and two or more representations (e.g., 1200, 1242, and/or 626) of participants in the real-time communication session (e.g., the computer system switches from a picture-in-picture view to a split view). In some embodiments, the first user interface is included in the user interface for the real-time communication session. In some embodiments, the user interface for the real-time communication session is the first user interface. In some embodiments, the single representation of the participant in the real-time communication session includes a representation of a remote participant or a representation (e.g., a self-view) of a user of the computer system (e.g., an avatar or a video feed of video captured by one or more cameras that are in communication with the computer system). Displaying the representation of the content being shared in the real-time communication session and a number of representations of the participants in the real-time communication session based on the number of displayed representations of participants enables the user to quickly and easily switch between views of the content and the real-time communication session, thereby providing improved visual feedback to the user and reducing the number of inputs needed to perform an operation. In some embodiments, in response to detecting the second input, the computer system displays, via the display generation component, instructions (e.g., 1224) for displaying (e.g., for using a remote control to display) a set of user interface elements (e.g., 1220) (e.g., user-interactive user interface elements, buttons, selectable icons, selectable options, and/or affordances) corresponding to functions associated with the real-time communication session. Displaying instructions for displaying the set of user interface elements for controlling the real-time communication session in response to the second input enables the user to quickly and efficiently control the real-time communication session without cluttering the user interface when control of the real-time communication session is not desired, thereby reducing the number of inputs needed to perform an operation and providing additional control options without cluttering the user interface with additional displayed controls.

In some embodiments, the computer system displays a user interface of the real-time communication session, including displaying: a representation of content (e.g., the content in 1222a in FIG. 12G) being shared in the real-time communication session in a first region (e.g., 1222a) of the user interface of the real-time communication session; and one or more representations (e.g., 1200, 1242, and/or 626) of participants in the real-time communication in a second region (e.g., 1222b) of the user interface of the real-time communication session that is smaller than the first region; and while displaying the user interface of the real-time communication session with the representation of the content in the first region and the one or more representations of participants in the real-time communication in the second region (e.g., FIGS. 12J-12L), the computer system displays, via the display generation component, a first expand user interface element (e.g., 1220c) (e.g., a user-interactive user interface element, a button, a selectable icon, a selectable option, and/or an affordance) that, when selected, initiates a process for increasing a size of the region in which one or more representations of participants in the real-time communication are displayed (and, in some embodiments, reducing a size of the region in which the representation of the content is displayed). Displaying the expand user interface element enables the user to quickly and efficiently prioritize display of the real-time communication session without cluttering the user interface, thereby providing improved visual feedback to the user, providing additional control options without cluttering the user interface with additional displayed controls, and reducing the number of inputs needed to perform an operation.

In some embodiments, the computer system detects, via the one or more input devices, a selection (e.g., input, touch gesture, air gesture, voice command, and/or other selection) of the expand user interface element (e.g., selection of 1220c in FIG. 12J); and in response to detecting the selection of the expand user interface element, the computer system displays (e.g., concurrently displays), via the display generation component: a second expand user interface element (e.g., 1230) (e.g., a user-interactive user interface element, a button, a selectable icon, a selectable option, and/or an affordance) that, when selected, causes the computer system to display the representation (e.g., 1244) of the content in a third region (e.g., the region occupied by 1244) and one or more representations (e.g., 620) of participants in the real-time communication in a fourth region (e.g., the region occupied by 620 in FIG. 12M) that is larger than the third region; and an end user interface element (e.g., a user-interactive user interface element, a button, a selectable icon, a selectable option, and/or an affordance) that, when selected, causes the computer system to disconnect from the real-time communication session. Displaying a second expand user interface element and an end user interface element in response to detecting the selection of the expand user interface element provides the user with relevant control options and enables the user to confirm a selection and avoid inadvertently expanding display of the real-time communication session, thereby providing improved visual feedback to the user, reducing the number of inputs needed to perform an operation, and providing additional control options without cluttering the user interface with additional displayed controls. In some embodiments, while displaying the user interface of the real-time communication session with the representation of the content in the first region and the one or more representations of participants in the real-time communication in the second region (e.g., FIGS. 12J-12L), the computer system detects, via the one or more input devices, a third input (e.g., selection of the first expand user interface element and/or the second expand user interface element); and in response to detecting the third input, the computer system displays (e.g., concurrently displays), via the display generation component: the representation (e.g., 1244) of the content in a third region (e.g., a picture-in-picture window) (e.g., the region occupied by 1244); and one or more representations (e.g., 620) of participants in the real-time communication in a fourth region (e.g., the region occupied by 620 in FIG. 12M) that is larger than the third region. Displaying the representation in the third region and the one or more participants in the fourth region enables the user to quickly and efficiently configure the layout of the content and the real-time communication session, thereby providing improved visual feedback to the user and reducing the number of inputs needed to perform an operation.

In some embodiments, while the real-time communication session is active, the computer system detects, via the one or more input devices, a fourth input (e.g., selection of a user interface element for providing options for sharing content in the real-time communication session) (e.g., selection of 1028b); and in response to detecting the fourth input, the computer system displays, via the display generation component, one or more application user interface elements corresponding to respective applications that are configured to share content in the real-time communication session (e.g., without displaying any user interface elements corresponding to applications that are not configured to share content in the real-time communication session). Displaying one or more application user interface elements corresponding to respective applications that are configured to share content in the real-time communication session informs the user of relevant applications without having to navigate to individual applications to determine whether they are configured to share content in the real-time communication session, thereby providing improved visual feedback and reducing the number of inputs needed to perform an operation.

Note that details of the processes described above with respect to method 1300 (e.g., FIG. 13 are also applicable in an analogous manner to the methods described below and above. For example, methods 700, 900, 1100, and/or 1500 optionally includes one or more of the characteristics of the various methods described above with reference to method 1300. For example, the techniques for managing a real-time communication session described in method 1300 can be applied to the real-time communication sessions described in methods 700 and 1100. For brevity, these details are not repeated below.

FIGS. 14A-14E illustrate exemplary user interfaces for providing a menu, in accordance with some embodiments. The user interfaces in these figures are used to illustrate the processes described below, including the processes in FIG. 15.

FIG. 14A illustrates computer system 600b described above. In some embodiments, computer system 600b is configured to be controlled by remote control 600c as described above. In FIG. 14A, a real-time communication session is active on computer system 600b, and media content is being shared in the real-time communication session as described with reference to FIGS. 12E-12O. Computer system 600b displays user interface 1222 with the shared content in region 1222a and with representation 1242 and representation 626 of the real-time communication session in region 1222b, as described above with reference to FIG. 12H.

In FIG. 14A, computer system 600b receives a request to display a system-level menu. In some embodiments, the request to display the system-level menu includes an input on remote control 600c (e.g., a press and hold input on input area 601 or button 603b). In response to receiving the request to display a system-level menu, computer system 600b displays system-level menu 1400. System-level menu 1400 includes menu options 1400a-1400c.

In some embodiments, computer system 600b displays a sub-menu of system-level menu 1400 based on a context in which computer system 600b is operating when receiving the request to display the system-level menu. For example, in response to receiving the request to display a system-level menu while a real-time communication session is active, computer system 600b displays sub-menu 1402 corresponding to menu option 1400a as shown in FIG. 14B. Sub-menu 1402 includes information and options associated with the real-time communication session and/or the content being shared in the real-time communication session. Sub-menu 1402 includes indication 1404 with information about the real-time communication session such as, e.g., the participants, status, and content (if any) being shared in the real-time communication session. Sub-menu 1402 includes options 1406 for controlling the real-time communication session, including option 1406a for enabling and/or disabling a microphone, option 1406b for enabling and/or disabling a camera, option 1406c for enabling, disabling, selecting, and/or controlling content to share in the real-time communication session, and option 1406d for ending the real-time communication session.

In FIG. 14B, computer system 600b receives a request to display a sub-menu corresponding to a different menu option in system-level menu 1400. In some embodiments, the request includes a directional (e.g., right direction) input on remote control 600c and/or other input selecting menu option 1400b. In response to receiving the request to display a sub-menu corresponding to a different menu option in system-level menu 1400, computer system 600b displays sub-menu 1408 corresponding to menu option 1400b with a camera preview and camera options 1410 shown in FIG. 14C. In FIG. 14C, camera options 1410 includes options for controlling a camera (e.g., tracking option 1410a, lighting option 1410b, image effect option 1410c, gesture option 1410d, and audio effects option 1412).

Turning to FIG. 14D, computer system 600b is displaying media content 1216, and a real-time communication session is not active on computer system 600b. In FIG. 14D, computer system 600b receives a request (e.g., another request) to display system-level menu 1400. In response to receiving the request to display system-level menu 1400 while a real-time communication session is not active, computer system 600b displays sub-menu 1414 corresponding to menu option 1400d as shown in FIG. 14E. In some embodiments, sub-menu 1414 is a control center that includes options for setting and/or controlling system-level parameters. In the example illustrated in FIG. 14E, sub-menu 1414 includes contact representations 1416, device controls 1420, and system controls 1418.

FIG. 15 is a flow diagram illustrating a method for providing a menu using a computer system in accordance with some embodiments. Method 1500 is performed at a computer system (e.g., 100, 300, 500, and/or 600b) (e.g., a smart phone, a smart watch, a tablet computer, a laptop computer, a desktop computer, a wearable device, and/or head-mounted device) that is in communication with (e.g., includes and/or is connected to) a display generation component (e.g., 602b) (e.g., a display, touch-screen display, a monitor, a holographic display system, and/or a head-mounted display system) and one or more input devices (e.g., 602b and/or 600c) (e.g., a touch-sensitive surface (e.g., a touch-sensitive display); a mouse; a keyboard; a remote control; a visual input device (e.g., one or more cameras such as, e.g., an infrared camera, a depth camera, a visible light camera, and/or a gaze tracking camera); an audio input device; a biometric sensor (e.g., a fingerprint sensor, a face identification sensor, a gaze tracking sensor, and/or an iris identification sensor); and/or one or more mechanical input devices (e.g., a depressible input mechanism; a button; a rotatable input mechanism; a crown; and/or a dial)). Some operations in method 1500 are, optionally, combined, the orders of some operations are, optionally, changed, and some operations are, optionally, omitted.

As described below, method 1500 provides an intuitive way for providing a menu. The method reduces the cognitive burden on a user for providing a menu, thereby creating a more efficient human-machine interface. For battery-operated computing devices, enabling a user to provide a menu faster and more efficiently conserves power and increases the time between battery charges.

While displaying, via the display generation component, a user interface (e.g., 654, 1216, or 1222), the computer system detects (1502), via the one or more input devices, a request (e.g., an input on remote control 600c, an input on 602b, and/or a voice command) to display a system-level menu (e.g., 1400) (e.g., a menu that includes controls and/or options for selecting and/or setting parameters and/or performing functions that apply to a system, as opposed to a single application). In response to detecting the request to display the system-level menu, the computer system displays (1504) the system-level menu (e.g., 1400), including: in accordance with a determination that the computer system is operating in a first context (e.g., the computer system is displaying predetermined content and/or running a predetermined application), the computer system displays (1506), via the display generation component, a sub-menu (e.g., 1402) corresponding to a first menu option (e.g., 1400a) in the system-level menu; and in accordance with a determination that the computer system is operating in a second context (e.g., the computer system is not displaying (or does not have in focus) predetermined content and/or running a predetermined application) that is different from the first context, the computer system displays (1508), via the display generation component, a sub-menu (e.g., 1408 or 1414) corresponding to a second menu option (e.g., 1400b or 1400d) in the system-level menu that is different from the first menu option. Displaying a sub-menu of the system-level menu corresponding to a first menu option or a second menu option based on a context in which the computer system is operating provides the user with relevant menu options without having to further navigate the user interface, thereby providing improved visual feedback, reducing the number of inputs needed to perform an operation, providing additional control options without cluttering the user interface with additional displayed controls, and performing an operation when a set of conditions has been met without requiring further user input.

In some embodiments, the request to display the system-level menu includes a press of a button (e.g., on a remote control) (e.g., a press of button 603b on remote control 600c) with a duration that exceeds a threshold amount of time. In some embodiments, in accordance with a determination that the duration of the press of the button satisfies (e.g., is equal to; or is greater than or equal to) the threshold amount of time, the computer system displays the system-level menu; and in accordance with a determination that the duration of the press of the button does not satisfy (e.g., is less than or equal to; or is less than) the threshold amount of time, the computer system foregoes display of the system-level menu (e.g., the computer system maintains display of a current user interface or performs an operation different from displaying the system-level menu). Displaying the system-level menu in response to a press of a button that exceeds a threshold amount of time enables the user to quickly and efficiently access the system-level menu without having to display and/or select an additional user interface element for accessing the system-level menu, thereby reducing the number of inputs needed to perform an operation and providing additional control options without cluttering the user interface with additional displayed controls.

In some embodiments, displaying the system-level menu includes: in accordance with a determination that a real-time communication session (e.g., a video call, a video conference, a phone call, and/or an audio call) is active on the computer system (e.g., that a user interface of the real-time communication session is displayed) (e.g., FIG. 14A), displaying, via the display generation component, a sub-menu (e.g., 1402) (e.g., a sub-menu corresponding to the real-time communication session) of the system-level menu that includes a set (e.g., 1406) of one or more control user interface elements (e.g., 1406a-1406d) (e.g., user-interactive user interface elements, buttons, selectable icons, selectable options, and/or affordances) corresponding to respective functions of the real-time communication session. In some embodiments, the first context is the real-time communication session being active on the computer system, and the sub-menu corresponding to the first menu option in the system-level menu includes the set of one or more control user interface elements corresponding to respective functions of the real-time communication session. In some embodiments, the respective functions of the real-time communication session include muting a microphone, unmuting a microphone, activating a camera, deactivating a camera, sharing content in the real-time communication session, displaying options for sharing content in the real-time communication session, and/or disconnecting from the real-time communication session. In some embodiments, the sub-menu corresponding to the real-time communication session includes a set of information about the real-time communication session such as, e.g., information about the participants of the real-time communication session, the status of participants in the real-time communication session, and/or content that is in (e.g., being shared in) the real-time communication session. Displaying a sub-menu of the system-level menu that includes a set of control user interface elements for functions of the real-time communication session enables the user to quickly and efficiently access and control the real-time communication session, thereby providing improved visual feedback to the user, providing additional control options without cluttering the user interface with additional displayed controls, and reducing the number of inputs needed to perform an operation.

In some embodiments, while displaying the sub-menu (e.g., 1402) corresponding to the first menu option (e.g., 1400a) in the system-level menu (e.g., 1400), the computer system detects, via the one or more input devices, an input (e.g., a swipe gesture and/or a tap and drag gesture on a touch-sensitive surface of a remote control) (e.g., a directional input, a tap on a menu option, and/or a swipe on, and/or a press on a left or right side of, input area 601 of remote control 600c); and in response to detecting the input, the computer system displays, via the display generation component, a sub-menu (e.g., 1408) corresponding to a third menu option (e.g., 1400b) (e.g., the second menu option or another menu option) in the system-level menu that is different from the first menu option (e.g., the computer system changes the sub-menu option in response to detecting user input). Displaying a sub-menu corresponding to a third menu option in response to detecting an input enables the user to quickly and efficiently change the menu options, thereby providing improved visual feedback and reducing the number of inputs needed to perform an operation.

In some embodiments, displaying the system-level menu (e.g., 1400) includes displaying a set of one or more camera user interface elements (e.g., 1410a-1410d) (e.g., user-interactive user interface elements, buttons, selectable icons, selectable options, and/or affordances) corresponding to respective controls or respective settings for one or more cameras (e.g., 658a and/or 658b) (e.g., one or more cameras that are in communication with the computer system and/or one or more cameras of a second computer system that are connected to the computer system). In some embodiments, the respective controls include controls for a tracking function, a lighting effect, a blurring effect, displaying effects in response to gestures (e.g., air gestures), and/or audio effects. In some embodiments, the respective settings include a setting for a tracking function, a setting for a lighting effect, a setting for a blurring effect, a setting for displaying effects in response to gestures (e.g., air gestures), and/or a setting for audio effects. Displaying camera user interface elements in the system-level menu enables the user to quickly and efficiently access information about the status of the one or more cameras and options for controlling the one or more cameras, thereby providing improved visual feedback and reducing the number of inputs needed to perform an operation.

In some embodiments, displaying the system-level menu includes displaying a set of one or more system-control user interface elements (e.g., 1418) (e.g., user-interactive user interface elements, buttons, selectable icons, selectable options, and/or affordances) corresponding to respective settings for an operating system of the computer system (e.g., system-level settings). In some embodiments, the respective settings include a wi-fi setting, a cellular setting, a Bluetooth setting, an airplane mode setting, a display orientation setting (e.g., orientation lock), a display sharing setting, a volume setting, a display brightness setting, a focus setting, a flashlight function, an alarm function, a calculator function, a camera application, and/or a screen recording function. Displaying the system-control user interface elements in the system-level menu enables the user to quickly and efficiently information about the status of the computer system and access options for controlling system-level functions and parameters, thereby providing improved visual feedback and reducing the number of inputs needed to perform an operation.

In some embodiments, displaying the system-level menu includes: in accordance with a determination that the computer system is operating in the first context (e.g., FIG. 14A), displaying, via the display generation component, the system-level menu with a first set of menu options (e.g., sub-menu options) (e.g., 1400a-1400c); and in accordance with a determination that the computer system is operating in the second context (e.g., FIG. 14D), displaying, via the display generation component, the system-level menu with a second set of menu options (e.g., sub-menu options) that includes the first set of menu options (e.g., 1400a-1400e). In some embodiments, the second set of menu options is the same as the first set of menu options. Displaying the system-level menu with the same set of menu options in the first context as in the second context provides consistency for the user that helps the user avoid mistakes and additional inputs, thereby reducing the number of inputs needed to perform an operation.

Note that details of the processes described above with respect to method 1500 (e.g., FIG. 15 are also applicable in an analogous manner to the methods described above. For example, methods 700, 900, 1100, and/or 1300 optionally includes one or more of the characteristics of the various methods described above with reference to method 1500. For example, the system-level menu described in method 1500 can be displayed in methods 700, 900, 1100, and/or 1300.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve real-time communication and the ability to connect a camera to a device. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve real-time communication and the ability to connect a camera to a device. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of real-time communication, the present technology can be configured to allow users to select to “opt in” or “opt out” of participation in the collection of personal information data during registration for services or anytime thereafter. In another example, users can select not to provide data for real-time communication sessions. In yet another example, users can select to limit the length of time data is maintained or entirely prohibit the maintenance of data. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, user preferences can be inferred based on non-personal information data or a bare minimum amount of personal information, such as the content being requested by the device associated with a user, other non-personal information available to real-time communication applications, or publicly available information.

1-111. (canceled)

112. A first computer system configured to communicate with a display generation component and one or more input devices, comprising:
one or more processors; and
memory storing one or more programs configured to be executed by the one or more processors, the one or more programs including instructions for:
detecting, via the one or more input devices, a request to display an application that uses data captured by a camera sensor; and
in response to detecting the request to display the application that uses data captured by a camera sensor:
in accordance with a determination that the first computer system is connected to a second computer system that is in communication with one or more camera sensors, displaying, via the display generation component, the application; and
in accordance with a determination that the first computer system is not connected to a computer system that is in communication with one or more camera sensors, displaying, via the display generation component, a first connection user interface element that, when selected, initiates a process for connecting the first computer system with the second computer system.

113. The first computer system of claim 112, the one or more programs further including instructions for:
in response to detecting the request to display the application that uses data captured by a camera sensor and in accordance with the determination that the first computer system is not connected to a computer system that is in communication with one or more camera sensors, displaying, via the display generation component, a list of one or more connection user interface elements for connecting the first computer system with respective computer systems, the list of one or more connection user interface elements including the first connection user interface element.

114. The first computer system of claim 113, wherein the list of one or more connection user interface elements includes connection user interface elements that correspond to respective computer systems that are signed into a same account as the first computer system.

115. The first computer system of claim 113, wherein the list of one or more connection user interface elements includes connection user interface elements that correspond to respective computer systems that are within a predetermined distance of the first computer system.

116. The first computer system of claim 113, wherein the list of one or more connection user interface elements includes a second connection user interface element, and the one or more programs further including instructions for:
detecting, via the one or more input devices, a selection of the second connection user interface element; and
in response to detecting the selection of the second connection user interface element, displaying, via the display generation component, a quick response code that, when scanned by an external computer system, initiates a process for connecting the first computer system with the external computer system.

117. The first computer system of claim 113, the one or more programs further including instructions for:
detecting, via the one or more input devices, a selection of the first connection user interface element; and
after detecting selection of the first connection user interface element, in accordance with a determination that the second computer system is in a predetermined position, connecting one or more camera sensors of the second computer system with the first computer system.

118. The first computer system of claim 112, the one or more programs further including instructions for:
in response to detecting the request to display the application that uses data captured by a camera sensor and in accordance with the determination that the first computer system is not connected to a computer system that is in communication with one or more camera sensors, displaying, via the display generation component, instructions to select a user associated with a computer system that includes one or more camera sensors that are configured for use with the first computer system.

119. The first computer system of claim 112, the one or more programs further including instructions for:
detecting, via the one or more input devices, a selection of the first connection user interface element; and
after detecting selection of the first connection user interface element, displaying, via the display generation component, instructions to confirm on the second computer system a request to connect the second computer system with the first computer system.

120. The first computer system of claim 112, the one or more programs further including instructions for:
receiving an indication that a request to connect the second computer system with the first computer system has been accepted; and
in response to receiving the indication that the request to connect the second computer system with the first computer system has been accepted, displaying, via the display generation component, a representation of video captured by one or more camera sensors of the second computer system.

121. The first computer system of claim 112, the one or more programs further including instructions for:
receiving an indication that the second computer system is connected to the first computer system; and
in response to receiving the indication that the second computer system is connected to the first computer system, displaying, via the display generation component, a representation of video captured by one or more camera sensors of the second computer system.

122. The first computer system of claim 121, the one or more programs further including instructions for:
displaying, via the display generation component, a user interface of the application, including displaying, in the user interface of the application, one or more control user interface elements that, when selected, cause the first computer system to perform respective functions associated with the video captured by one or more camera sensors of the second computer system.

123. The first computer system of claim 122, wherein displaying the one or more control user interface elements includes displaying a first control user interface element, and the one or more programs further including instructions for:
detecting, via the one or more input devices, a selection of the first control user interface element; and
in response to detecting the selection of the first control user interface element, displaying, via the display generation component:
an indication that the second computer system is actively connected with the first computer system;
a user interface element corresponding to the second computer system;
an indication that other computer systems are available to connect with the first computer system; and
a user interface element corresponding to a third computer system that is different from the first computer system and the second computer system.

124. The first computer system of claim 112, the one or more programs further including instructions for:
detecting, via the one or more input devices, a request to display a system-level control menu;
in response to detecting the request to display the system-level control menu, displaying the system-level control menu, including displaying a camera user interface element;
detecting, via the one or more input devices, a selection of the camera user interface element; and
in response to detecting the selection of the camera user interface element, displaying, via the display generation component, a list of connection user interface elements for connecting the first computer system with respective computer systems, the list of connection user interface elements including the first connection user interface element.

125. The first computer system of claim 112, wherein in response to receiving an indication that the second computer system has been selected, the second computer system displays an accept option for connecting the second computer system with the first computer system.

126. The first computer system of claim 125, wherein in response to receiving an indication that a user associated with the second computer system has been selected at the first computer system, a fourth computer system displays an accept option for connecting the fourth computer system with the first computer system.

127. The first computer system of claim 126, wherein in response to a determination that the accept option for connecting the second computer system with the first computer system has been selected, the fourth computer system ceases display of the accept option for connecting the fourth computer system with the first computer system.

128. The first computer system of claim 125, wherein the second computer system detects a selection of the accept option for connecting the second computer system with the first computer system and, in response to the second computer system detecting the selection of the accept option for connecting the second computer system with the first computer system, the second computer system initiates a process for connecting with the first computer system.

129. A non-transitory computer-readable storage medium storing one or more programs configured to be executed by one or more processors of a first computer system that is in communication with a display generation component and one or more input devices, the one or more programs including instructions for:
detecting, via the one or more input devices, a request to display an application that uses data captured by a camera sensor; and
in response to detecting the request to display the application that uses data captured by a camera sensor:
in accordance with a determination that the first computer system is connected to a second computer system that is in communication with one or more camera sensors, displaying, via the display generation component, the application; and
in accordance with a determination that the first computer system is not connected to a computer system that is in communication with one or more camera sensors, displaying, via the display generation component, a first connection user interface element that, when selected, initiates a process for connecting the first computer system with the second computer system.

130. A method, comprising:
at a first computer system that is in communication with a display generation component and one or more input devices:
detecting, via the one or more input devices, a request to display an application that uses data captured by a camera sensor; and
in response to detecting the request to display the application that uses data captured by a camera sensor:
in accordance with a determination that the first computer system is connected to a second computer system that is in communication with one or more camera sensors, displaying, via the display generation component, the application; and
in accordance with a determination that the first computer system is not connected to a computer system that is in communication with one or more camera sensors, displaying, via the display generation component, a first connection user interface element that, when selected, initiates a process for connecting the first computer system with the second computer system.
